(19) United States
(12) Patent Application Publication
(10) Pub. No.: US 2010/0106655 A1
(43) Pub. Date: Apr. 29, 2010

(54) CPW method with application in a CPW enterprise architecture engine

(76) Inventor: Bernd Schneider, Ihringen (DE)

Correspondence Address: Bernd Schneider, Haldenweg 41, Ihringen, 79241, DE

(21) Appl. No.: 12/312,671

(22) Filed: May 16, 2009

Related U.S. Application Data
(63) Continuation-in-part of application No. 10/486,290, filed on Aug. 20, 2004.

(51) Int. Cl. G06Q 10/00; G06F 7/00

(52) U.S. Cl. 705/301; 707/792

(57) ABSTRACT

The CPW Method with their extensions is applied in the CPW Enterprise Architecture Framework and in the CPW Enterprise Architecture Engine. The service oriented CPW Enterprise Architecture Framework and the CPW Enterprise Architecture Engine can be applied to the business areas of financial services (banking, insurance industry and financial accounting and auditing), chemistry, pharmacy, medicine, transportation and shipping, travel, film industry, politics, psychology, legal practice, jurisprudence, judiciary and other business areas.

### 1 WHAT THE APPLIED PATENT REFERS TO AND WHAT IS THE BACKGROUND OF THE APPLIED PATENT?

The applied patent or patent application is a continuation in part of the application of the Parent Application No. or International Application No.: PCT/IB01/01337 with the International Filing Date Jul. 26, 2001 and the U.S. application Ser. No. 10/486,290 with Filing Date Aug. 20, 2004. The applied patent refers to the extension of the CPW Method. The CPW Method with their extensions has been created by Bernd Jakob Schneider. The CPW Method with their extensions includes among others the application of the CPW Method in a CPW Enterprise Architecture Framework and a CPW Enterprise Architecture Engine.

### 2 ABSTRACT OF THE PATENT APPLICATION OR OF THE INVENTION

The CPW Method with their extensions is applied in the CPW Enterprise Architecture Framework and in the CPW Enterprise Architecture Engine. The service oriented CPW Enterprise Architecture Framework and the CPW Enterprise Architecture Engine can be applied to the business areas of financial services (banking, insurance industry and financial accounting and auditing), chemistry, pharmacy, medicine, transportation and shipping, travel, film industry, politics, psychology, legal practice, jurisprudence, judiciary and other business areas.

### BRIEF DESCRIPTION OF THE FIGURES

FIG. 1 shows the CPW Process, CPW Dialog and CPW Workflow with Swimlanes.

FIG. 2 shows a CPW Object Context Diagram and two CPW Functional Diagrams.

FIG. 3 shows a CPW Subject Context Diagram and two CPW Functional Diagrams.

FIG. 4 shows a CPW Process and CPW Workflow with Swimlanes.

FIG. 5 shows the method transformation of the CPW Process in a UML Activity Diagram with Swimlanes.

FIG. 6 shows like in FIG. 5 the method transformation of the CPW Process in a UML Activity Diagram.

In FIG. 7 is shown a CPW Process, which has been transformed in a UML Activity Diagram.

In FIG. 8 is shown a CPW Process, which has been transformed in a UML Activity Diagram.

In FIG. 9 is shown a CPW Process, which has been transformed in a BPMN Business Process Diagram (BPD).

FIG. 10 shows the CPW Dialog: Peter and Mary make coffee with a filter coffee machine.

FIG. 11 shows the CPW Process or CPW Workflow: Peter and Mary make coffee with a filter coffee machine.

FIG. 12 shows an example for a CPW Process 2d, CPW Workflow 2d and CPW Dialog 2d.

FIG. 13 shows an example for a CPW Object Context Diagram 2d.

FIG. 14 shows an example for a CPW Subject Context Diagram 2d.

FIG. 15 shows an example for a CPW Subject Object Context Diagram 2d.

FIG. 16 shows the triangle as a CPW Triangle with the realization levels of a project in business and IT how the CPW Framework can be applied on different realization levels.

FIG. 17 shows a CPW Object Context Diagram.

FIG. 18 shows a CPW Object Flow Context Diagram.

FIG. 19 shows a CPW Object Flow Context Diagram with sequence numbers and the CPW Object Flow Table.

FIG. 20 shows a CPW Subject Object Flow Context Diagram.

FIG. 21 shows a CPW Subject Object Flow Context Diagram with sequence numbers and the CPW Subject Object Flow Table with the significant attributes.

FIG. 22 shows a CPW Subject Object Process Flow Context Diagram.

FIG. 23 shows a CPW Subject Object Process Flow Context Diagram with sequence numbers and the CPW Subject Object Process Flow Table with the significant attributes.

FIG. 24 shows the CPW Process and CPW Workflow.

FIG. 25 shows the CPW Process and CPW Workflow with sequence numbers.

FIG. 26 shows the variant B of the CPW Subject Object Context Diagram Process Transformation.

FIG. 27 shows the steps 1 to 11 of the variant C method transformation of the CPW Object Context Diagram Process Transformation by means of an example.

FIG. 28 shows the steps 12 to 13 of the variant C method transformation of the CPW Object Context Diagram Process Transformation by means of an example.

FIG. 29 shows the basic structure of the CPW Expert Concepts, which forms the basis for the CPW Diagnostic Assessment.

FIG. 30 shows the basic structure of the CPW Diagnostic Assessment.

FIG. 31 shows the CPW DA Change Management Transformation.

FIG. 32 shows the CPW Method Components CPW Diagnostic Assessment (CPW DA) and CPW Change Management (CPW CM).

The FIG. 33 shows the CPW Change Management Table and CPW Plan Table for the CPW Change Management Plan Transformation.

The FIG. 34 shows the CPW Change Management Table and CPW Workflow Table or CPW Process Table for the CPW Change Management Process Transformation.

FIG. 35 shows the CPW Process Plan Transformation

FIG. 36 shows the CPW Plan Process Transformation.

FIG. 37 shows a CPW Framework with the CPW Method Components CPW DA, CPW CM, CPW Plan, CPW Process and CPW Sign-off Process.

In FIG. 38 is shown the CPW Change Management Functional Requirements Transformation (CPW Change Management FR Transformation).

FIG. 39 shows the CPW Functional Requirements Functional Diagram Transformation (CPW FR FD Transformation).

FIG. 40 shows the CPW Functional Requirements Table, the transformed CPW Functional Diagram and the transformed CPW Object Diagram.

FIG. 41 shows the CPW Functional Diagram and the transformed CPW Subject Object Context Diagram.

FIG. 42 shows the CPW Functional Diagram, the CPW Object Context Diagram and the transformed CPW Object Flow Context Diagram.

FIG. 43 shows the CPW Functional Requirements Table and the transformed CPW Workflow Table/CPW Process Table.

FIG. 44 shows the CPW Functional Requirements Table and the transformed CPW Plan Table.

FIG. 45 shows the CPW Framework with CPW Method Components.

FIG. 46 shows how the CPW Framework with CPW Method Components can be applied in business and IT in the CPW Triangle.

FIG. 47 shows an Entity Relationship Diagram (ERD), which is regarded as a Business Data Model (BDM), and which has been transformed by means of method transformation in a CPW Subject Object Context Diagram, the so-called CPW Context Diagram BDM Transformation.

FIG. 48 shows an Entity Relationship Diagram (ERD), which is regarded as a Business Data Model (BDM) and which has been transformed by means of method transformation in a CPW Subject Object Relationship Diagram.

FIG. 49 shows an CPW Subject Object Context Diagram, which has been transformed in a CPW Subject Object Relationship Diagram. This CPW Method Transformation is called as CPW Context Diagram Subject Object Relationship Diagram Transformation.

In FIG. 50 is represented the CPW Framework with the CPW Business System Description (CPW BS Description).

In FIG. 51 is represented the CPW Framework with the connection to Business Case (BC), Specification Case (SC) and Production Case (PC).

In FIG. 52 is represented the CPW Enterprise Architecture Framework and CPW Enterprise Architecture Engine.

In FIG. 53 is represented a CPW Enterprise Architecture Framework with a tree structure of CPW Frameworks.

In FIG. 54 is represented a CPW Triangle.

FIG. 55 shows the tree structure of a CPW Enterprise Architecture Framework or of a CPW Enterprise Architecture Engine.

FIG. 56 shows the tree structure of a CPW Enterprise Architecture Framework or of a CPW Enterprise Architecture Engine.

FIG. 57 shows a CPW Enterprise Architecture Framework for the IT area.

FIG. 58 shows a example for an external framework for the IT area.

FIG. 59 shows a CPW Enterprise Architecture Framework for the IT area.

FIG. 60 shows a CPW Enterprise Architecture Framework for the area of Business Architecture.

FIG. 61 shows a CPW Enterprise Architecture Framework for the IT area.

FIG. 62 shows a CPW Enterprise Architecture Framework (CPW EA Framework) for the IT area.

FIG. 63 shows a CPW Enterprise Architecture Framework(CPW EA Framework) for the IT area.

In FIG. 64 is shown the CPW Enterprise Architecture Framework and CPW Enterprise Architecture Engine with the interface to applications and tools with the appropriate protocols like for example.: XML.

### 4 DETAILED DESCRIPTION OF THE INVENTION OR OF THE APPLIED PATENT

In the following chapters is described the detailed description of the Cognitive Process Workflow (CPW) Method with their extensions.

### 5 OVERVIEW OF THE COGNITIVE PROCESS WORKFLOW (CPW) METHOD WITH THEIR EXTENSIONS

In the Application PCT/IB01/01337 is Described the CPW Method with the Following Methods:

| No. | CPW Method in the application PCT/IB01/01337 |
|---|---|
| 1 | CPW Process |
| 2 | CPW Dialog |
| 3 | CPW Workflow |
| 4 | CPW Context Diagrams are subdivided into: |
| 5 | CPW Subject Context Diagram |
| 6 | CPW Object Context Diagram |
| 7 | CPW Subject Object Context Diagram |

With the Following Application are with the CPW Method the Following Method Extensions:

Overview of the Method Extensions of the CPW Method:

| No. | Method extensions of the CPW Method: |
|---|---|
| 1 | CPW Overall Method |
| 2 | CPW Method Component |
| 3 | CPW Method Transformation |
| 4 | Method extensions of the CPW Process |
| 5 | Method extensions of the CPW Dialog |

| No. | Method extensions of the CPW Method: |
|---|---|
| 1 | CPW Framework |
| 2 | CPW Enterprise Architecture Framework |
| 3 | CPW Enterprise Architecture Engine |

| No. | Method extensions of the CPW Method: |
|---|---|
| 1 | The CPW Process, the CPW Dialog and the CPW Workflow with |
| | Swimlanes |
| 2 | The CPW Process, CPW Workflow synchronized with the CPW |
| | Functional Model (CPW Functional Diagram, CPW Functional |
| | Requirements) |
| 3 | Method transformation of the CPW Process in a UML Activity |
| | Diagram |
| 4 | Method transformation of the CPW Process in a BPMN Business |
| | Process Diagram (BPD) |
| 5 | The CPW Process, the CPW Workflow and the CPW Dialog |
| | integrated in a sociocultural dialog |
| 6 | The CPW Process 2d, CPW Workflow 2d |
| 7 | The CPW Dialog 2d |
| 8 | The CPW Context Diagram 2d (CPW Object Context Diagram 2d, |
| | CPW Subject Context Diagram 2d, |
| | CPW Subject Object Context Diagram 2d) |

| No. | CPW Method Transformation |
|---|---|
| 1 | CPW Method Transformation |
| 2 | CPW Method Transformation Relationship |
| 3 | Direct CPW Method Transformation |
| 4 | Indirect CPW Method Transformation |
| 5 | Manual CPW Method Transformation |
| 6 | Automatic CPW Method Transformation |

| No. | CPW Framework |
|---|---|
| 1 | CPW Framework |
| 2 | CPW Framework Configuration |
| 3 | CPW Method Component Instance |
| 4 | CPW Method Component CPW Sign-off Process |
| 5 | Function Synchronization for the CPW Frameworks |
| 6 | CPW Triangle |

| No. | Variants of the CPW Context Diagram Process Transformations |
|---|---|
| 1 | Variant A Method Transformation of CPW Object Context |
| | Diagram Process Transformation |
| 2 | CPW Object Flow Context Diagram |
| 3 | CPW Subject Object Flow Context Diagram |
| 4 | CPW Subject Object Process Flow Context Diagram |
| 5 | Variant B Method Transformation of CPW Subject Object Context |
| | Diagram Process Transformation |
| 6 | Variant C Method Transformation of CPW Object Context |
| | Diagram Process Transformation |

| No. | CPW Method Components and CPW Method Transformations |
|---|---|
| 1 | CPW Expert Concept |
| 2 | CPW Diagnostic Assessment |
| 3 | CPW Diagnostic Assessment Change Management Transformation |
| 4 | CPW Change Management Plan Transformation |
| 5 | CPW Change Management Process Transformation |

| No. | CPW Method Transformation |
|---|---|
| 1 | CPW Process Plan Transformation |
| 2 | CPW Plan Process Transformation |

| No. | CPW Method Transformation |
|---|---|
| 1 | CPW Change Management Functional Requirements |
| | Transformation |
| 2 | CPW Functional Requirements Functional Diagram |
| | Transformation |
| 3 | CPW Functional Requirements Context Diagram Transformation |
| 4 | CPW Functional Diagram Subject Object Context Diagram |
| | Transformation |
| 5 | CPW Functional Diagram Object Flow Context Diagram |
| | Transformation |
| 6 | CPW Functional Requirements Process Transformation |
| 7 | CPW Functional Requirements Plan Transformation |

| No. | CPW Method Component and CPW Method Transformation |
|---|---|
| 1 | Method Transformation of BDM/ERD to CPW Subject Object |
| | Context Diagram |
| 2 | CPW Context Diagram BDM Transformation |
| 3 | CPW Subject Object Relationship Diagram |
| 4 | Method Transformation of BDM/ERD to CPW Subject Object |
| | Relationship Diagram |
| 5 | CPW Context Diagram Subject Object Relationship Diagram |
| | Transformation |
| 6 | Method Transformation of an Entity Relationship Diagram |
| | to a CPW Process or CPW Workflow |
| 7 | CPW BDM Process Transformation |

| No. | CPW Method Component and external Method Components |
|---|---|
| 1 | CPW Business System Description |
| 2 | Business Case (BC), Specification Case (SC), Production |
| | Case (PC) |
| | CPW Enterprise Architecture Framework and CPW Enterprise |
| No. | Architecture Engine |
| 1 | CPW Enterprise Architecture Framework |
| 2 | Rules, High Level Key Requirements and functions for the CPW |
| | Enterprise Architecture Framework or the CPW Enterprise |
| | Architecture Framework Engine |
| 3 | The function of synchronization of the CPW Enterprise |
| | Architecture Framework and the CPW Enterprise Architecture |
| | Engine |
| 4 | The CPW Method Transformation of the CPW Enterprise |
| | Architecture Framework and the CPW Enterprise Architecture |
| | Engine |
| 5 | Rules, High Level Key Requirements and Functions for the CPW |
| | Enterprise Architecture Framework or the CPW Enterprise |
| | Architecture Framework Engine for the Function Security |
| 6 | Variants and examples of CPW Enterprise Architecture Frameworks |
| 7 | CPW Enterprise Architecture Frameworks and CPW Enterprise |
| | Architecture Engine as an application |
| 8 | Technical System Description of the CPW Enterprise Architecture |
| | Engine |
| 9 | CPW Enterprise Architecture Framework from a service-oriented view |

### 6 CPW OVERALL METHOD, CPW METHOD COMPONENT AND CPW METHOD TRANSFORMATION

In the following chapter the following terms are introduced:
CPW Overall Method
CPW Method Component
Conjunction
Conjunction of CPW Method Components
External method components
CPW Method Transformation
Method transformation

CPW Overall Method

The CPW Method can be named as overall method or as CPW Overall Method, because it can be subdivided into different partial methods or submethods.

CPW Method Component

A Method becomes to a CPW Method Component, if it can be linked with another method, which is also then a CPW Method Component, and they together, with their possibility of the conjunction can be assigned to the CPW Overall Method. A CPW

Method Component can be also named as submethod or as partial method of the CPW Overall Method. There are different possibilities for the conjunction of CPW Method Components. In the application the CPW Method Components can be used independently of each other, however, but also together with the possibility of the conjunction.

External Method Component

An external method component belongs not to the CPW Overall Method, but it can be linked under certain conditions with a CPW Method Component.

CPW Method Transformation

A CPW Method Transformation designates the possibility, to transform a partial method of the CPW Overall Method either only partly or wholly in another partial method of the CPW Overall Method. That means, that a CPW Method Component can be transformed either only partly or wholly in another CPW Method Component. The CPW Method Transformation is a forming, how two CPW Method Components can be linked together.

Method Transformation

A Method Transformation designates the possibility, to transform a partial method of the CPW Overall Method partly or wholly in an external method component. That means, that a CPW Method Component can be transformed either only partly or wholly in an external method component. The Method Transformation is a forming, how a CPW Method Component can be linked with an external method component.

In the following chapters will be presented examples, how a CPW Method Component or external method component is transformed either only partly or wholly in another CPW Method Component.

| No. | Key terms and definitions (Schlüsselbegriffe und Definitionen) |
|---|---|
| 1 | CPW Overall Method |
| 2 | CPW Method Component |
| 3 | CPW Method Transformation |
| 4 | External method component |
| 5 | partial method and submethod |
| 6 | Conjunction |
| 7 | Conjunction of CPW Method Components |
| 8 | Method transformation |
| 9 | Method transformation of CPW Method |
| | Component to an external method component |

### 7 METHOD EXTENSIONS OF THE CPW PROCESS

In the application PCT/IB01/01337 is described, how the CPW Process is represented as Simple Sentence with subject, predicate and object. In this application can at the CPW Process the Subject, the Predicate and the Object also be named in addition as CPW Subject, CPW Predicate and CPW Object.

| No. | Grammar, Syntax and Semantics extensions of the CPW Process |
|---|---|
| 1 | The CPW Process is represented in the application PCT/IB01/01337 |
| | as Simple Sentence with subject, predicate and object. |
| 2 | Subject, Predicate and Object of the CPW Process can also be named |
| | as CPW Subject, CPW Predicate and CPW Object. |
| 3 | The CPW Process defined in the application PCT/IB01/01337 is in this |
| | application a CPW Process Step, so that the CPW Process can consists |
| | of one or more CPW Process Steps. |
| 4 | The CPW Workflow can consequently also consists of one or more CPW |
| | Process Steps. |

| | Key terms and definitions |
|---|---|
| No. | (Schlüsselbegriffe und Definitionen) |
| 1 | CPW Subject |
| 2 | CPW Predicate |
| 3 | CPW Object |
| 4 | CPW Process Step |

### 8 METHOD EXTENSIONS OF THE CPW DIALOG

| No. | Grammar, Syntax and Semantics extensions of the CPW Dialog |
|---|---|
| 1 | In the application PCT/IB01/01337 the CPW Dialog has been introduced. |
| | The CPW Dialog can be interpreted as Dialog as follows: |
| | Business Dialog |
| | System Dialog |
| | Technical Dialog |
| | Dialog between Systems |
| | Dialog from machine to machine |
| | Dialog from system to system |
| | Conversation dialog between people |
| | Conversation dialog between people with interaction to system or |
| | machine |
| | Dialog between people and environment |
| | Business Process Dialog |
| | Business System Dialog |
| | Dialog in a Business Process |
| | Dialog between man and machine or system |
| | Dialog between people |
| | Dialog between man and Business System |
| | Sociocultural dialog between people |
| | Sociocultural dialog between people and systems |
| 2 | The CPW Dialog can consists of one or more CPW Process Steps. |
| 3 | The CPW Dialog can consists of one or more CPW Processes. |
| 4 | The CPW Dialog can consists of one or more CPW Workflows. |
| 5 | The CPW Dialog can contains one or more CPW Processes. |
| 6 | The CPW Dialog can contains one or more CPW Workflows. |
| 7 | The CPW Process can contains one or more CPW Dialogs. |
| 8 | The CPW Workflow can contains one or more CPW Dialogs. |
| 9 | Is the CPW Subject of the CPW Process Step of the CPW Dialog a person, |
| | or a speaking system, so the CPW Process Step with CPW Subject, CPW |
| | Predicate and CPW Object can contains the Direct Speech or Reported |
| | Speech of the dialog, it is the CPW Dialog with Direct Speech or the |
| | CPW Dialog with Reported Speech. |
| | The CPW Predicate in this case corresponds to a verb like for example: |
| | to say, to mean, to shout, to scream, to speak . . . |

| | Key terms and definitions |
|---|---|
| No. | (Schlüsselbegriffe und Definitionen) |
| 1 | CPW Dialog |
| 2 | CPW Dialog with Direct Speech |
| 3 | CPW Dialog with Reported Speech |

### 9 CPW PROCESS, CPW DIALOG CPW WORKFLOW WITH SWIMLANES

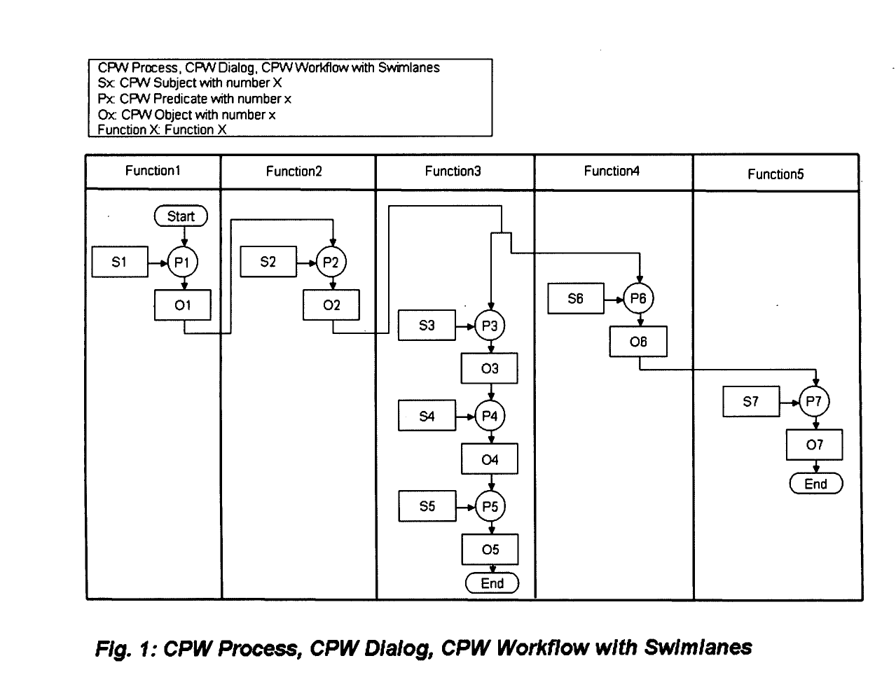

The following FIG. 1 shows the CPW Process, the CPW Dialog and the CPW Workflow represented with Swimlanes. By means of the Swimlanse the particular CPW Process Steps are assigned to the different Functions (Functions) in a column. So the CPW Process Steps are assigned to the functions, clearly arranged in the particular columns, represented through the Swimlanes and thereby the whole process is more transparent and clearer for the reader:

The FIG. 1 shows the CPW Process, CPW Dialog and CPW Workflow with Swimlanes

In FIG. 1 for example the different columns are assigned to the functions (Functions). Instead the columns with their CPW Process Steps could also be assigned to an organizational unit, a responsible person, a system or responsibility. Because the CPW Subject can also corresponds to a responsibility, a CPW Subject can be also assigned to a column overall.

| No. | Key terms and definitions (Key terms und definitions) |
|---|---|
| 1 | CPW Process, CPW Workflow, CPW Dialog with Swimlanes |
| 2 | Function (Function) |

### 10 CPW PROCESS, CPW WORKFLOW SYNCHRONIZED WITH THE CPW FUNCTIONAL MODEL

CPW Functional Model

The CPW Functional Model is the generic term for the CPW Method Components CPW Functional Diagram and CPW Functional Requirements.

Assignment of the CPW Functional Diagram to the CPW Object Context Diagram

The CPW Functional Diagram describes an Enterprise System, Business System or IT System as Functional Context Diagram. The CPW Functional Diagram can be assigned to the CPW Object Context Diagram, whereby each CPW Function can be assigned to a CPW Object. Through the structural representation of the CPW Functional Diagram the hierarchy of the CPW Functions can be defined and represented.

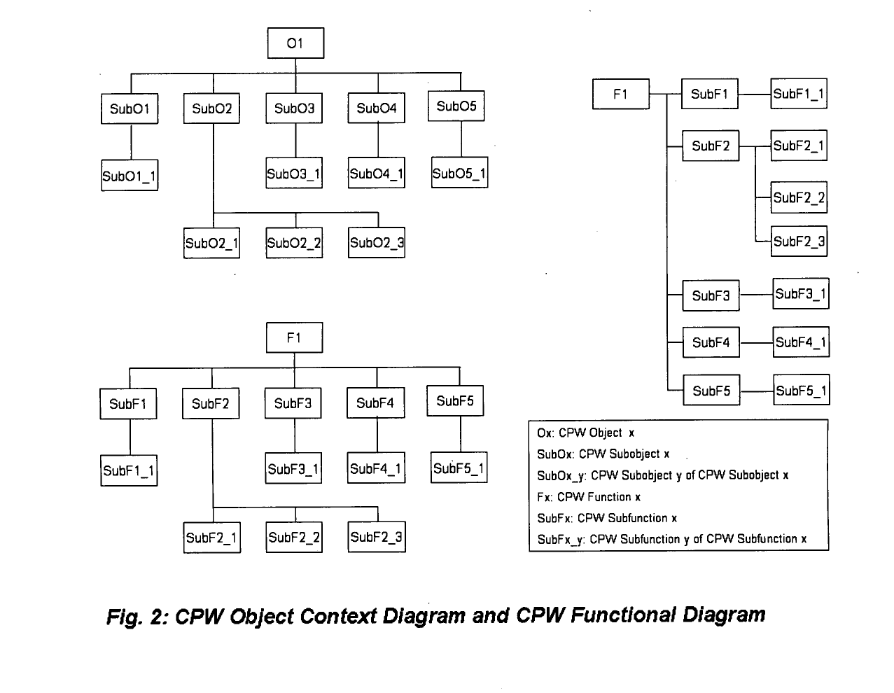

The following FIG. 2 shows a CPW Functional Diagram in two different variants, how the hierarchy of the particular CPW Functions can be represented and a CPW Object Context Diagram, which through the hierarchal representation can also be assigned to the other both CPW Functions Diagrams.

The FIG. 2 shows a CPW Object Context Diagram and two CPW Functional Diagrams.

From the methodical point of view of the CPW Method in this case the CPW Functions of the CPW Functional Diagrams are assigned to the CPW Objects of the CPW Object Context Diagrams, so that a CPW Functional Diagram can be assigned to the CPW Object Context Diagram.

Assignment of the CPW Functional Diagram to the CPW Subject Context Diagram

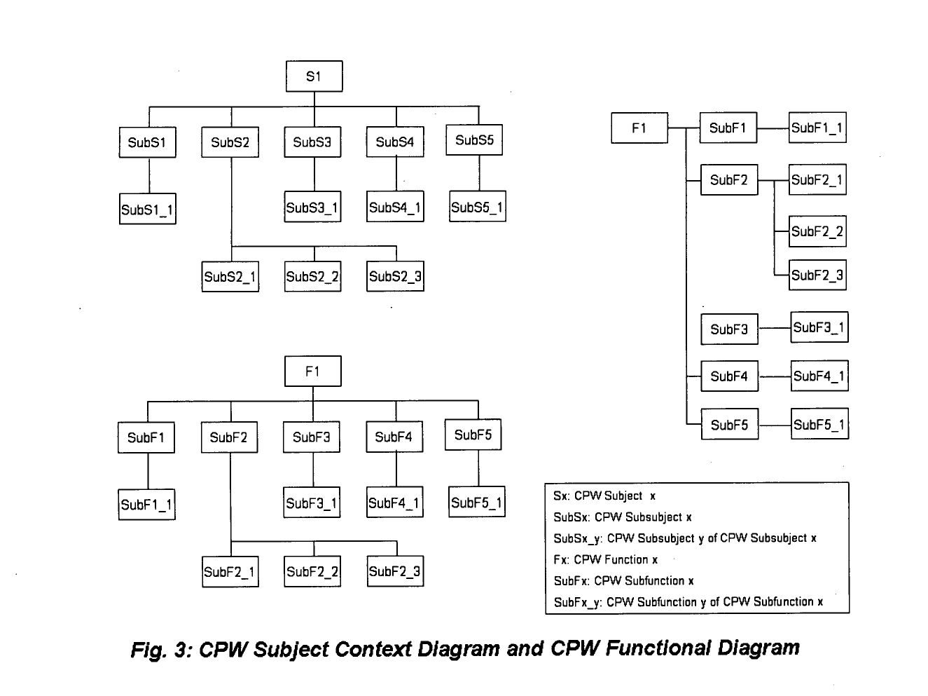

The following FIG. 3 shows the same CPW Functional Diagrams, how they have also been represented in FIG. 2. However there is in the FIG. 3. a CPW Subject Context Diagram. The CPW Subject Context Diagram corresponds the structure of the CPW Functional Diagram, so that each CPW Subject of a CPW Function or CPW Subfunction of the CPW Functional Diagram can be assigned.

The FIG. 3 shows a CPW Subject Context Diagram and two CPW Functional Diagrams.

CPW Process, CPW Workflow Synchronized with the CPW Functional Diagram

Is now the CPW Functional Diagram synchronized with the CPW Process or CPW Workflow, every single CPW Process Step with CPW Object, CPW Subject and CPW Predicate is assigned to a CPW Function or CPW Subfunction. To reach this objective, can be taken different ways. In this case the following work steps are done with the objective to synchronize the CPW Functional Diagram with the CPW Process or CPW Workflow:

| | Work steps to synchronize the CPW Functional Diagram with the |
|---|---|
| No. | CPW Process and CPW Workflow. |
| 1 | Create the CPW Functional Diagram |
| 2 | Create a CPW Object Context Diagram with the objective, that all |
| | CPW Objects can be assigned to a CPW Function or to a CPW |
| | Subfunction of a CPW Functional Diagram. |
| 3 | Create a CPW Subject Context Diagram with the objective, that all |
| | CPW Subjects can be assigned to a CPW Function or to a CPW |
| | Subfunction of a CPW Functional Diagram. |
| 4 | Create a CPW Process or CPW Workflow with all CPW Process |
| | Steps and concurrent synchronization with the CPW Functional |
| | Diagram. |

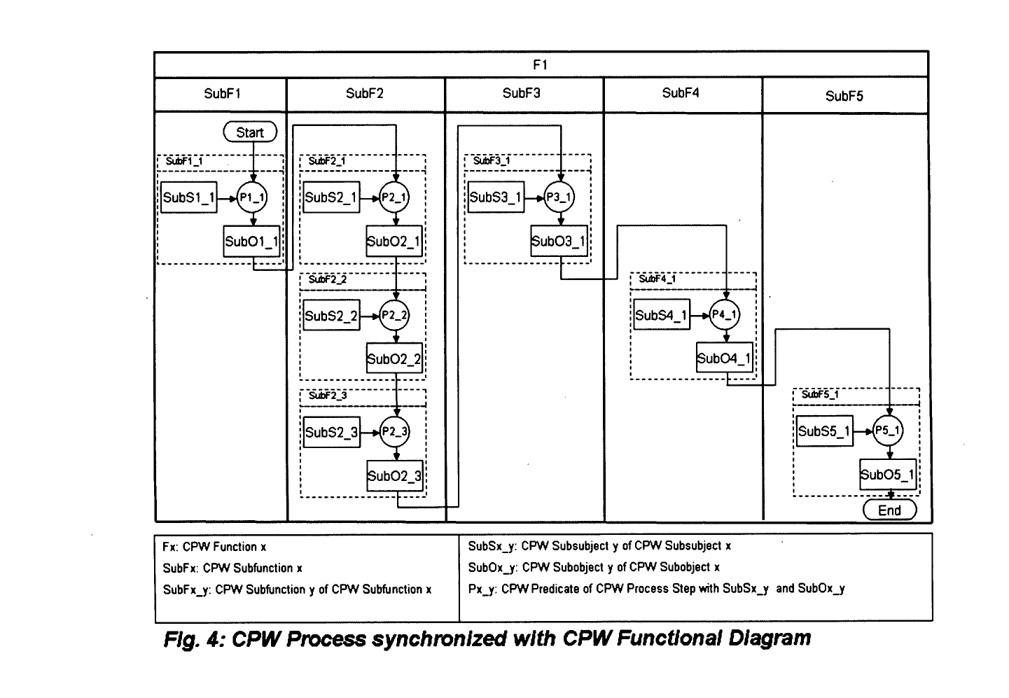

After the previous work steps then there are the following results, which are represented in the following figures FIG. 2, FIG. 3, FIG. 4:

The FIG. 2 shows a CPW Object Context Diagram and two CPW Functional Diagrams.

The FIG. 3 shows a CPW Subject Context Diagram and two CPW Functional Diagrams.

The FIG. 4 shows a CPW Process and CPW Workflow with Swimlanes and where all CPW Process Steps with CPW Subject, CPW Object and CPW Predicate are assigned and synchronized to the CPW Functions and CPW Subfunctions of the CPW Functional Diagram.

CPW Functional Requirements

The CPW Functional Requirements are represented in tabular form and describe the functions and subfunctions of an Enterprise System, Business System and IT System. How the table of the CPW Functional Requirements can be constructed, and which possible attributes there can be, is illustrated in one of the later chapter. In a later chapter is also this illustrated, how the CPW Process and the CPW Workflow is synchronized with the CPW Functional Requirements.

| No. | Key terms and definitions (Schlüsselbegriffe und Definitionen) |
|---|---|
| 1 | CPW Functional Model |
| 2 | CPW Functional Requirements |
| 3 | Functional Context Diagram |
| 4 | CPW Functional Diagram |
| 5 | CPW Function |
| 6 | CPW Subfunction |
| 7 | Assignment of the CPW Functional Diagram to the CPW Object |
| | Context Diagram |
| 8 | CPW Object Context Diagram |
| 9 | CPW Object |
| 10 | CPW Subobject |
| 11 | Assignment of the CPW Functional Diagram to the CPW Subject |
| | Context Diagram |
| 12 | CPW Subject Context Diagram |
| 13 | CPW Subject |
| 14 | CPW Subsubject |
| 15 | CPW Process synchronized with the CPW Functional Diagram |
| 16 | CPW Workflow synchronized with the CPW Functional Diagram |

### 11 METHOD TRANSFORMATION OF THE CPW PROCESS IN A UML ACTIVITY DIAGRAM

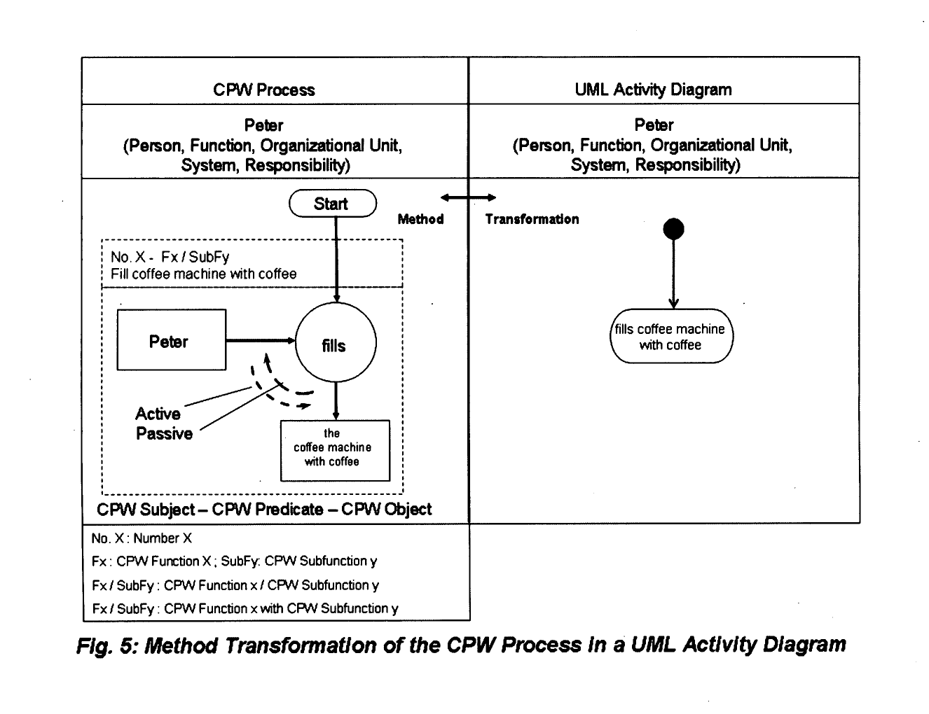

The following FIG. 5 shows the Method transformation of the CPW Process in a UML Activity Diagram. The CPW Process Step with CPW Subject, CPW Predicate and CPW Object forms the CPW Process Step: Peter fills the coffee machine with coffee. In the UML Activity Diagram is: fills coffee machine with coffee. The represented CPW Process Step is framed with the CPW Subfunction: Fill coffee machine with coffee, so that the CPW Process is sychronized with the CPW Functional Diagram. At the CPW Process as well as at the UML Activity Diagram have been applied Swimlanes, whereby the particular Swimlanes Columns have been assigned to a responsibility. In this case the Person with the name Peter. The responsibility could also be a function, an organizational unit, or a system.

The FIG. 5 shows the Method transformation of the CPW Process in a UML Activity Diagram with swimlanes. In FIG. 5 at the represented CPW Process and the UML Activity Diagram the Swimlanes Columns are assigned to the responsibility person with the name Peter.

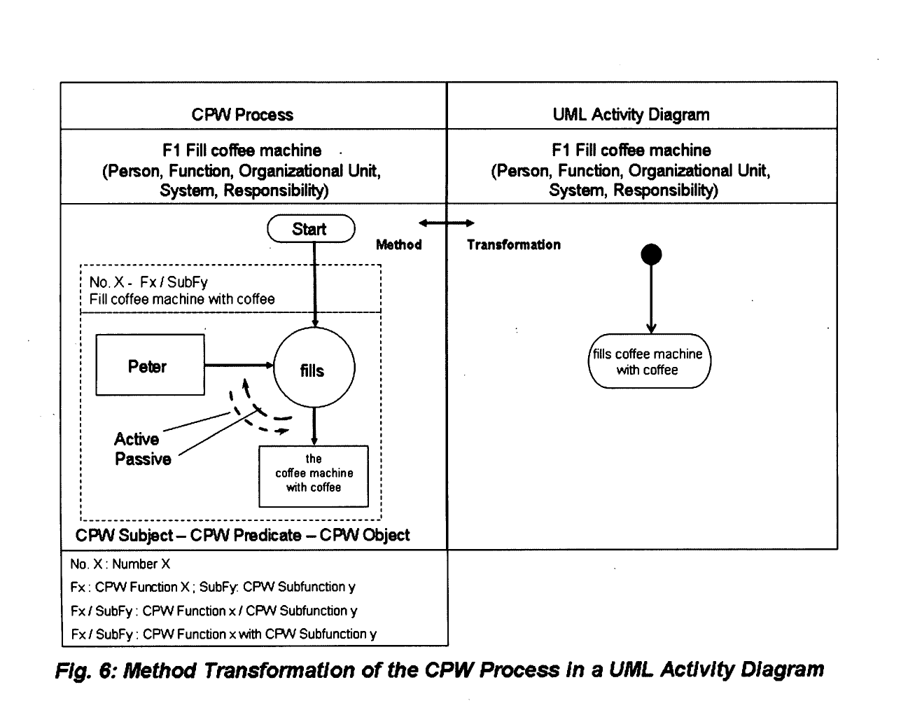

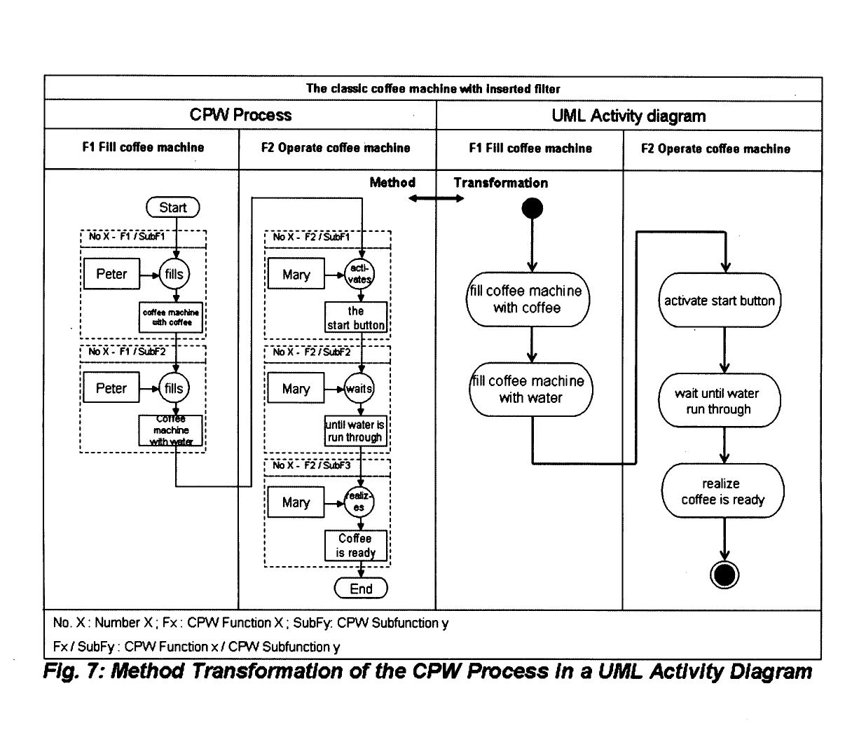

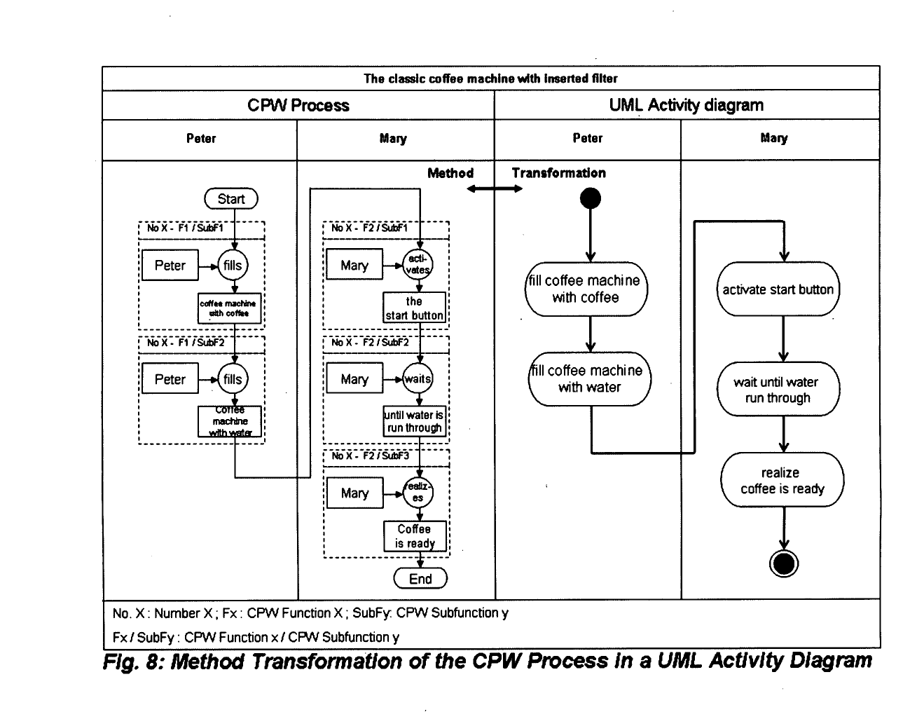

The following FIG. 6 shows as in FIG. 5 the Method Transformation of the CPW Process in a UML Activity Diagram with the difference, that the Swimlanes Columns are assigned to the Functions. The Function corresponds to the CPW Function: Fill coffee machine.

The following FIG. 7 is shown a CPW Process, which has been transformed in a UML Activity Diagram. The Swimlanes Columns are assigned to the CPW Functions F1 and F2. The CPW Functions F1 and F2 are as follows:
CPW Function F1: Fill coffee machine
CPW Function F2: Operate coffee machine

Every CPW Process Step with CPW Subject, CPW Predicate and CPW Object is framed with the assigned CPW Subfunction. The CPW Subfunction is identified through the number X (No. X), with which the CPW Process Step and the CPW Subfunction get a unique identification number. The CPW Subfunction is described through the CPW Function x/CPW Subfunction y, so that the Function is assigned to the appropriate CPW Function with CPW Subfunction. With the Assignment from CPW Function x with CPW Subfunction y to the different CPW Process Steps, is the CPW Process or CPW Workflow synchronized with the CPW Functional Diagram. It follows the legend of the FIG. 7, which describes the Functions:
No. X: Number X
Fx: CPW Function X
SubFy: CPW Subfunction y
Fx/SubFy: CPW Function x/CPW Subfunction y

The following figures FIG. 8 is shown a CPW Process, which has been transformed into an UML Activity Diagram. The difference is to FIG. 7, that the Swimlanes Columns are not assigned to the Functions, but to the responsibility person with the name Peter and Mary.

This chapter shows the Method Transformation of a CPW Process into an UML Activity Diagram. The UML Activity Diagram of the Object Management Group (OMG) can be transformed again into a BPMN Business Process Diagram.

The BPMN (Business Process Modeling Notation) is from the Business Process Management Initiative (BPMI).

| No. | Key terms and definitions (Schlüsselbegriffe und Definitionen) |
|---|---|
| 1 | Method Transformation of the CPW Process in a UML Activity |
| | Diagram |
| 2 | CPW Process |
| 3 | Method Transformation |
| 4 | CPW Function |
| 5 | CPW Subfunction |

### 12 METHOD TRANSFORMATION OF THE CPW PROCESS IN A BPMN BUSINESS PROCESS DIAGRAM (BPD)

The following FIG. 9 shows the Method Transformation of the CPW Process in a BPMN Business Process Diagram (BPD).

In the FIG. 9 is shown a CPW Process, which has been transformed in a BPMN Business Process Diagram (BPD). The Swimlanes columns are assigned to the responsibility person with the name Peter and Mary.

Each CPW Process Step with CPW Subject, CPW Predicate and CPW Object is framed with the assigned CPW Subfunction. Die CPW Subfunction is identified through the Number X (No. X), with which the CPW Process Step and the CPW Subfunction get a unique identification number. The CPW Subfunction is described through the CPW Function x/CPW Subfunction y, so that the Function is assigned to the appropriate CPW Function with CPW Subfunction. With the assignment of CPW Function x with CPW Subfunction y to the different CPW Process Steps, is the CPW Process or CPW Workflow synchronized with the CPW Functional Diagram. It follows the legend of the FIG. 9, which describes the Functions:
No. X: Number X
Fx: CPW Function X
SubFy: CPW Subfunction y
Fx/SubFy: CPW Function x/CPW Subfunction y

| No. | Key terms and definitions (Schlüsselbegriffe und Definitionen) |
|---|---|
| 1 | Method Transformation of the CPW Process in a BPMN Business |
| | Process Diagram (BPD) |
| 2 | CPW Process |
| 3 | Method Transformation |
| 4 | CPW Function |
| 5 | CPW Subfunction |

### 13 THE CPW PROCESS, CPW WORKFLOW AND CPW DIALOG INTEGRATED IN A SOCIOCULTURAL DIALOG

With the CPW Method a conversation dialog between people and with interaction to a system or a machine can be represented in a CPW Dialog. Every CPW Process Step of the CPW Dialog has the sentence structure of a Simple Sentence with CPW Subject, CPW Predicate and CPW Object. Thereby the CPW Process Steps of the CPW Dialog can include real spoken language in form of direct or indirect speech, it is the CPW Dialog with direct speech or the CPW Dialog with indirect speech. But the CPW Process Steps can also include activities or interactions of persons to a system or a machine. The CPW Process Steps can furthermore also describe the processes of a system or of a machine. In the CPW Dialog can be basically described the whole happenings with all involved, as well as man and system or machine, with all relevant occurrences and events. This means, that in a CPW Dialog the sociocultural Dialog of people between themselves and with interaction to system or machine can be described. Or It can also be described with the CPW Dialog the processes of the systems or machines by itself, which are again in interaction with people and persons.

This can helps at the application within the analysis to an enormous depth of sharpness, to have considered all, what relevant is in the analysis. The CPW Dialog can be almost read as a spoken language in direct and indirect speech and at the same time is described in the CPW Dialog the interaction of the people with the system or the machine, as well as itself the processes of the system or the machine.

Through the representation of the CPW Process Steps of the CPW Dialog and their possibility to represent the CPW Process Steps in indirect and direct speech, is the describing process or dialog much more readable and much more transparent as conventional methods.

So it can be achieved with the application of the CPW Dialog within the analysis phase a higher grade or an enormous depth of sharpness.

Through the description of the event with the CPW Dialog is integrated the sociocultural behaviour of the people in the Business Processes and in the technical Processes.

Is the analysis satisfying and corresponds to the necessary requirements, can be extracted from the sociocultural CPW Dialog the technical processes and the Business Processes as CPW Process or CPW Workflow.

Afterwards can be refined in itself then the technical processes and the Business Processes as CPW Processes or CPW Workflows and if the result is satisfying, then the CPW Processes and CPW Workflows can be integrated again in the sociocultural Dialog, to counter-check, if all relevant aspects of the analysis have been considered.

Through the representation of the CPW Dialog of the particular CPW Process Steps with CPW Subject, CPW Predicate and CPW Object is the process for people from the IT, Engineering, Business, people, which has nothing to do with business and technology, culture, politics and other areas much more clearer, readable and transparent.

In the following table are described the possible work steps, in order to transform and to create from a Dialog a CPW Dialog, and then to create or to transform from this CPW Dialog a CPW Process or CPW Workflow.

| | Work steps, in order to create or to transform from a Dialog |
|---|---|
| No. | a CPW Dialog, CPW Process or CPW Workflow. |
| 1 | A Dialog is transformed in a CPW Dialog, in which every CPW |
| | Process Step of a CPW Dialog corresponds to the structure of a |
| | Simple Sentence with CPW Subject, CPW Predicate and CPW |
| | Object. |
| 2 | The CPW Process Step of a CPW Dialog can contains direct or |
| | indirect speech, it is the CPW Dialog with direct speech or the |
| | CPW Dialog with indirect speech. |
| 3 | The CPW Dialog can contains a sociocultural Dialog between |
| | people and interaction with a system. |
| 4 | The CPW Dialog can also describes the processes of a system or of |
| | a machine, which are in interaction with humans. |
| 5 | In the next step is extracted from the CPW Dialog the Business |
| | Process as CPW Process or CPW Workflow. |
| 6 | The criteria for the Extraction of the CPW Process or of the CPW |
| | Workflow from the CPW Dialog are dependent on the objective, |
| | what you follow and what you want to aim for with the to be |
| | created CPW Process or CPW Workflow. The CPW Process and |
| | the CPW Workflow can describe a Business Process, a System or |
| | a product. |
| 7 | Objective of the Extraction of the CPW Dialog and the creation of |
| | the CPW Process or of the CPW Workflow is to come close as |
| | possible to the requirements of the to be described Business |
| | Process, System or product. |
| 8 | In this step is refined the extracted CPW Process or the CPW |
| | Workflow in its processes, to come close as possible to the |
| | objectives and the necessary requirements. |
| 9 | The result is a CPW Process or a CPW Workflow, which describes |
| | a Business Process, a system, or a product, which can be integrated |
| | in a sociocultural Dialog, which is described through the CPW |
| | Dialog. |

It follows an example of a CPW Dialog, where Mary and Peter make coffee together with a coffee machine, at which the filter is already inserted.

The CPW Process Steps, each with CPW Subject, CPW Predicate and CPW Object are represented as follows:

CPW Process Step Number: S: CPW Subject P: CPW Predicate O: CPW Object

Example for a CPW Dialog: Peter and Mary make coffee with a Filter Coffee Machine:

1: S: Peter P: says O: to Mary: “Do you want a coffee?”

2: S: Mary P: says O: to Peter: “Why ever not.”

3: S: Mary P: says O: to Peter: “Paul wants also one.”

4: S: Peter P: says O: to Mary: “So, three coffee then.”

5: S: Peter P: fills O: the coffee machine with water.

6: S: Peter P: fills O: the coffee filter with coffee powder.

7: S: Peter P: says O: to Mary: “Could you use the coffee machine?”

8: S: Mary P: says O: to Peter: “I make it, no problem.”

9: S: Mary P: starts O: the coffee machine start button.

10: S: Mary P: waits O: until the water is run through.

11: S: Mary P: realizes O: the water is run through.

12: S: Mary P: says O: to Peter: “The coffee is ready.”

13: S: Peter P: pours out O: the three cups with coffee.

14: S: Peter P: says O: to Mary: “With milk and with sugar?”

15: S: Mary P: says O: to Peter: “Paul and me with milk and without sugar please.”

16: S: Peter P: pours out O: into the three cups the milk.

17: S: Mary and Peter P: drink O: the coffee with pleasure.

18: S: Mary P: says O: to Peter: “That has really a very good aroma!”

19: S: Peter P: says O: to Mary: “I have taken the Brazilian one!”

20: S: Paul P: says O: to Mary and Peter: “Thanks for the coffee!”

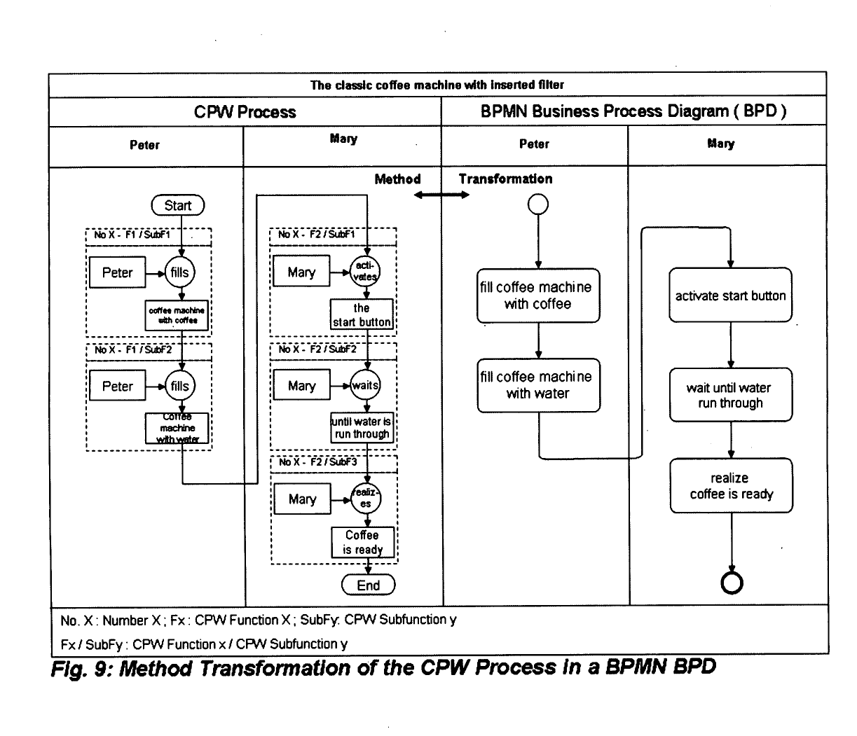

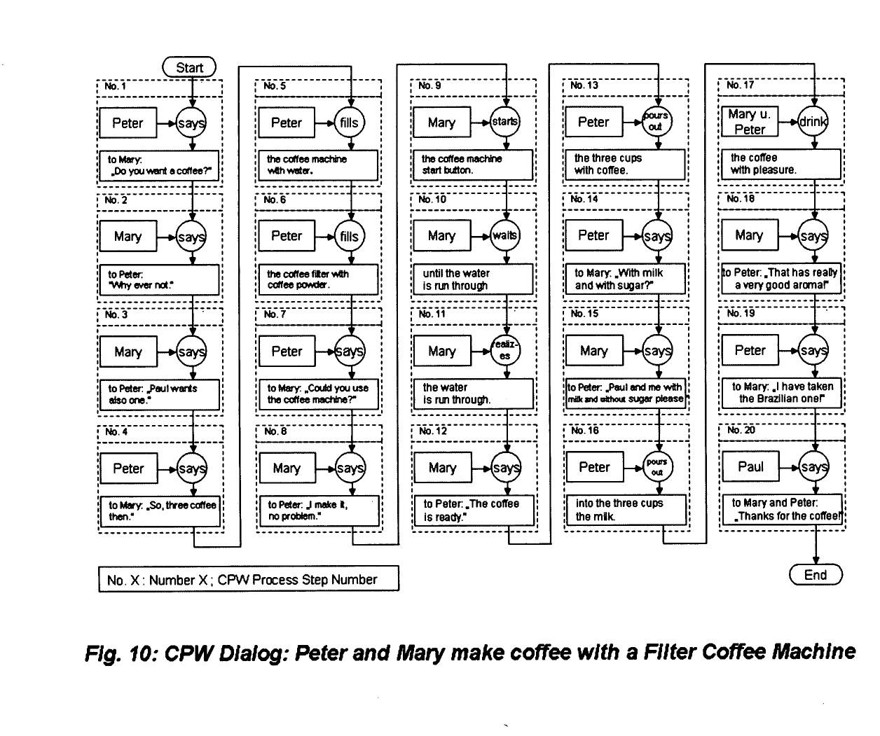

In the following FIG. 10 are represented the previous CPW Process Steps as CPW Dialog, where the sociocultural behaviour from people and persons is integrated in a technical process and Business Process. The FIG. 10 shows the CPW Dialog: Peter and Mary make coffee with a filter coffee machine.

From the previous CPW Dialog the CPW Process or CPW Workflow is now extracted with the relevant CPW Process Steps. To the precondition is, that the filter for the filter coffee machine has already been inserted. In addition the CPW Process Steps are described, which describe closer the process of the coffee machine.

The CPW Process Steps, each with CPW Subject, CPW Predicate and CPW Object are represented as follows:

CPW Process Step Number: S: CPW Subject P: CPW Predicate O: CPW Object

Example for a CPW Process or CPW Workflow: Peter arid Mary make coffee:

1: S: Peter P: fills O: the coffee machine with three cups of water.

2: S: Peter P: fills O: the filter with coffee powder for three cups.

3: S: Mary P: starts O: the coffee machine start button.

4: S: Coffee machine pump P: draws O: the water out of the reservoir.

5: S: Boiler P: heats O: the sucked in water.

6: S: The heated water P: runs O: into the filter with coffee powder.

7: S: The coffee P: runs O: into the glass pot.

8: S: Mary P: waits O: until the water has run completely through the filter.

9: S: Mary P: realizes O: the water is run through.

10: S: Peter P: pours out O: into the three cups the coffee.

11: S: Peter P: pours out O: into the three cups a little bit milk.

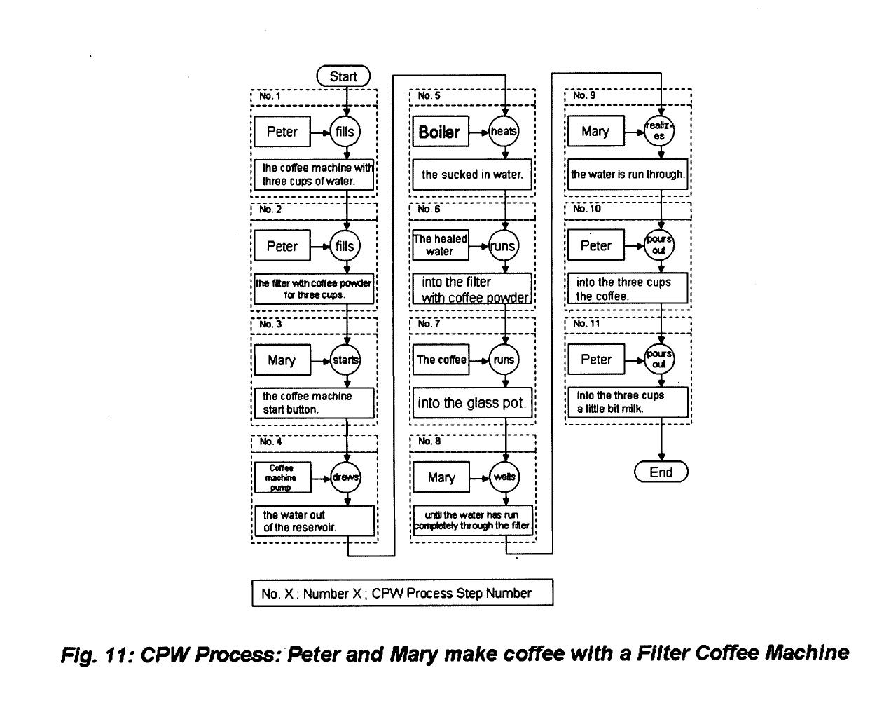

The FIG. 11 shows the previous described CPW Process or CPW Workflow: Peter and Mary make coffee with a filter coffee machine.

The created CPW Process and CPW Workflow is in the sociocultural context and dialog of the previous created CPW Dialog.

| No. | Key terms and definitions (Schlüsselbegriffe und Definitionen) |
|---|---|
| 1 | CPW Dialog |
| 2 | CPW Dialog integrated into a sociocultural Dialog |
| 3 | CPW Process, CPW Workflow |
| 4 | CPW Process Step Number |
| 5 | The CPW Dialog with direct speech |
| 6 | The CPW Dialog with indirect speech |
| 7 | Sociocultural Dialog |
| 8 | The processes of the systems or machines |
| 9 | Extraction of the CPW Process or of the CPW Workflow from the |
| | CPW Dialog |
| 10 | Business Process |
| 11 | Technical Processes |

### 14 CPW PROCESS 2d, CPW WORKFLOW 2d, CPW DIALOG 2d AND CPW CONTEXT DIAGRAM 2d

The CPW Process 2d and CPW Workflow 2d is for it, that the CPW Process and CPW Workflow are represented in a two dimensional plane.

The structure of the represented CPW Process Step within a CPW Process or CPW Workflow corresponds to a homogeneous alignment, to make the CPW Process or CPW Workflow readable as possible, so that the processes for the Business Process Engineer are as easy to read as possible and are represented didactical good.

At the CPW Process 2d and CPW Workflow 2d, the CPW Process Steps can be represented and arranged in a two dimensional plane that way, so that the CPW Process Steps can be assigned to the geographical points, places and figures in a two dimensional plane. It is the assignment of the CPW Process Steps of the CPW Process 2d or CPW Workflow 2d to the geographical points, places and figures in a two dimensional plane.

This can be a map with a scale, on which the various CPW Process Steps of the CPW Process 2d or CPW Workflow 2d can be assigned to the places, points, or figures of a geographical, two dimensional map.

Or it can also be a two dimensional plan with a scale, at which various places, points, or figures can be assigned to the CPW Process Steps of the CPW Process 2d or of the CPW Workflow 2d.

The same principle goes also for the CPW Dialog 2d, at which at a map or a plan with a scale the CPW Process Steps of the CPW Dialogs 2d can be assigned to the places, points, and figures.

Furthermore this principle also goes for the CPW Context Diagram 2d, at which at a map or a plan with a scale the CPW Objects or the CPW Subjects of the CPW Context Diagrams 2d can be assigned to the places, points, and figures of the map or of the plan.

Here again the overview, how the CPW Methods are labeled with 2d as follows:

| No. | CPW Method with 2d |
|---|---|
| 1 | CPW Process 2d |
| 2 | CPW Workflow 2d |
| 3 | CPW Dialog 2d |
| 4 | CPW Context Diagram 2d |
| 5 | CPW Object Context Diagram 2d |
| 6 | CPW Subject Context Diagram 2d |
| 7 | CPW Subject Object Context Diagram 2d |

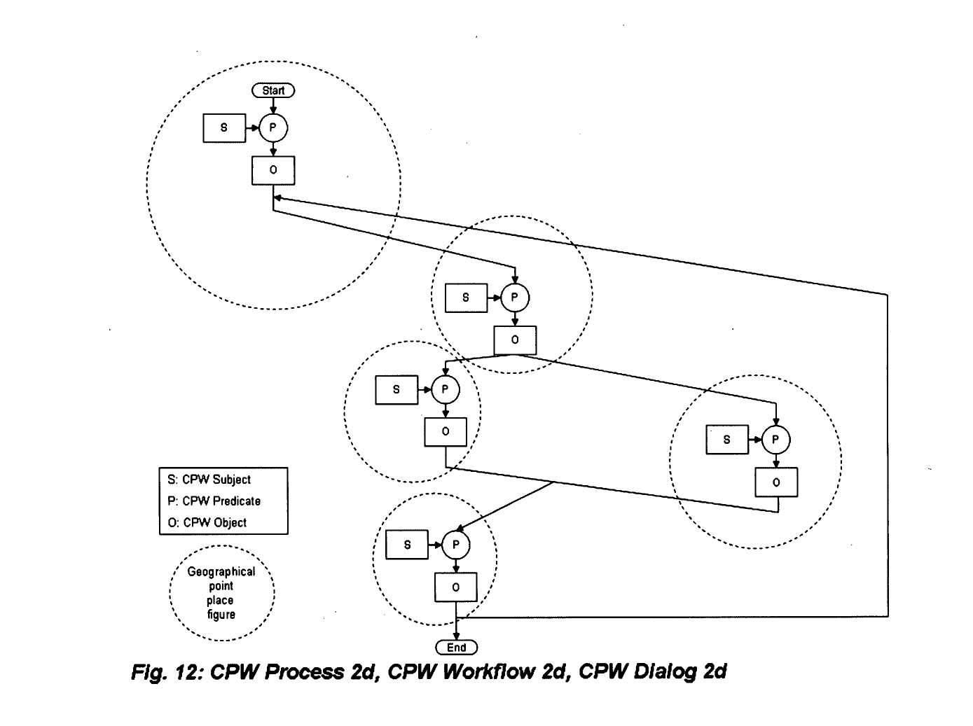

The following FIG. 12 shows an example for a CPW Process 2d, CPW Workflow 2d and CPW Dialog 2d.

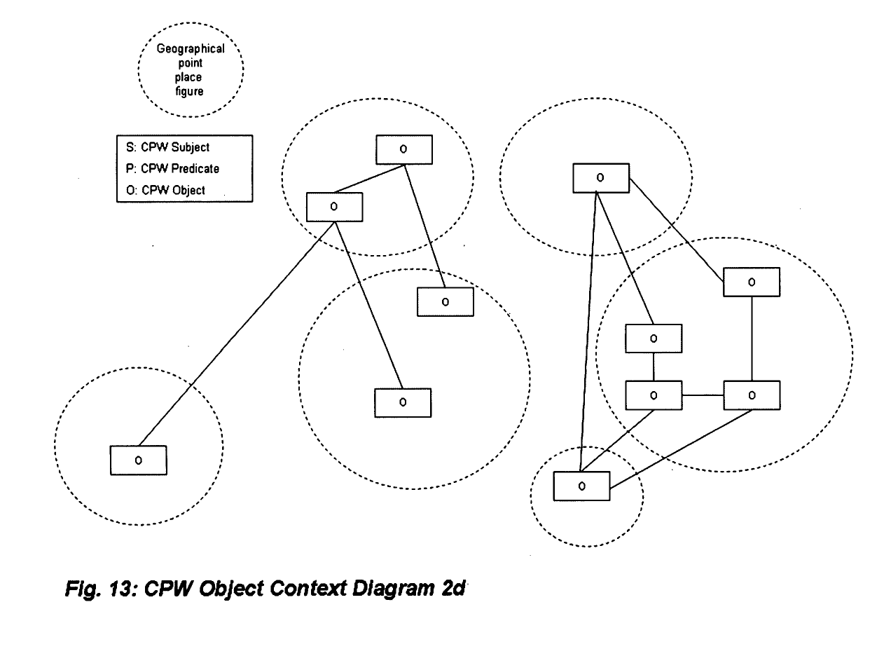

The following FIG. 13 shows an example for a CPW Object Context Diagram 2d.

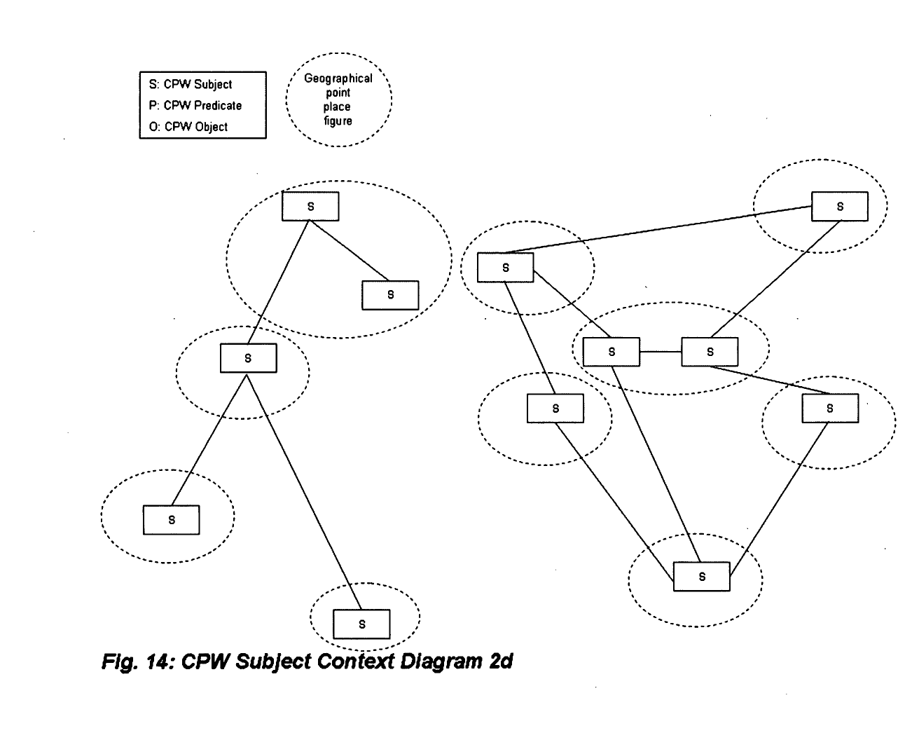

The following FIG. 14 shows an example for a CPW Subject Context Diagram 2d.

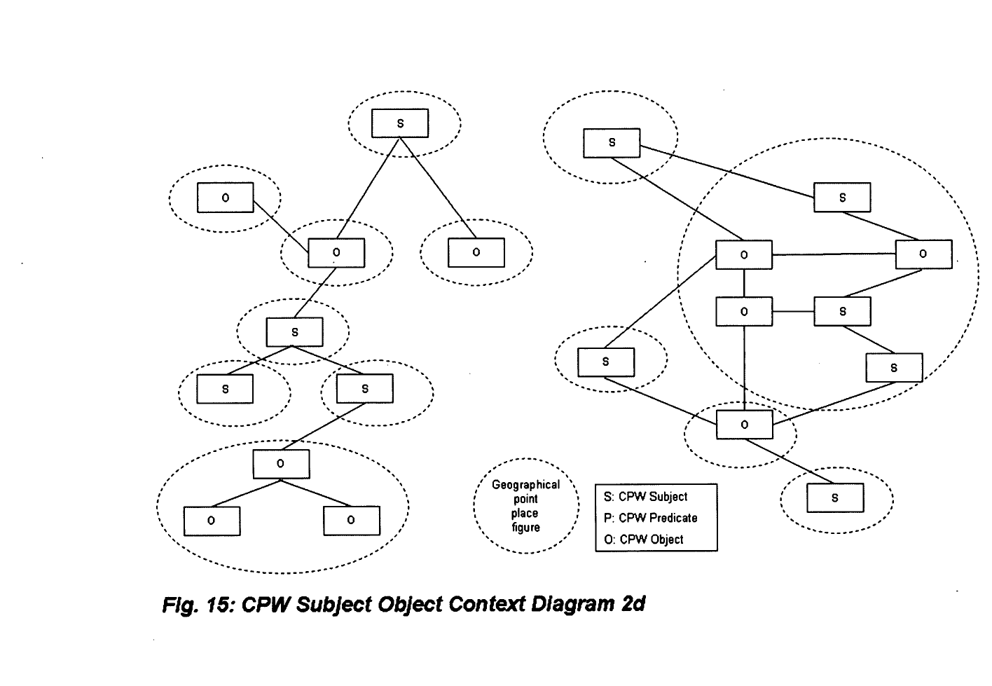

The following FIG. 15 shows an example for a CPW Subject Object Context Diagram 2d.

| No. | Key terms and definitions (Schlüsselbegriffe und Definitionen) |
|---|---|
| 1 | CPW Process 2d |
| 2 | CPW Workflow 2d |
| 3 | CPW Dialog 2d |
| 4 | CPW Context Diagram 2d |
| 5 | CPW Object Context Diagram 2d |
| 6 | CPW Subject Context Diagram 2d |
| 7 | CPW Subject Object Context Diagram 2d |
| 8 | Geographical points, places and figures in a two dimensional plane |
| 9 | Assignment of the CPW Process Steps of the CPW Process 2d or |
| | CPW Workflow 2d to the geographical points, places and figures |
| | in a two dimensional plane. |

### 15 CPW METHOD TRANSFORMATION

In the following table are defined rules, High Level Key Requirements and functions for the CPW Method Transformation.

| | Rules, High Level Key Requirements and Functions for the CPW |
|---|---|
| No. | Method Transformation |
| 1 | At the CPW Method Transformation is transformed a CPW Method |
| | Component either partly or wholly in another CPW Method Component. |
| 2 | At the performed CPW Method Transformation of a CPW Method |
| | Component in another CPW Method Component are in the manner, how |
| | has been transformed, the CPW Method Components in a Relationship to |
| | each other. The CPW Method Components are in the following manner |
| | through the performed CPW Method Transformation in relationship to |
| | each other: |
| | 1:1 CPW Method Transformation Relationship |
| | 1:M CPW Method Transformation Relationship |
| | N:1 CPW Method Transformation Relationship |
| | N:M CPW Method Transformation Relationship |
| 3 | At the CPW Method Transformation is distinguished between the |
| | functions of the direct CPW Method Transformation and the indirect |
| | CPW Method Transformation. |
| | Is there at the CPW Method Transformation a 1:1 CPW Method |
| | Transformation Relationship, so you speak of a direct CPW Method |
| | Transformation. |
| | Is there at the CPW Method Transformation a 1:M, N:1 or a N:M CPW |
| | Method Transformation Relationship, so you speak of a indirect CPW |
| | Method Transformation. |
| | How the functions of the CPW Method Transformations are performed in |
| | particular, is described in the following chapters. |
| | Direct CPW Method Transformation |
| | Indirect CPW Method Transformation |
| 4 | At the CPW Method Transformation is also distinguished among other |
| | things between the functions of the manual and of the automatic CPW |
| | Method Transformation. |
| | At the manual CPW Method Transformation is transformed a CPW Method |
| | Component in another CPW Method Component partly or wholly manual |
| | through a person with the appropriate function. |
| | At the automatic CPW Method Transformation is transformed a CPW |
| | Method Component partly or wholly automatic through a system or the |
| | engine. |
| | Manual CPW Method Transformation |
| | Automatic CPW Method Transformation |

| | Key terms and definitions |
|---|---|
| No. | (Schlüsselbegriffe und Definitionen) |
| 1 | CPW Method Transformation |
| 2 | CPW Method Component |
| 3 | CPW Method Transformation Relationship |
| 4 | Direct CPW Method Transformation |
| 5 | Indirect CPW Method Transformation |
| 6 | Manual CPW Method Transformation |
| 7 | Automatic CPW Method Transformation |

### 16 CPW FRAMEWORK

In the following table are defined Rules, High Level Key Requirements and Functions of the CPW Framework with CPW Method Components.

| | Rules, High Level Key Requirements and Functions of the CPW |
|---|---|
| No. | Framework with CPW Method Components |
| 1 | One or more CPW Method Components can be assigned to a CPW |
| | Framework. |
| 2 | The CPW Method Components, which are assigned to a CPW Framework, |
| | can be applied independent of each other. |
| 3 | However the CPW Method Components can be also linked together. So, |
| | the interaction of the CPW Method Components within a CPW Framework |
| | is named as Conjunction. It is the Conjunction of CPW Method |
| | Components within a CPW Framework. |
| 4 | A possibility or application of the conjunction of two CPW Method |
| | Components in a CPW Framework is given through the application of the |
| | CPW Method Transformation between two CPW Method Components. |
| 5 | The applied CPW Method Transformation between two CPW Method |
| | Components in a CPW Framework can be the direct CPW Method |
| | Transformation, the indirect CPW Method Transformation, the automatic |
| | CPW Method Transformation or the manual CPW Method Transformation. |
| | But the listed CPW Method Transformations can be also combined like for |
| | example an automatic and direct CPW Method Transformation. |
| 6 | Which CPW Method Components are assigned to a CPW Framework, and |
| | in which matter the CPW Method Components are linked together, is |
| | named as CPW Framework Configuration. |
| 7 | Which CPW Method Components are assigned to a CPW Framework, and |
| | in which matter the CPW Method Transformation is applied to the CPW |
| | Method Components, belongs also to the CPW Framework |
| | Configuration. |
| 8 | CPW Method Component Instances |
| | Within a CPW Framework can be created from a CPW Method |
| | Component one to several CPW Method Component Instances. This |
| | means for example, that from the CPW Method Component CPW Plan can |
| | be created several plans and these can be filled with content. |
| 9 | Die CPW Method Component CPW Sign-off Process |
| | The CPW Method Component CPW Sign-off Process describes the |
| | Process, where the decision maker or responsibilities decide over the |
| | further proceeding or authorize regarding the contents of the CPW Method |
| | Component Instances. |
| | The CPW Method Components, which are linked together within a CPW |
| | Framework, have to be or can run through the CPW Sign-off Process in |
| | the work steps between the various CPW Method Components. |

| | Rules, High Level Key Requirements and Functions for the CPW |
|---|---|
| No. | Frameworks for the Function Synchronization |
| 1 | The Synchronization of two CPW Frameworks with equal CPW Method |
| | Components describe the possibility, that the content of the CPW |
| | Method Component Instances, which are assigned to the two various |
| | CPW Frameworks, can be synchronized partly or wholly. |
| 2 | The Synchronization of two CPW Frameworks can takes place manual or |
| | automatic. The manual Synchronization of two CPW Frameworks is |
| | performed through a person with corresponding function. The automatic |
| | Synchronization of two CPW Frameworks is performed according fixed |
| | defined rules through the system or the engine. The fixed defined |
| | rules, in which matter the CPW Frameworks should be synchronized, is |
| | configurable through the system or the engine. To the configuration |
| | also belongs among others, in what way the CPW Frameworks should be |
| | synchronized in real-time or in periodic time intervals. |

| | Key terms and definitions |
|---|---|
| No. | (Schlüsselbegriffe und Definitionen) |
| 1 | CPW Framework |
| 2 | CPW Method Component |
| 3 | Conjunction of CPW Method Components |
| 4 | Conjunction of CPW Method Components within a CPW |
| | Framework |
| 5 | CPW Method Transformation |
| 6 | CPW Framework Configuration |
| 7 | CPW Method Component Instances |
| 8 | CPW Method Component CPW Sign-off Process |
| 9 | Manual synchronization of two CPW Frameworks |
| 10 | Automatic synchronization of two CPW Frameworks |
| 11 | Function Synchronization for the CPW Frameworks |

### 17 PRESENTATION METHOD OF THE CPW FRAMEWORKS

Presentation Method of the CPW Frameworks with CPW Method Components

In the following table are defined Rules and High Level Key Requirements, how the CPW

Frameworks with the corresponding CPW Method Components are represented. It is the presentation method of the CPW Frameworks with CPW Method Components.

| | Rules and High Level Key Requirements, how the CPW Frameworks |
|---|---|
| No. | with the CPW Method Components are represented. |
| 1 | The CPW Framework with the various CPW Method Components is |
| | represented through a context diagram with directional arrows. A |
| | directional arrow between two CPW Method Components indicates, |
| | that the two CPW Method Components are linked together. |
| 2 | Point the directional arrow to both CPW Method Component between two |
| | CPW Method Components, so is in both directions a work step possible at |
| | a conjunction of two CPW Method Components. Point the directional arrow |
| | from a CPW Method Component to the other CPW Method Component, so |
| | is only in one direction a work step possible at a conjunction of two CPW |
| | Method Components. Point the directional arrow from the corresponding |
| | CPW Method Component to itself, so is a multiple iterative work step |
| | possible within the corresponding CPW Method Component. A work step |
| | at a conjunction of two CPW Method Components can be for example a |
| | CPW Method Transformation. |

| | Key terms and definitions |
|---|---|
| No. | (Schlüsselbegriffe und Definitionen) |
| 12 | Presentation method of the CPW Frameworks with CPW Method |
| | Components |
| 13 | Directional arrow between two CPW Method Components |
| 14 | Work Step at a conjunction of two CPW Method Components |

### 18 CPW TRIANGLE

In the application PCT/IB01/01337 the CPW Method with CPW Process and CPW Context Diagrams in the realization process of a project has been represented in that way in a triangle, so that the CPW Method can be applied in Business as also in the IT in the following levels horizontal as also vertical.

| No. | CPW Method applied in Business as also in IT |
|---|---|
| 1 | Vision |
| 2 | Strategy |
| 3 | Policy, directives |
| 4 | Architecture, infrastructure |
| 5 | Realization EAI |
| 6 | Operation - Production |

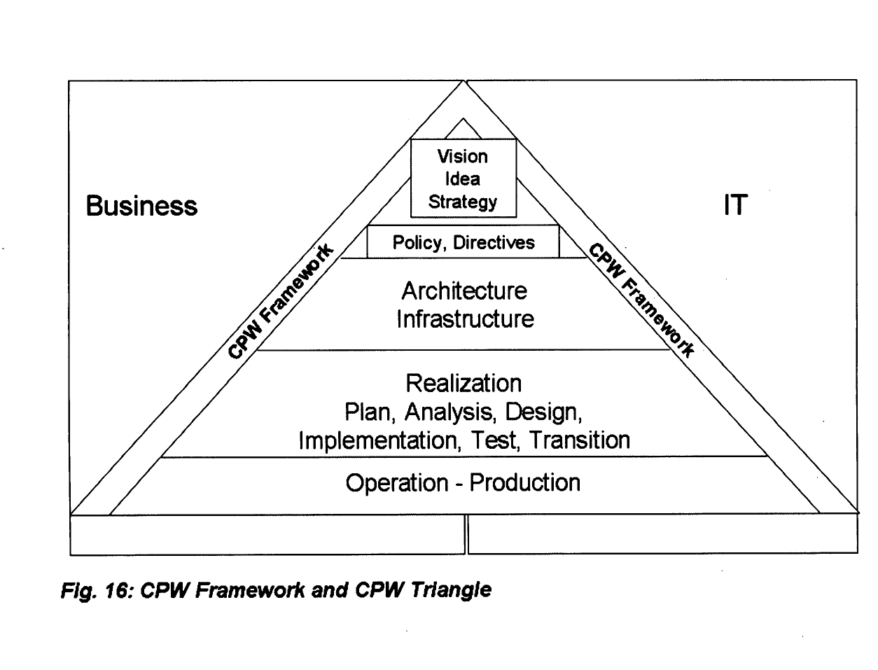

The following FIG. 16 shows the triangle as CPW Triangle with the realization levels of a project in Business and IT, how on the various realization levels the CPW Framework can be applied.

In the following chapters the CPW Method or CPW Overall Method is extended, among other things also through additional CPW Method Components, which then can also be applied on the various levels in the CPW Triangle.

Also it follows in the following chapters, how the various variants of CPW Frameworks can be applied in the CPW Triangle.

| No. | Key terms and definitions (Schlüsselbegriffe und Definitionen) |
|---|---|
| 1 | CPW Triangle |
| 2 | CPW Frameworks |

### 19 VARIANT A METHOD TRANSFORMATION OF CPW OBJECT CONTEXT DIAGRAM PROCESS TRANSFORMATION

In this chapter is introduced the Variant A Method Transformation of a CPW Object Context Diagram in a CPW Process or CPW Workflow, the so-called CPW Object Context Diagram Process Transformation. For the CPW Object Context Diagram Process Transformation are required the following work steps:

| | Work Steps for the CPW |
|---|---|
| No. | Object Context Diagram Process Transformation |
| 1 | Initial situation is CPW Object Context Diagram |
| 2 | Creation of the CPW Object Flow Context Diagram |
| 3 | Creation of the CPW Subject Object Flow Context Diagram |
| 4 | Creation of the CPW Subject Object Process Flow Context |
| | Diagram |
| 5 | Creation of the CPW Process or CPW Workflow |

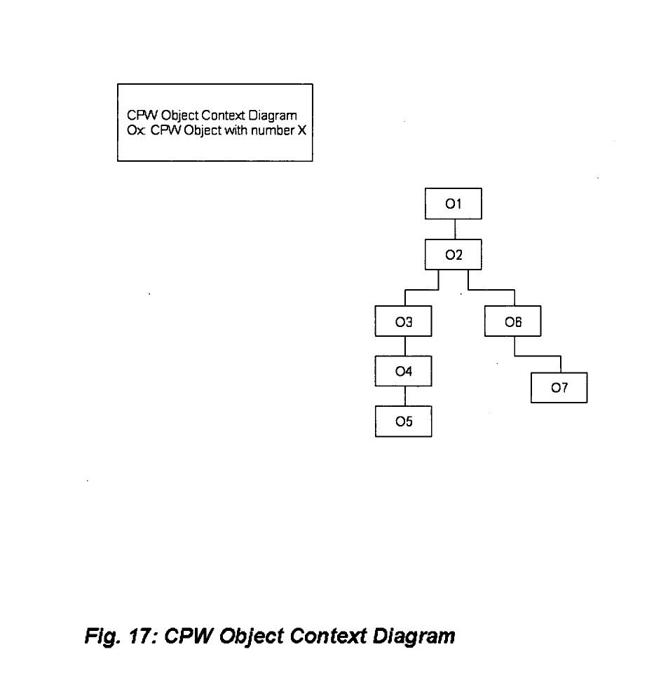

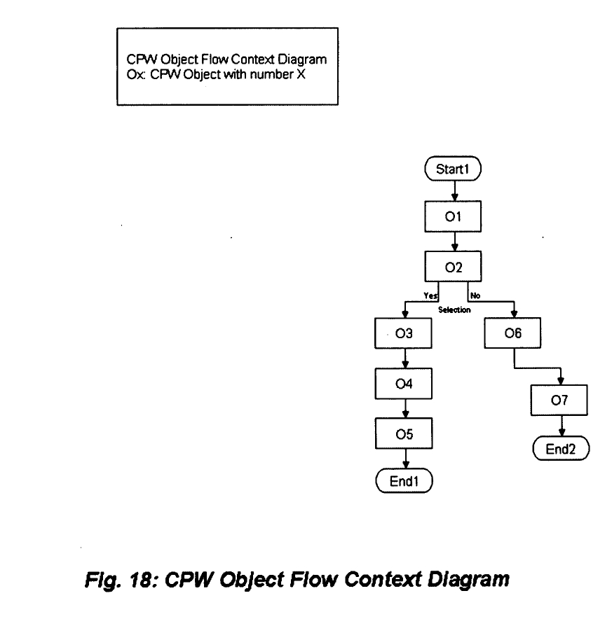

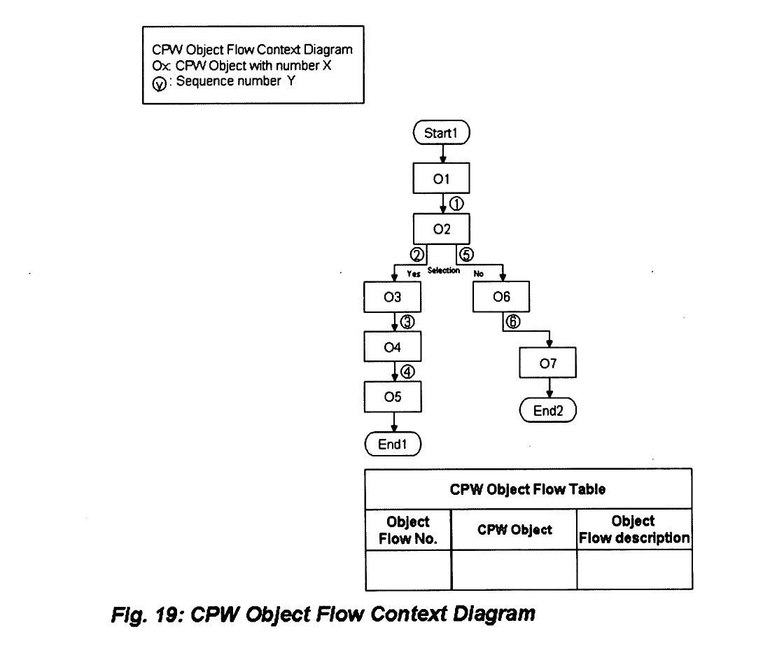

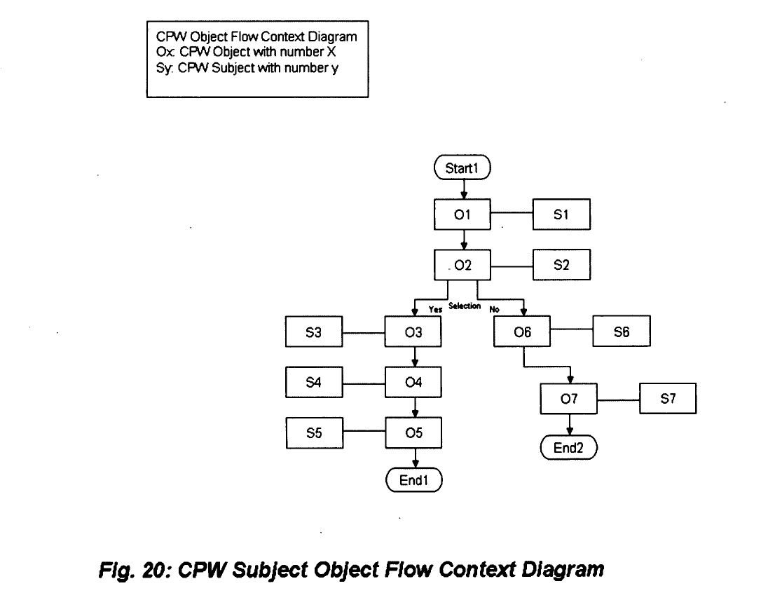

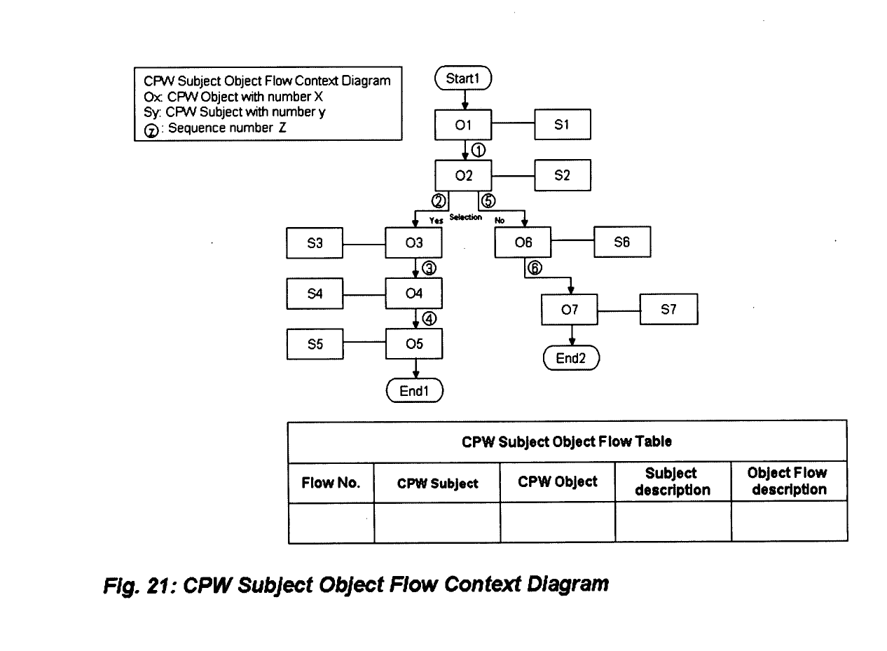

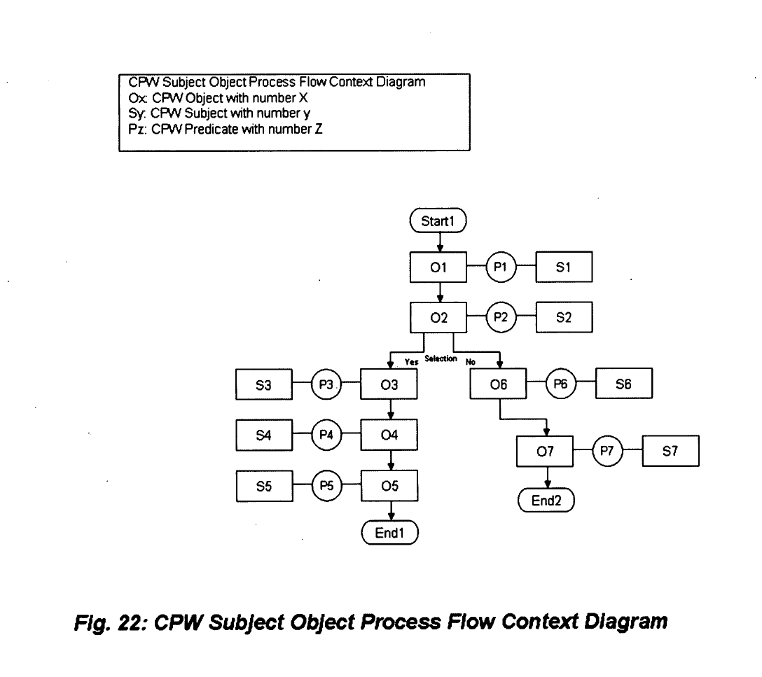

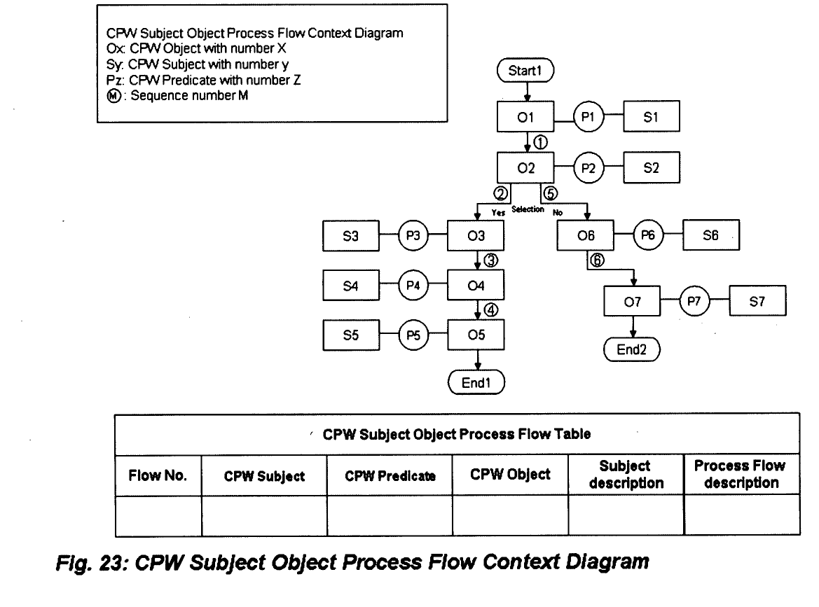

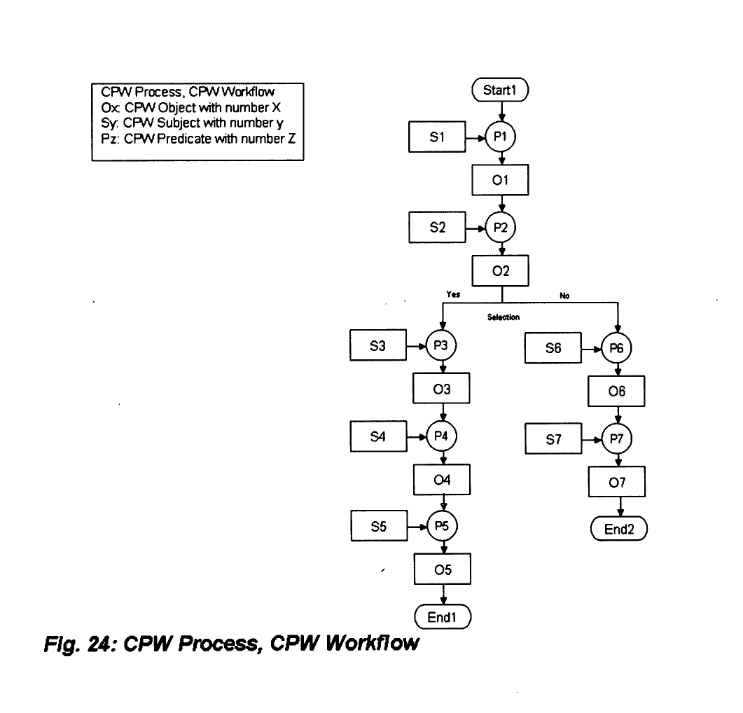

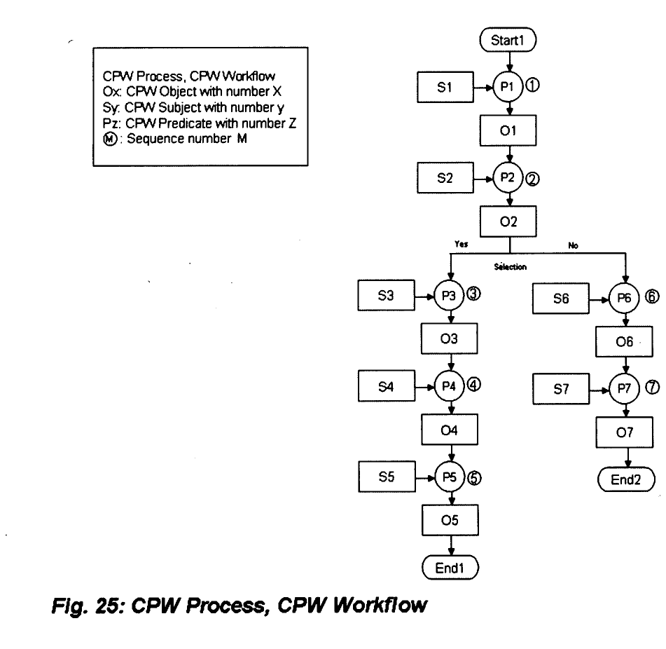

The above named work steps are explained in detail in the following table, to perform the CPW Object Context Diagram Process Transformation. To keep the Method Transformation at first simple, in the following tables have been defined at first preconditions, to limit the Method Transformation to certain cases. Afterwards follows in the following table the single steps, to perform the CPW Object Context Diagram Process Transformation.

| | Preconditions, Rules and single steps of the Variant A Method |
|---|---|
| | Transformation of the CPW Object Context Diagram Process |
| No. | Transformation |
| 1 | Preconditions for the CPW Object Context Diagram Process |
| | Transformation |
| | In the CPW Object Flow Context Diagram is a start point through a |
| | CPW Object and several end points through CPW Objects |
| | All relationships between the CPW Objects in the CPW Objects |
| | Context Diagram can be replaced through a directional arrow for |
| | the creation of the CPW Object Flow Context Diagram |
| | It has not to be created any additional CPW Objects, to be able to |
| | create the wished CPW Object Flow Context Diagram. |
| | FIG. 17 shows the CPW Object Context Diagram. |
| 2 | Definition of the directional arrows of the CPW Object Flow |
| | Context Diagram |
| | Definition of the directional arrows of the relationships between the |
| | CPW Objects for the CPW Object Flow in the CPW Object |
| | Flow Context Diagram. The created directional arrows between |
| | the CPW Objects are the CPW Object Flow Directional |
| | Arrows. |
| | FIG. 18 shows the CPW Object Flow Context Diagram. |
| 3 | Definition of the CPW Objects, which should represent the start |
| | point of the CPW Object Flow and the end point of the |
| | CPW Object Flow in the CPW Object Flow Context |
| | Diagram. |
| | FIG. 18 shows the CPW Object Flow Context Diagram. |
| 4 | All defined directional arrows are assigned to a Sequence, |
| | Selection, logic operation or Iteration. |
| | FIG. 18 shows the Object Flow Context Diagram. |
| 5 | Definition of the Sequence number in the CPW Object Flow |
| | Context Diagram. |
| | FIG. 19 shows the CPW Object Flow Context Diagram with |
| | Sequence numbers. |
| 6 | Creation of the CPW Subject Object Flow Context Diagram |
| | Creation of the CPW Subjects and their assignment to the CPW |
| | Objects in the CPW Subject Object Flow Context Diagram, |
| | so that all CPW Objects are assigned to the CPW Subjects |
| | in a 1:1 Relationship. FIG. 20 shows the CPW Subject |
| | Object Flow Context Diagram. |
| 7 | Definition of the Sequence number in the CPW Subject Object |
| | Flow Context Diagram. |
| | FIG. 21 shows the CPW Subject Object Flow Context Diagram |
| | with sequence numbers. |
| 8 | Creation of the CPW Subject Object Process Flow Context |
| | Diagram Creation of CPW Predicates and their assignment |
| | to the CPW Subject Object Relationships, so that all CPW |
| | Subject Object Relationships has been transformed in |
| | CPW Subject Predicate Object Relationships, so that |
| | every CPW Process Step consists each of a CPW Subject, CPW |
| | Predicate and CPW Object. |
| | FIG. 22 shows the CPW Subject Object Process Flow Context |
| | Diagram. |
| 9 | Definition of the Sequence numbers in the CPW Subject Object |
| | Process Flow Context Diagram. |
| | FIG. 23 shows the CPW Subject Object Process Flow Context |
| | Diagram with Sequence numbers. |
| 10 | Creation of the CPW Process or CPW Workflow |
| | Alignment of the CPW Subject Object Process Flow Context |
| | Diagram to the structure of the CPW Process or CPW |
| | Workflow. |
| | FIG. 24 shows the CPW Process and the CPW Workflow. |
| 11 | Definition of the Sequence number in the CPW Process and CPW |
| | Workflow. |
| | FIG. 25 shows the CPW Process and the CPW Workflow with |
| | Sequence numbers. |

In the following Steps the single Steps from the previous table of the CPW Object Context Diagram Process Transformation are assigned to the figures:

In the Step 1 is provided the CPW Object Context Diagram with the preconditions for the CPW Object Context Diagram Process Transformation.

The FIG. 17 shows in the Step 1 an Object Context Diagram.

The FIG. 18 shows the Steps 2 to 4, where the CPW Object Context Diagram is transformed to a CPW Object Flow Context Diagram.

The FIG. 19 shows with Step 5 the CPW Object Flow Context Diagram with sequence numbers. Furthermore the FIG. 19 shows the CPW Object Flow Table with the essential attributes. The names of the Object Flow Number (Object Flow No.) in the CPW Object Flow Table should be chosen that way, that from the CPW Object Flow Table can be reconstructed the CPW Object Flow Context Diagram.

The FIG. 20 shows with Step 6 the CPW Subject Object Flow Context Diagram.

The FIG. 21 shows the Step 7, where the CPW Subject Object Flow Context Diagram is marked with sequence numbers. The figures also show the CPW Subject Object Flow Table with the essential attributes.

The FIG. 22 shows with Step 8 the CPW Subject Object Process Flow Context Diagram.

The FIG. 23 shows with Step 9 the CPW Subject Object Process Flow Context Diagram with Sequence numbers and the CPW Subject Object Process Flow Table with the essential attributes.

The FIG. 24 shows with Step 10 the CPW Process and CPW Workflow.

The FIG. 25 shows the Step 11, where the CPW Process and CPW Workflow is marked with sequence numbers.

| No. | Key terms and definitions (Schlüsselbegriffe und Definitionen) |
|---|---|
| 1 | CPW Object Context Diagram Process Transformation |
| 2 | CPW Object Context Diagram |
| 3 | CPW Object Flow Context Diagram |
| 4 | CPW Subject Object Flow Context Diagram |
| 5 | CPW Subject Object Process Flow Context Diagram |
| 6 | CPW Process |
| 7 | CPW Workflow |
| 8 | CPW Subject |
| 9 | CPW Predicate |
| 10 | CPW Object |
| 11 | Directional arrows of the CPW Object Flow Context Diagram |
| 12 | Directional arrow |
| 13 | CPW Object Flow Directional Arrows |
| 14 | CPW Object Flow |
| 15 | Start point of the CPW Object Flow |
| 16 | End point of the CPW Object Flow |
| 17 | Sequence, Selection, logic operation or Iteration. |
| 18 | Sequence number |
| 19 | 1:1 Relationship |
| 20 | CPW Subject Object Relationships |
| 21 | CPW Subject Predicate Object Relationships |
| 22 | CPW Process Step |
| 23 | CPW Object Flow Table |
| 24 | CPW Subject Object Flow Table |
| 25 | CPW Subject Object Process Flow Table |

### 20 VARIANT B METHOD TRANSFORMATION OF CPW SUBJECT OBJECT CONTEXT DIAGRAM PROCESS TRANSFORMATION

| | Preconditions, Rules and single steps of the Variant B Method |
|---|---|
| No. | Transformation of the CPW Subject Object Context Diagram Process Transformation |
| 1 | CPW Subject Object Context Diagram |
| | Preconditions |
| | In the initial situation a CPW Subject Object Context Diagram is |
| | present in the hierarchical form. A CPW Subject with its |
| | relationships is assigned to the CPW Objects 1:M. |
| 2 | Creation of the CPW Subject Object 1:1 Relationships |
| | First, it is the objective to break up CPW Subject Object |
| | Relationships of 1:M and to convert or to transform them into |
| | CPW Subject Object 1:1 Relationships. |
| | All CPW Objects are used at the creation of the CPW Object |
| | Context Diagram Process Transformation. No CPW Object should, |
| | can and must be left out. |
| | A CPW Subject can be redundant for the to-be-created CPW Object |
| | Context Diagram Process Transformation and therefore can be left out. |
| | The particular CPW Subjects can be derived from the hierarchical |
| | CPW Subject, but need not be. It also can be created new CPW |
| | Subjects. However at the end of this step all CPW Subjects are to |
| | the particular CPW Objects in a 1:1 Relationship. |
| | Have several CPW Subjects to a CPW Object a M:1 Relationship, |
| | then the several CPW Subjects are combined to a CPW Subject, |
| | so that at the end of this step between CPW Subject and CPW |
| | Object exist a 1:1 Relationship. |
| | The CPW Subject Relationships among each other are broken up |
| | all, so that after this step exclusive exist CPW Subject Object |
| | Relationships in a 1:1 Relationship and no more CPW Subject |
| | Subject Relationships exist. |
| | Has a CPW Subject to several CPW Objects a relationship at the |
| | same time, so the CPW Subject Object 1:M Relationships are |
| | broken up and afterwards the CPW Subject is duplicated according |
| | to the involved CPW Objects and in each case is assigned to the |
| | CPW Objects, so that at the end of this step to each involved CPW |
| | Object exists a CPW Subject with a 1:1 Relationship. |
| 3 | Creation of the CPW Subject Object Flow Diagram |
| | At the next step it is the objective to create or to realize the CPW |
| | Subject Object Flow Diagram. The expert should visualize or to |
| | realize that, what the to-be-created CPW Subject Object Flow |
| | Diagram should represent, content or express. |
| 4 | Rules for the creation of the CPW Subject Object Flow Diagrams |
| | Existing CPW Object Relationships can be used for the to-be- |
| | created Flow, but need not be. They also can be left out. |
| | Depending on from what kind of a Flow should be created. |
| | It also can be created new CPW Object Relationships. |
| | It is the objective as a next step to transform or to create the CPW |
| | Object Relationships into Directional Arrows. The created |
| | Directional Arrows between the CPW Objects are the CPW Object |
| | Flow Directional Arrows. |
| | The given represented sequence through the graphical alignment |
| | or representation of the CPW Objects can be helpful for the to be |
| | realized CPW Subject Object Flow Diagram, however this graphical |
| | represented alignment need not to be kept, to create the Flow, so |
| | that the CPW Objects can be displaced accordingly, to be able to |
| | create afterwards the wished CPW Subject Object Flow Diagram. |
| | Definition of the Directional Arrows of the relationships between the |
| | CPW Objects, the so-called CPW Object Flow Directional Arrows. |
| | If exist CPW Object Relationships, then they can be used for the |
| | to-be-created CPW Subject Object Flow Context Diagram, however |
| | they need not to be used. This means, that existing relationships |
| | also can be left out. It depends, what should describe the to-be- |
| | created Flow. Therefore, if not any relationships exist between |
| | CPW Objects, can also be created any relationships between CPW Objects. |
| | The relationships between the CPW Objects are assigned |
| | according the to-be-created Flow to the Directional Arrows. |
| | Afterwards are assigned all defined Directional Arrows to a |
| | Sequence, Selection, logic operation or Iteration. |
| 5 | CPW Subject Object Process Flow Context Diagram |
| | At this step are created the CPW Predicates and they are assigned to the |
| | CPW Subject Object Relationships, so that all CPW Subject Object |
| | Relationships are transformed in a CPW Subject Predicate Object |
| | Relationship, so that each CPW Process Step consists of each a CPW |
| | Subject, a CPW Predicate and a CPW Object. |
| 6 | CPW Subject Object Process Flow Context Diagram |
| | In this Step are determined the CPW Objects, which build the start point |
| | and the end points of the CPW Subject Object Flows. |
| 7 | CPW Process, CPW Workflow |
| | Alignment of the CPW Subject Object Process Flow Context Diagram after |
| | the structure of the CPW Process or CPW Workflow. In addition the |
| | Directional Arrows are still inserted between CPW Subject and CPW |
| | Predicate and between CPW Predicate and CPW Object. |

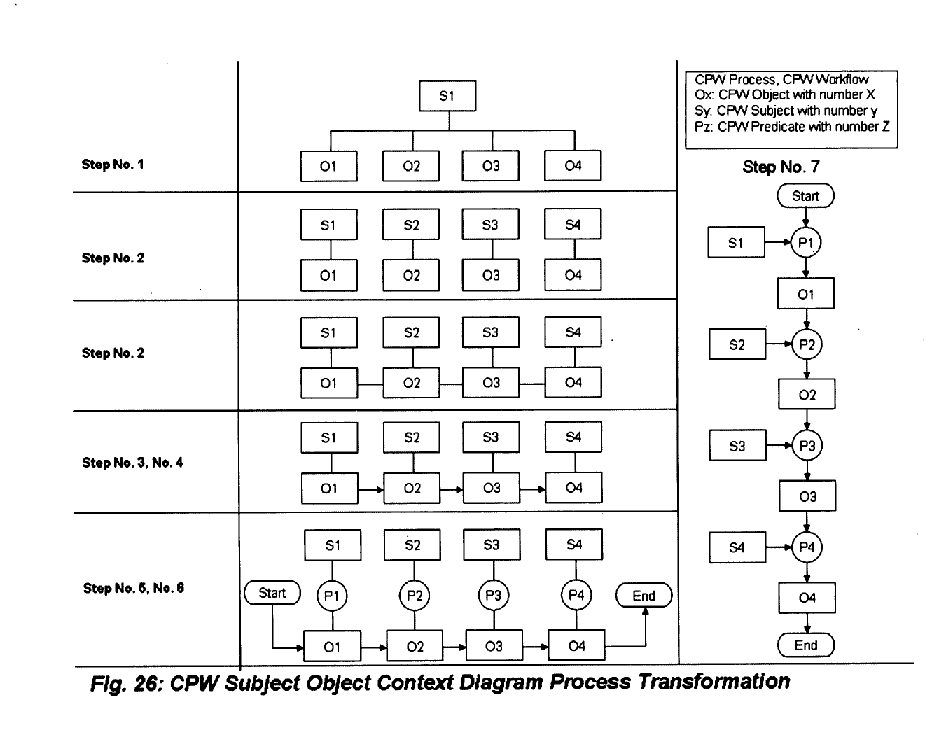

The FIG. 26 shows the Steps 1 to 7 of the previous table, to be able to perform the variant B of CPW Subject Object Context Diagram Process Transformation.

| No. | Key terms and definitions (Schlüsselbegriffe und Definitionen) |
|---|---|
| 1 | CPW Subject Object Context Diagram Process Transformation |
| 2 | CPW Subject Object Context Diagram |
| 3 | CPW Subject |
| 4 | CPW Object |
| 5 | CPW Predicate |
| 6 | CPW Subject Relationships |
| 7 | CPW Object Relationships |
| 8 | CPW Subject Object Relationships |
| 9 | CPW Subject Object 1:1 Relationships |
| 10 | CPW Subject Object Relationships in a 1:1 Relationship |
| 11 | CPW Subject Object 1:M Relationships |
| 12 | CPW Subject Object Relationships of 1:M |
| 13 | CPW Subject Subject Relationships |
| 14 | Directional Arrow |
| 15 | CPW Object Flow Directional Arrows |
| 16 | Directional Arrows between the CPW Object Relationships |
| 17 | Sequence, Selection, logic operation or Iteration. |
| 18 | CPW Subject Object Flow Diagram |
| 19 | Flow |
| 20 | CPW Subject Object Flow |
| 21 | CPW Subject Predicate Object Relationship |
| 22 | CPW Process Step |

### 21 VARIANT C METHOD TRANSFORMATION OF CPW OBJECT CONTEXT DIAGRAM PROCESS TRANSFORMATION

| | Preconditions, Rules and single steps of the Variant C Method |
|---|---|
| | Transformation of the CPW Object Context Diagram Process |
| No. | Transformation |
| 1 | What is the objective and the purpose of the description of the |
| | process? |
| | Description of the final condition of a realized product |
| | Description of the realization of a product |
| | Description of the operational mode of a product |
| | Description of a service |
| | Description of a system |
| | Description of a Business System |
| | Description of occurrences and events |
| 2 | CPW Object Context Diagram |
| | At the Variant C Method Transformation is started in the initial |
| | situation with a CPW Object Context Diagram. |
| 3 | Preconditions |
| | At the beginning it is chosen the CPW Object, from which the |
| | CPW Object Flow should be started. |
| | It is chosen only one CPW Object as a start point, however are |
| | possible in the course of the creation of the CPW Object Flows |
| | several end points. |
| 4 | CPW Subject Object Context Diagram |
| | To the chosen CPW Object is chosen the appropriate CPW |
| | Subject, so that between the CPW Object and CPW Subject exist a |
| | 1:1 relationship. |
| 5 | CPW Subject Object Flow Context Diagram |
| | Definition of the CPW Object for the next CPW Object Flow Step. |
| 6 | CPW Subject Object Flow Context Diagram |
| | Is already existing the found CPW Object in the existing to be |
| | edited CPW Object Context Diagram? Yes |
| | Has been already used before the found CPW Object in a previous |
| | CPW Object Flow Step? |
| | No |
| | Definition of the directional arrow between of the found CPW |
| | Object, which correspond to the next CPW Object Flow Step, and |
| | the current, last edited CPW Object, which correspond to the |
| | current CPW Object Flow Step. |
| | Has the found CPW Object to other CPW Objects also |
| | relationships and these have for the further process of the to-be- |
| | created CPW Object Flows no consideration, or they make no |
| | sense for the to-be-created CPW Object Flow, then they can be left |
| | out. |
| 7 | CPW Subject Object Flow Context Diagram |
| | Is already existing the found CPW Object in the existing to be |
| | edited CPW Object Context Diagram? Yes |
| | Has been already used before the found CPW Object in a previous |
| | CPW Object Flow Step? |
| | Yes |
| | The found CPW Object is duplicated and the directional arrow is |
| | created between the current last edited CPW Object, which |
| | correspond to the current CPW Object Flow Step, and the |
| | duplicated CPW Object, which correspond to the next CPW Object |
| | Flow Step. |
| 8 | CPW Subject Object Flow Context Diagram |
| | Is already existing the found CPW Object in the existing to be |
| | edited CPW Object Context Diagram? No |
| | The found CPW Object is created new and the directional arrow is |
| | created between the current last edited CPW Object, which |
| | correspond to the current CPW Object Flow Step, and the new |
| | created CPW Object, which correspond to the next CPW Object |
| | Flow Step. |
| 9 | Assignment of the directional arrows |
| | All created directional arrows of the CPW Object Relationships are |
| | assigned to a sequence, Selection, logic operation or Iteration. |
| | All created directional arrows are assigned to a sequence number. |
| | The directional arrow, which is assigned to a sequence, is marked |
| | not special. |
| | Is the directional arrow assigned to a selection, logic operation or |
| | an iteration, so the directional arrow is marked according to the |
| | assignment. |
| | The directional arrow can also be named as CPW Object Flow |
| | Directional Arrow |
| 10 | CPW Subject Object Flow Context Diagram |
| | To the chosen CPW Object, which correspond to the next CPW |
| | Object Flow Step, is chosen the appropriate CPW Subject, |
| | so that between the CPW Object and CPW Subject exist |
| | a 1:1 relationship. |
| 11 | CPW Subject Object Flow Context Diagram |
| | Iteration of the steps 5 to 11 |
| | The Steps 5 to 11 are iterated as long as until to the end point or |
| | the end points are achieved of the complete CPW Subject |
| | Object Flow Context Diagram. |
| 12 | CPW Subject Object Process Flow Context Diagram |
| | At this step the CPW Predicates are created and are assigned to the |
| | CPW Subject Object Relationships, so that all CPW Subject Object |
| | Relationships has been transformed to CPW Subject Predicate |
| | Object Relationship, so that each CPW Process Step consists of |
| | each a CPW Subject, a CPW Predicate and a CPW Object. |
| 13 | CPW Process, CPW Workflow |
| | Alignment of the CPW Subject Object Process Flow Context |
| | Diagram according to the structure of the CPW Process or |
| | CPW Workflow |

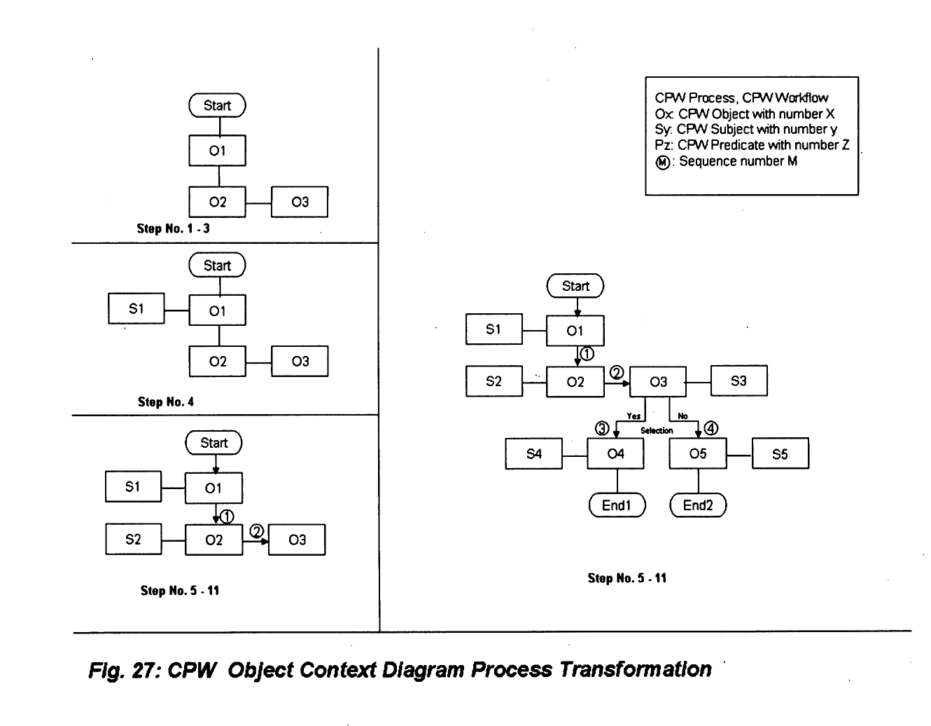

The FIG. 27 shows the Steps 1 to 11 of the above table of the Variant C Method Transformation of the CPW Object Context Diagram Process Transformation by means of a example.

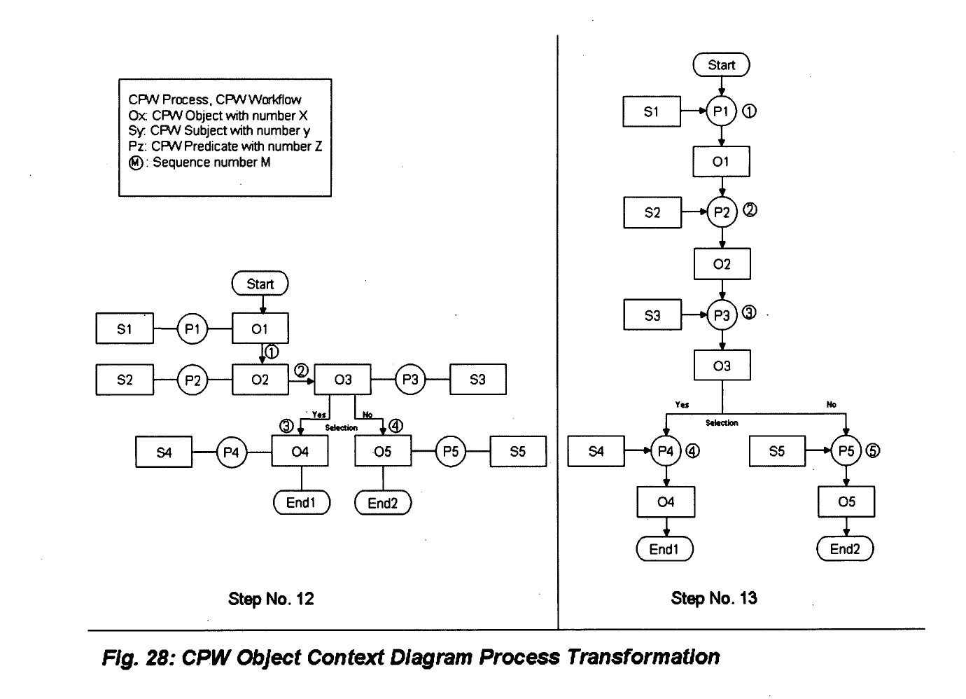

The FIG. 28 shows the Steps 12 to 13 of the above table of the Variant C Method Transformation of the CPW Object Context Diagram Process Transformation by means of a example.

| No. | Key terms and definitions (Schlüsselbegriffe und Definitionen) |
|---|---|
| 1 | CPW Object Context Diagram Process Transformation |
| 2 | CPW Process |
| 3 | CPW Workflow |
| 4 | CPW Subject |
| 5 | CPW Predicate |
| 6 | CPW Object |
| 7 | CPW Object Context Diagram |
| 8 | CPW Subject Object Flow Context Diagram |
| 9 | CPW Object Flow |
| 10 | CPW Object Flow Step |
| 11 | Current CPW Object Flow Step |
| 12 | Next CPW Object Flow Step |
| 13 | Directional Arrow |
| 14 | Directional arrow between the CPW Object Relationships |
| 15 | CPW Object Flow Directional Arrow |
| 16 | Sequence, Selection, logic operation or Iteration. |
| 17 | CPW Subject Object Process Flow Context Diagram |
| 18 | Start point and end points of the CPW Subject Object Process Flow |
| | Context Diagram |
| 19 | CPW Subject Object Relationships |
| 20 | CPW Subject Predicate Object Relationship |
| 21 | CPW Process Step |

### 22 CPW EXPERT CONCEPT

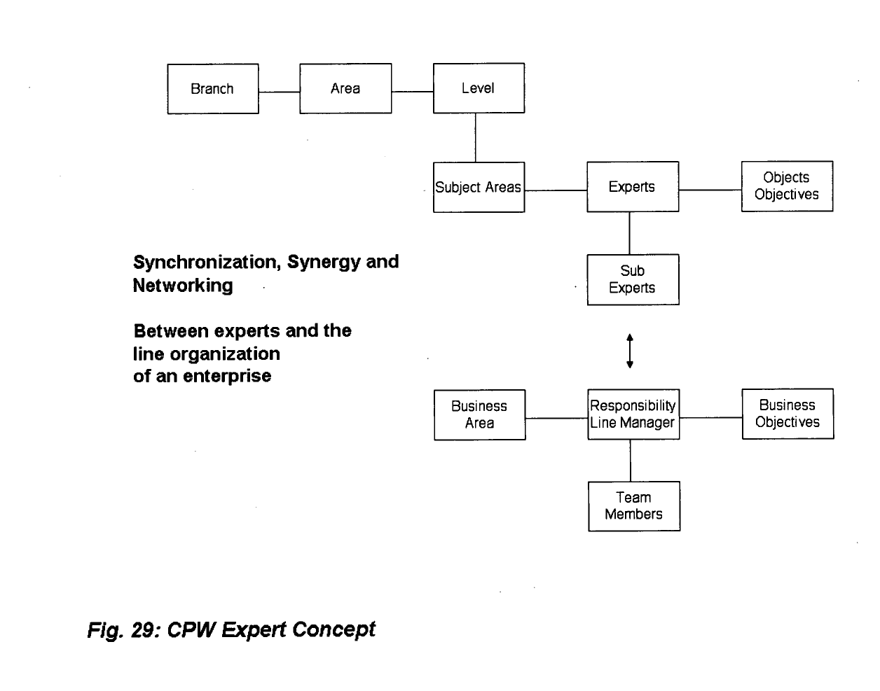

The FIG. 29 shows the basic structure of the CPW Expert Concept, which build the basis for the CPW Diagnostic Assessment.

The FIG. 29 shows on one side the following:
To the branch of business is assigned a area
To the area is assigned a level
To the level is assigned a subject area
The subject area is assigned to experts
To the experts are assigned the business objectives
To the experts are assigned subexperts

The FIG. 29 shows on the other side the following:
The line managers with their responsibility are assigned to a business area
The line managers are assigned the business objectives.
The line managers are assigned the team members.

It is the objective of the CPW Expert Concept at a realized project, to synchronize the experts and subexperts with their competence with the line organization of an enterprise.

So it is the objective within a project, that the objective and tasks of the experts are synchronized with the business objectives of the line mangers.

In the team work between experts, which are taken into the project from outside, the following criteria or principles are crucial:
Synchronization
Synergy
Networking

| No. | Key terms and definitions (Schlüsselbegriffe und Definitionen) |
|---|---|
| 1 | CPW Expert Concepts |
| 2 | CPW Diagnostic Assessment |
| 3 | branch of business |
| 4 | area |
| 5 | Level |
| 6 | Subject area |
| 7 | Business objective |
| 8 | Experts and Subexperts |
| 9 | Line Manager |
| 10 | Responsibility |
| 11 | Business objectives |
| 12 | Business area |
| 13 | Team member |
| 14 | Synchronization |
| 15 | Synergy |
| 16 | Networking |

### 23 CPW DIAGNOSTIC ASSESSMENT

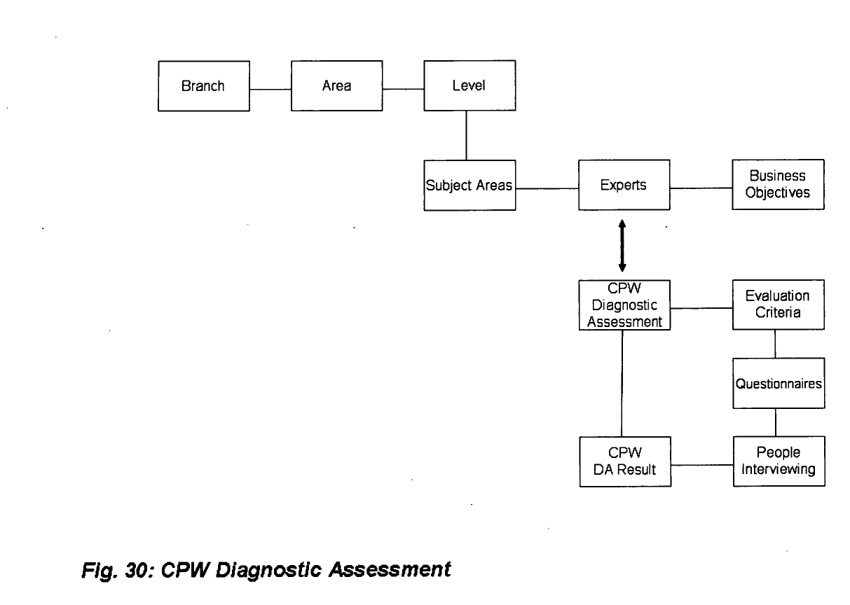

The FIG. 30 shows the basic structure of the CPW Diagnostic Assessment.

The FIG. 30 shows at first the following:
To the branch of business is assigned a area
To the area is assigned a level
To the level is assigned a subject area
The subject area is assigned to experts
To the experts are assigned the business objectives

The FIG. 30 shows the following furthermore:
To the CPW Diagnostic Assessment are assigned the Evaluation Criteria.
To the Evaluation Criteria are assigned the Questionnaires.
To the Questionnaires is assigned the People interviewing.
To the People Interviewing is assigned the CPW Diagnostic Assessment Result (CPW DA Result).
The CPW Diagnostic Assessment Result (CPW DA Result) is the result of the work, which is realized through the experts by means of the CPW Diagnostic Assessment.

In FIG. 30 is drafted in principle the approach of the Experts. The approach for the problem solving cycle is named as CPW Diagnostic Assessment, where the experts diagnose the diagnosis of the problem and if possible to bring a solution. For the problem solving cycle exists different variants to get the CPW Diagnostic Assessment Result (CPW DA Result). In this case the experts investigate the problem with the self established Evaluation Criteria. It is the objective to find the Cognitive Points or Criteria, to identify the problems, to find then the appropriate solutions. From the

Evaluation Criteria are derived the Questionnaires, with those then the people are interviewed, which are involved in the business projects.

Then the results are summarized through the experts and deliver the CPW Diagnostic Assessment Result (CPW DA Result).

| No. | Key terms and definitions (Schlüsselbegriffe und Definitionen) |
|---|---|
| 1 | Experts |
| 2 | CPW Diagnostic Assessment |
| 3 | Evaluation Criteria |
| 4 | Criteria |
| 5 | Cognitive Points |
| 6 | Questionnaires |
| 7 | People interviewing |
| 8 | CPW Diagnostic Assessment Result (CPW DA Result) |

### 24 CPW DA Change Management Transformation

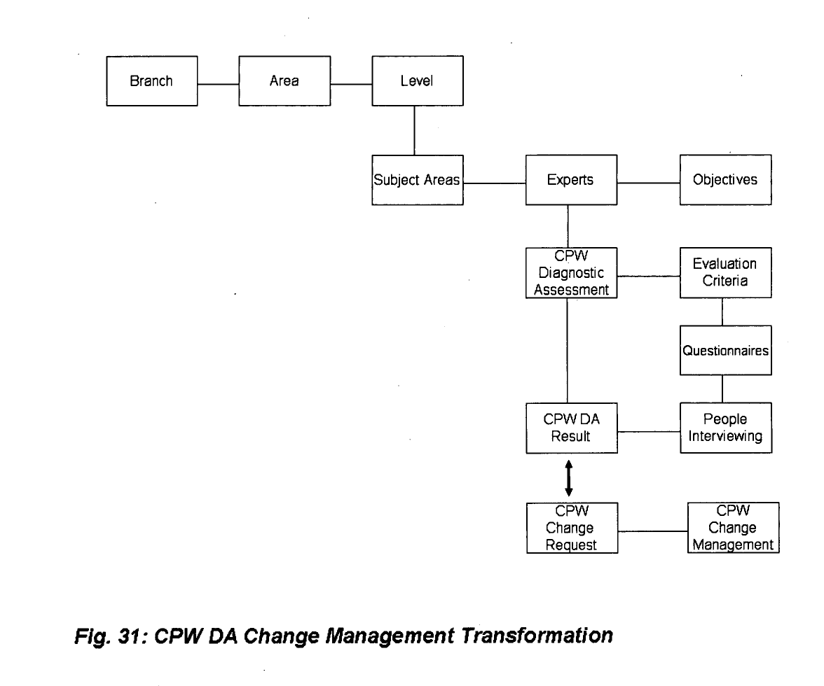

The FIG. 31 shows the relationship between CPW Diagnostic Assessment Result (CPW DA Result) and the CPW Change Management. It is the objective to generate with the CPW DA Result the CPW Change Requests in Strategy, Gaps and Problems, which then are collected in the CPW Change Management. This Process is named as CPW DA Change Management Transformation. The Process or step of the CPW DA Result to the generation and collecting of CPW Change Requests in the CPW Change Management is not a one-off process, but an iterative process or cycle. In the interplay between CPW Diagnostic Assessment and CPW Change Management is deepened the analysis level, to achieve a, as high as possible, and precise level of detail, to identify the problems and to deliver solutions. The cycle can be repeated in periodic intervals, like: daily, weekly, monthly, but also it should be possible to update in a realized application the changes in the CPW Change Management in real-time, so that the involved people in the project are to be up to date at every time about the current situation.

The FIG. 31 shows the CPW DA Change Management Transformation in the overview.

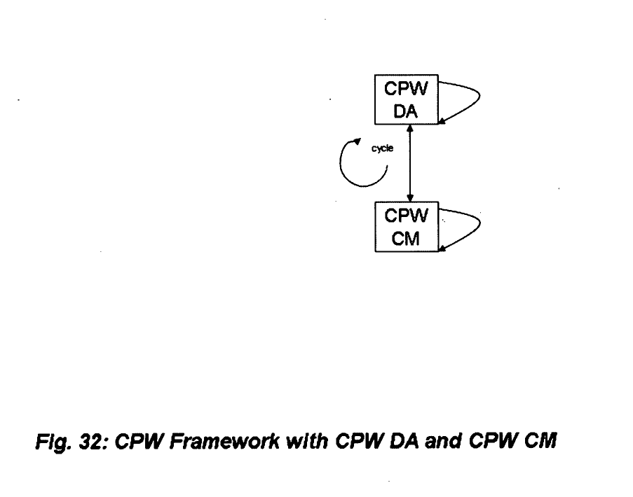

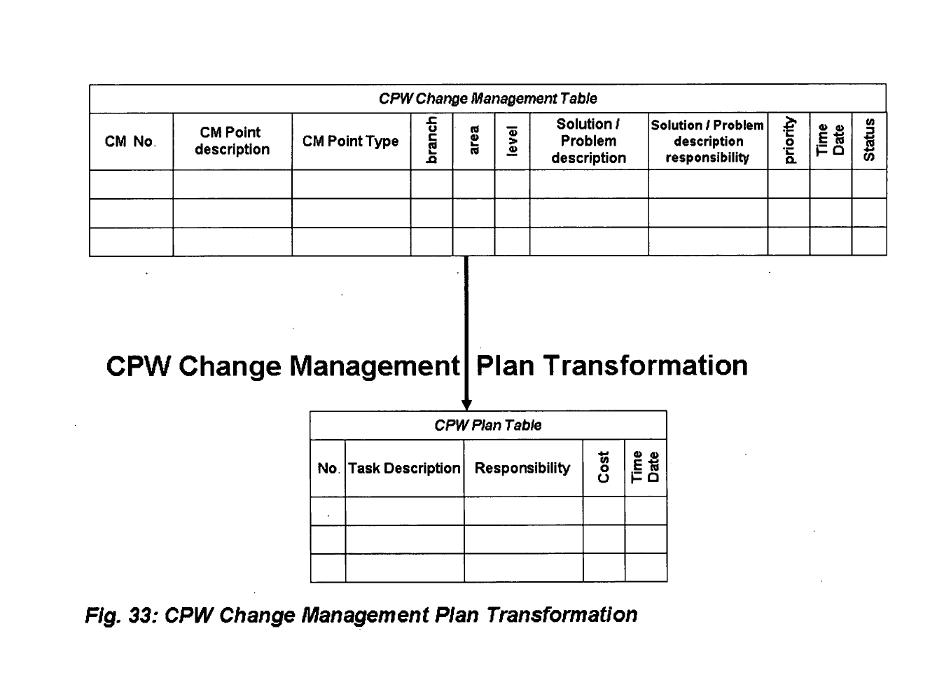

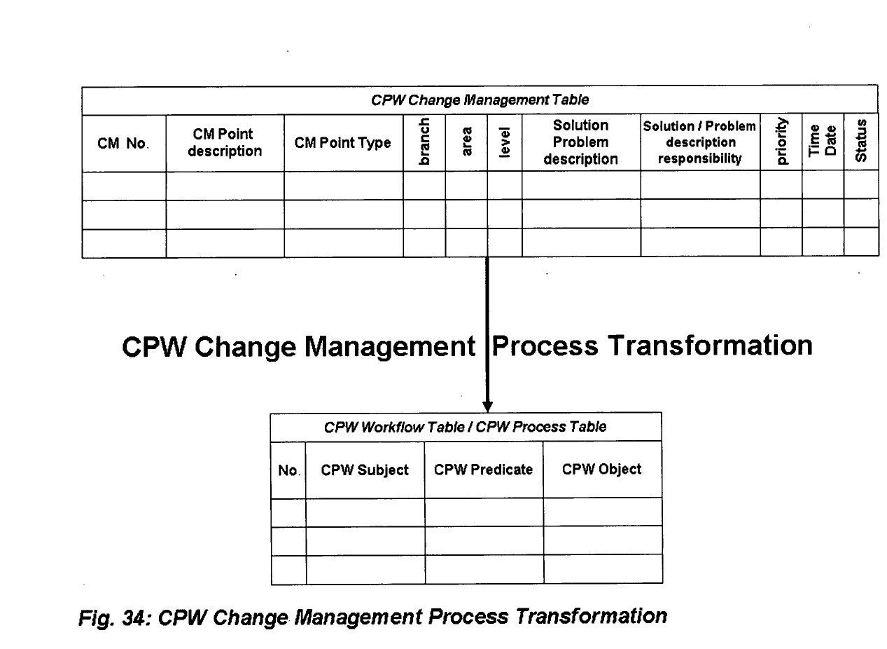

The FIG. 32 shows the CPW Method Components CPW Diagnostic Assessment (CPW DA) and CPW Change Management (CPW CM). The CPW Method Component CPW Diagnostic Assessment and CPW Change Management linked together can be seen as a CPW Framework.

| No. | Key terms and definitions (Schlüsselbegriffe und Definitionen) |
|---|---|
| 1 | CPW Diagnostic Assessment Change Management Transformation |
| | (CPW DA Change Management Transformation) |
| 2 | CPW Change Management |
| 3 | CPW DA Result |
| 4 | CPW Change Request |
| 5 | Strategy, Gaps and Problems |
| 6 | CPW Diagnostic Assessment(CPW DA) |
| 7 | CPW Change Management (CPW CM) |
| 8 | CPW Framework |

### 25 CPW METHOD COMPONENT

Configuration of the Attributes of the Table of a CPW Method Component

At the realization of the table of a CPW Method Component in an application system, it should be possible according to the business requirements to choose and to configure any attributes for the CPW Method Component Table and to model as possible as precise the reality with the existing entities with their attributes.

| No. | Key terms and definitions (Schlüsselbegriffe und Definitionen) |
|---|---|
| 1 | CPW Method Component Table |
| 2 | Entities |
| 3 | Attributes of the CPW Method Component Table |

### 26 CPW METHOD TRANSFORMATION

Configuration of the Attributes, which are Used at the CPW Method Transformation

The attributes of the CPW Method Components Tables, which should be used at the CPW Method Transformation, should be configurable. This means, it can be configured through the system, which attributes for the Method Components Tables at the CPW Method Transformation should be used and how the assignment of the attributes of both tables at the CPW Method Transformation should be.

Direct CPW Method Transformation and Indirect CPW Method Transformation

At CPW Method Transformation is differed between the direct CPW Method Transformation of two CPW Method Components and the indirect CPW Method Transformation of two CPW Method Components.

At the direct CPW Method Transformation of two CPW Method Components are transformed the assigned attributes of the CPW Method Components Tables with their contents 1:1 and they are also then after the CPW Method Transformation in a 1:1 relationship to each other.

At the direct CPW Method Transformation of a CPW Method Component Table to another CPW Method Components Table are determined at first the attributes, which should be transformed. Crucial is, that it exists at every CPW Method Component Table a unique Key, which points to both CPW Method Components Tables, so that it is not at the CPW Method Transformation to ambiguities. With the unique Key the contents of the attributes of the particular Records can be transformed distinct from the one CPW Method Component Table to the other CPW Method Component Table.

At the indirect CPW Method Transformation of two method components are the transformed attributes in a 1:M relationship, in a N:1 relationship, or in a N:M relationship to each other.

Which CPW Method Transformation is preferred, depends on the respective underlying case, and which objective should be followed at the Method Transformation of two CPW Method Components.

Automatic CPW Method Transformation

At the Automatic CPW Method Transformation is transformed in periodic intervals or in real-time from one CPW Method Component Table to another CPW Method Component Table. Which attributes and how should be transformed, can be defined at the appropriate configuration.

Manual CPW Method Transformation

At the manual CPW Method Transformation the contents of the attributes of the relevant CPW Method Components Table are transformed manual through a person with appropriate function by means of the system.

Manual Indirect or Direct CPW Method Transformation

The persons with the appropriate function transform manual by means of system from one CPW Method Component Table to another CPW Method Component Table.

Automatic and Manual Indirect or Direct CPW Method Transformation

After an automatic CPW Method Transformation persons with appropriate function can transform manual by means of system from one CPW Method Component Table to another CPW Method Component Table, to be able to revise the wished objective.

| No. | Key terms and definitions (Schlüsselbegriffe und Definitionen) |
|---|---|
| 1 | CPW Method Transformation |
| 2 | CPW Method Component Table |
| 3 | Attributes of the CPW Method Component Table |
| 4 | Records of the CPW Method Component Table |
| 5 | direct CPW Method Transformation |
| 6 | indirect CPW Method Transformation |
| 7 | Automatic CPW Method Transformation |
| 8 | Manual CPW Method Transformation |
| 9 | Unique Key at the CPW Method Transformation |

### 27 CPW CHANGE MANAGEMENT PLAN TRANSFORMATION

The FIG. 33 shows the basic structure of the CPW Change Management Table with their attributes. The following table shows the basic structure of the attributes of the CPW Change Management Table.

Attributes of the CPW Change Management Table

| No. | Name Attributes | Description of the attributes |
|---|---|---|
| 1 | CM No. | Number of the Change Management No. |
| 2 | CM Point | Description of the Change Management |
| | description | point |
| | (Change | |
| | Management | |
| | Point description) | |
| 3 | CM Point Type | Type of the Change Management point. A |
| | (Change | Change Management point type can be a |
| | Management | strategy point, a gap point or a problem |
| | Point Type | point or a solution point. |
| 4 | Branch | The Change Management point is assigned |
| | | to a branch of business. |
| 5 | Area | The Change Management point is assigned |
| | | to a area. |
| 6 | level | The Change Management point is assigned |
| | | to a Level. |
| 7 | Solution/Problem | Description of the problem or description |
| | Description | of a solution variant. |
| 8 | Solution/Problem | Responsibility for the solution variant or |
| | Description | the appropriate problem. |
| | Responsibility | |
| 9 | Priority | Priority |
| 10 | Status | Status |
| 11 | Time/Date | Time, date or appointment |

The FIG. 33 shows the basic structure of the CPW Plan Table with their attributes. The following table shows the basic structure of the attributes of the CPW Plan Table.

Attributes of the CPW Plan Table

| No. | Name Attributes | Description of the Attributes |
|---|---|---|
| 1 | No. | Number of the task of a plan. |
| 2 | Task Description | Description of the task of a plan. |
| 3 | Responsibility | Responsibility for the respective task or task |
| | | of a plan |
| 4 | Cost | Cost in manpower or expenditure |
| 5 | Time, Date | Time and duration of a to-be-executed task. |
| | | Date and appointment of a to-be-executed task. |

CPW Change Management Plan Transformation

The FIG. 33 shows as overview how the method component CPW Change Management can be transformed in a CPW Plan. It is the so-called CPW Change Management Plan Transformation. There is for the CPW Method Transformation of CPW Change Management to CPW Plan different variants, which are explained as follows:

Variant 1—Automatic and Manual Direct CPW Method Transformation

From the FIG. 33 of the CPW Change Management Table the attributes are transformed automatic and direct in this case to the attributes of the CPW Plan as follows:

Assignment of the attributes of the CPW Change Management
Table to the CPW Plan Table at the CPW Change Management
Plan Transformation

| | Attributes of the CPW Change | |
|---|---|---|
| No. | Management Table | Attributes of the CPW Plan Table |
| 1 | CM No. | No. (Task Number) |
| 2 | CM Point description | Task Description |
| 3 | Solution/Problem description | Task Description |
| 4 | Solution/Problem Description | Responsibility |
| | Responsibility | |
| 5 | Time/Date | Time/Date |
| 6 | Empty | Cost |

The CM No. of the CPW Change Management Table and the No. of the CPW Plan Table are the unique Key for the CPW Change Management Plan Transformation, to ensure the uniqueness of the CPW Method Transformation. CM Point description and Solution/Problem description at the CPW Change Management Table has been taken together to Task Description at the CPW Plan. An additional attribute at the CPW Plan is the attribute cost, which can be reworked after the automatic direct CPW Method Transformation manual through a person with the appropriate function. After the CPW Method Transformation are all contents of the chosen attributes of CPW Change Management Table to CPW Plan in a 1:1 relationship to each other.

Variant 2 Automatic Indirect CPW Method Transformation

At the indirect CPW Method Transformation of CPW Change Management Table to CPW Plan Table at the variant, at which the CPW Change Management Table to the CPW Plan Table is in the relationship of M:1, are summarized several Change Management Request with the CM No to a Task Number of the CPW Plan Table with the corresponding attributes of Task Description, Responsibility, cost, Time Date.

At the indirect CPW Method Transformation of the CPW Change Management Table to the CPW Plan Table in the relationship of 1:M, a Change Request with the CM No is divided to several Task Numbers of the CPW Plan Table with the corresponding attributes of Task Description, Responsibility, cost, Time Date.

The rules, how at this automatic indirect CPW Method Transformation of CPW Change Management Table to CPW Plan Table is transformed, is defined at the configuration of the system.

| No. | Key terms and definitions (Schlüsselbegriffe und Definitionen) |
|---|---|
| 1 | CPW Change Management Table |
| 2 | CPW Plan Table |
| 3 | CPW Change Management Plan Transformation |

### 28 CPW CHANGE MANAGEMENT PROCESS TRANSFORMATION

The FIG. 34 shows the basic structure of the CPW Change Management Table with their attributes.

The FIG. 34 shows the basic structure of the CPW Workflow Table or CPW Process Table with their attributes. The following table shows the basic structure of the attributes of the CPW Workflow Table or of the CPW Process Table.

Attributes of the CPW Process Table

| No. | Name Attribute | Description of the attribute |
|---|---|---|
| 1 | No. | Number of a CPW Process Step |
| 2 | CPW Subject | CPW Subject with their responsibility |
| 3 | CPW Predicate | CPW Predicate |
| 4 | CPW Object | CPW Object |

The FIG. 34 shows the CPW Method Component Table CPW Change Management Table and CPW Workflow Table or CPW Process Table for the CPW Change Management Process Transformation.

Manual and Automatic Direct or Indirect CPW Method Transformation of the CPW Change Management Process Transformation

The attributes of the CPW Change Management Table, which are used for the automatic direct or indirect CPW Method Transformation, and how these then are assigned to the attributes of the CPW Workflow Table and CPW Process Table, can be configured through the system through a person with the appropriate function.

If through the system by means of configured automatic CPW Method Transformation the CPW Change Management Process Transformation can be executed only incomplete or only partly, so then in the second step a person with appropriate function can rework manual in this manner the CPW Change Management Process Transformation, so that it then correspond to the wished result.

| No. | Key terms and definitions (Schlüsselbegriffe und Definitionen) |
|---|---|
| 1 | CPW Change Management Table |
| 2 | CPW Process Table |
| 3 | CPW Workflow Table |
| 4 | CPW Change Management Process Transformation |
| 5 | CPW Method Component Table |

### 29 CPW PROCESS PLAN TRANSFORMATION

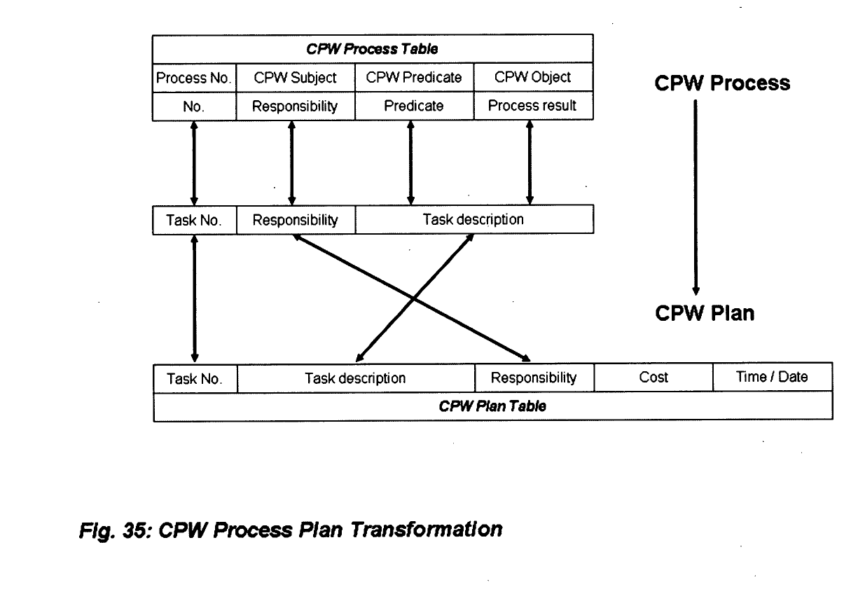

The FIG. 35 shows the basic structure of the CPW Process Table with their attributes. The following table shows the basic structure of the attributes of the CPW Process Table.

Attributes of the CPW Process Table

| No. | Name Attribute | Description of the attribute |
|---|---|---|
| 1 | Process No. | Number of a CPW Process Step |
| 2 | CPW Subject | Description of the CPW Subject. The CPW |
| | | Subject describes the responsibility of the |
| | | CPW Process Step |
| 3 | CPW Predicate | Description of the CPW Predicate |
| 4 | CPW Object | Description of the CPW Object. |

The FIG. 35 shows the basic structure of the CPW Plan Table with their attributes. The following table shows the basic structure of the attributes of the CPW Plan Table.

Attributes of the CPW Plan Table

| No. | Name Attribute | Description of the attribute |
|---|---|---|
| 1 | No. | Number of the Task of a plan. |
| 2 | Task Description | Description of the Task of a plan |
| 3 | Responsibility | Responsibility for the respective Task or |
| | | Task of a plan |
| 4 | Cost | Cost in manpower or expenditure |
| 5 | Time, Date | Time and duration of a to-be-executed task. |
| | | Date and appointment of a to-be-executed task. |

Variant 1—Automatic and Direct CPW Method Transformation

From the FIG. 35 of the CPW Process Table the attributes are transformed automatic and direct to the attributes of the CPW Plan in this case as follows:

Assignment of the attributes of the CPW Process Table to the
CPW Plan Table at the CPW Process Plan Transformation

| | Attributes of the CPW | |
|---|---|---|
| No. | Process Table | Attributes of the CPW Plan Table |
| 1 | Process No. | Task No. (Task Number) |
| 2 | CPW Predicate | Task Description |
| 3 | CPW Object | Task Description |
| 4 | CPW Subject | Responsibility |
| 5 | Empty | Cost |
| 6 | Empty | Time/Date |

The FIG. 35 shows the CPW Process Plan Transformation. In this case it is the matter of a direct CPW Method Transformation, which can be made manual or automatic. The arrows in FIG. 35 show the assignment, which attributes of the CPW Method Components are transformed. How in the FIG. 35 represented, from the CPW Process Table the Process No. is assigned to the Task No. of the CPW Plan. To make clear the CPW Method Transformation, shows the FIG. 35 at the CPW Method Transformation a interstage. In the transformation interstage is shown, how the attributes CPW Predicate and CPW Object of the CPW Process Table are combined or joined to Task description. The attribute CPW Subject of the CPW Process is assigned to the Responsibility. From the transformation interstage to the CPW Plan the attributes Responsibility and Task description are crossed-over, to have the classic attribute sequence in the CPW Plan.

At the CPW Process Plan Transformation in the direct CPW Method Transformation are the attributes of the CPW Method Components in a 1:1 relationship to each other.

Manual Rework of the Attributes Cost and Time/Date of the CPW Plan

The CPW Plan itself is still extended furthermore to two attributes Cost and Time/Date, to have the essential attributes of the CPW Plan. These two attributes can be reworked after the automatic and direct CPW Method Transformation manual through a person with the appropriate function.

| No. | Key terms and definitions (Schlüsselbegriffe und Definitionen) |
|---|---|
| 1 | CPW Plan Table |
| 2 | CPW Process Table |
| 3 | CPW Workflow Table |
| 4 | transformation interstage |
| 5 | CPW Process Plan Transformation |

### 30 CPW PLAN PROCESS TRANSFORMATION

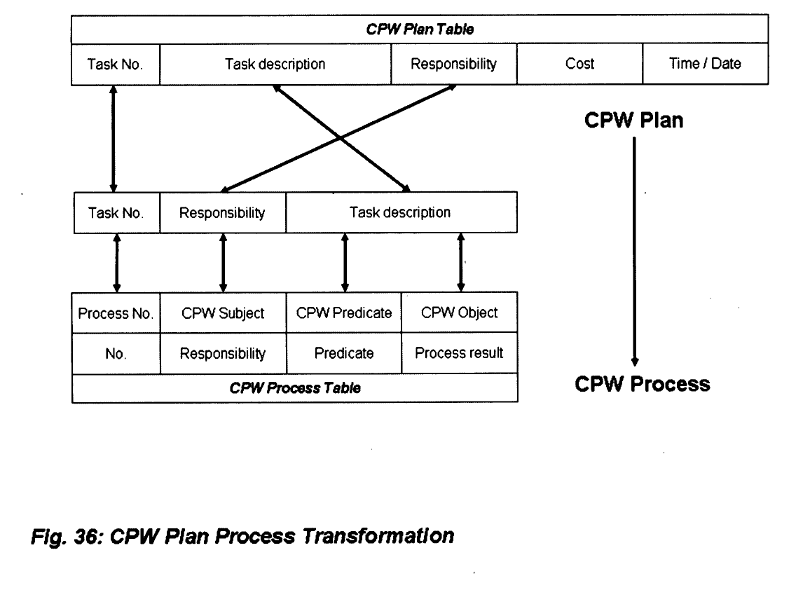

The FIG. 36 shows the CPW Plan Process Transformation. The alignment of the arrows shows the assignment of the attributes of the CPW Plan Table to the CPW Process Table, how should be executed the CPW Method Transformation. As like at the CPW Process Plan Transformation a transformation interstage is also here inserted for illustration. The attributes Cost and Time/Date of the CPW Plan Table are not needed for the CPW Plan Process Transformation.

In the following table is the assignment of the attributes of the CPW Plan Table to the CPW Process Table, to achieve the CPW Plan Process Transformation.

Assignment of the attributes of the CPW Plan Table to the
CPW Process Table at the CPW Plan Process Transformation

| | Attributes of the CPW Plan | |
|---|---|---|
| No. | Table | Attributes of the CPW Process Table |
| 1 | Task No. (Task Number) | Process No. |
| 2 | Task Description | CPW Predicate |
| 3 | Task Description | CPW Object |
| 4 | Responsibility | CPW Subject |
| 5 | Cost | Empty |
| 6 | Time/Date | Empty |

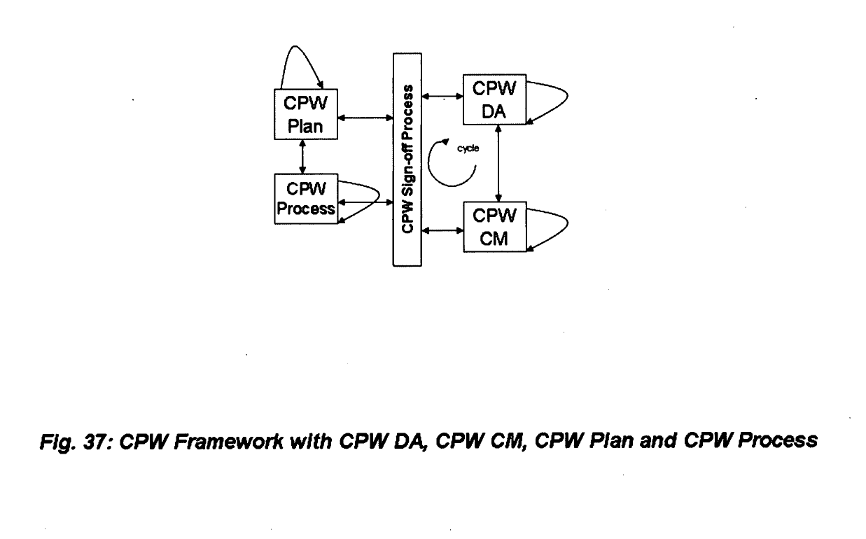

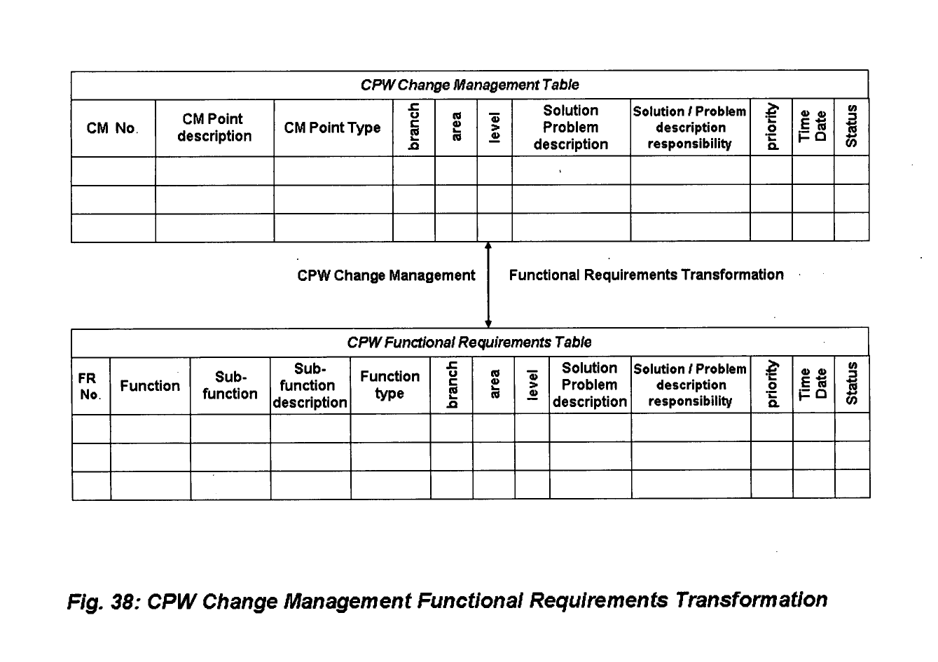

The FIG. 37 shows a CPW Framework with the CPW Method Components CPW DA, CPW CM, CPW Plan, CPW Process and CPW Sign-off Process.

| No. | Key terms and definitions (Schlüsselbegriffe und Definitionen) |
|---|---|
| 1 | CPW Plan Table |
| 2 | CPW Process Table |
| 3 | CPW Workflow Table |
| 4 | CPW Plan Process Transformation |
| 5 | CPW Framework |
| 6 | CPW Sign-off Process. |
| 7 | CPW DA, CPW CM, CPW Plan, CPW Process |

### 31 CPW CHANGE MANAGEMENT FR TRANSFORMATION

In FIG. 38 is represented the CPW Change Management Functional Requirements Transformation (CPW Change Management FR Transformation).

The FIG. 38 shows the basic structure of the CPW Change Management Table with their attributes. The following table shows the basic structure of the attributes of the CPW Change. Management Table.

Attributes of the CPW Change Management Table

| No. | Name Attribute | Description of the attribute |
|---|---|---|
| 1 | CM No. | Number of the Change Management No. |
| 2 | CM Point | Description of the Change Management |
| | description | Point |
| | (Change | |
| | Management Point | |
| | description) | |
| 3 | CM Point Type | Type of the Change Management Point. |
| | (Change | A Change Management Point Type can be a |
| | Management Point | Strategy Point, a Gap Point or a Problem |
| | Type) | Point or a Solution Point. |
| 4 | Branch | The Change Management Point is assigned |
| | | to a branch of business. |
| 5 | Area | The Change Management Point is assigned |
| | | to a area. |
| 6 | level | The Change Management Point is assigned |
| | | to a Level. |
| 7 | Solution/Problem | Description of the problems or |
| | Description | description of the solution variant. |
| 8 | Solution/Problem | Responsibility for the solution variant or the |
| | Description | corresponding problem. |
| | Responsibility | |
| 9 | Priority | Priority |
| 10 | Status | Status |
| 11 | Time/Date | Time, Date or appointment |

The FIG. 38 shows the basic structure of the CPW Functional Requirements Table with their attributes. The following table shows the basic structure of the attributes of the CPW Functional Requirements Table.

Attributes of the CPW Functional Requirements Table

| No. | Name Attribute | Description of the attribute |
|---|---|---|
| 1 | FR No. | Number of the Functional Requirements No. |
| 2 | Function | Description of the function |
| 3 | Subfunction | Description of the subfunction |
| | description | |
| 4 | Function Type | Description of the Function Type |
| 5 | Branch | The Functional Requirement is assigned to a |
| | | branch of business. |
| 6 | Area | The Functional Requirement is assigned |
| | | to a area. |
| 7 | Level | The Functional Requirement is assigned |
| | | to a Level. |
| 8 | Solution/Problem | Description of the problem or description |
| | Description | of the solution variant. |
| 9 | Solution/Problem | Responsibility for the solution variant or the |
| | Description | corresponding problem. |
| | Responsibility | |
| 10 | Priority | Priority |
| 11 | Status | Status |
| 12 | Time/Date | Time, Date or appointment |

The CPW Change Management Functional Requirements Transformation can be taken in both directions, depending how the project situation is. Either it is transformed at the CPW Change Management Functional Requirements Transformation from the CPW Change Management Table in the direction of Functional Requirements Table or it is transformed from the CPW Functional Requirements Table in direction of CPW Change Management Table.

The basic structure of the attributes of the CPW Change Management Table and of the Functional Requirements Table can be given as default through the system, however a person with the appropriate function can also change by means of system the attributes of the CPW Change Management Table and of the CPW Functional Requirements Table, or to delete attributes, or to add or to create new attributes of the CPW Method Components Tables.

The CPW Change Management Functional Requirements Transformation can be a manual, automatic, direct or indirect CPW Method Transformation.

| No. | Key terms and definitions (Schlüsselbegriffe und Definitionen) |
|---|---|
| 1 | CPW Change Management Table |
| 2 | The CPW Functional Requirements Table |
| 3 | CPW Change Management Functional Requirements |
| | Transformation (CPW Change Management FR Transformation) |

### 32 CPW FUNCTIONAL REQUIREMENTS FUNCTIONAL DIAGRAM TRANSFORMATION

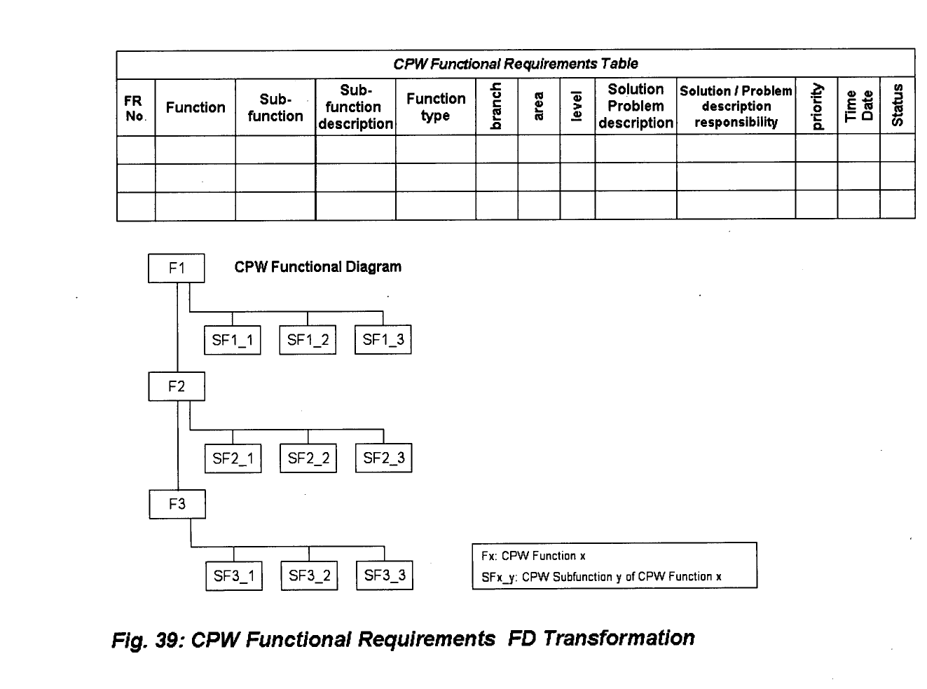

The FIG. 39 shows the CPW Method Component CPW Functional Requirements Table and the CPW Method Component CPW Functional Diagram with the objective to perform the CPW Functional Requirements Functional Diagram Transformation (CPW FR FD Transformation).

In this case the CPW Functional Requirements Functional Diagram Transformation is a direct CPW Method Transformation with a 1:1 relationship. From the CPW Functional Requirements are used the attributes Function and Subfunction, to transform the CPW Functional Diagram. From the CPW Functional Requirements Table are extracted the attributes. Function and Subfunction and are assigned to the represented graphical structure of the CPW Functional Diagram.

Is the CPW Functional Requirements Functional Diagram Transformation performed into the other direction of CPW Functional Diagram to CPW Functional Requirements, so the CPW Functions and CPW Subfunctions of the CPW Functional Diagram are assigned to the attributes Functions and Subfunctions of the CPW Functional Requirements Table. Also here the CPW Functional Requirements Functional Diagram Transformation is a direct CPW Method Transformation with a 1:1 relationship.

| No. | Key terms and definitions (Schlüsselbegriffe und Definitionen) |
|---|---|
| 1 | CPW Functional Requirements Table |
| 2 | CPW Functional Diagram |
| 3 | CPW Functions |
| 4 | CPW Subfunctions |
| 5 | CPW Functional Requirements Functional Diagram Transformation |

### 33 CPW FUNCTIONAL REQUIREMENTS CONTEXT DIAGRAM TRANSFORMATION

In the previous chapter has been described and represented the CPW Functional Requirements Functional Diagram Transformation with the FIG. 39. In this chapter it is the objective to transform from the CPW Functional Requirements Table a CPW Context Diagram, the so-called CPW Functional Requirements Context Diagram Transformation. Thereby can be taken at first the work steps of the CPW Functional Requirements Functional Diagram Transformation, where has been transformed from the CPW Functional Requirements Table the CPW Functional Diagram.

The transformed CPW Functional Diagram may be considered then as CPW Object Context Diagram, where the CPW Functions and CPW Subfunctions of the CPW Functional Diagrams can be assigned to the CPW Objects of the CPW Object Diagram, so that then the CPW Object Diagram from the CPW Functional Diagram has been transformed. This work step can be also named as CPW Functional Diagram Context Diagram Transformation or also as CPW Functional Diagram Object Context Diagram Transformation.

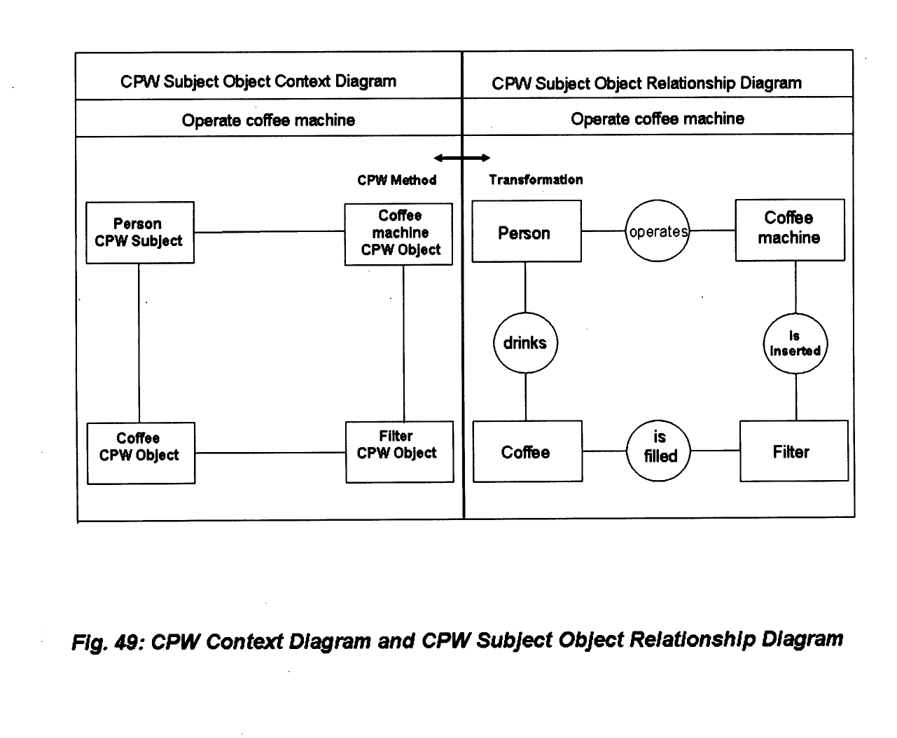

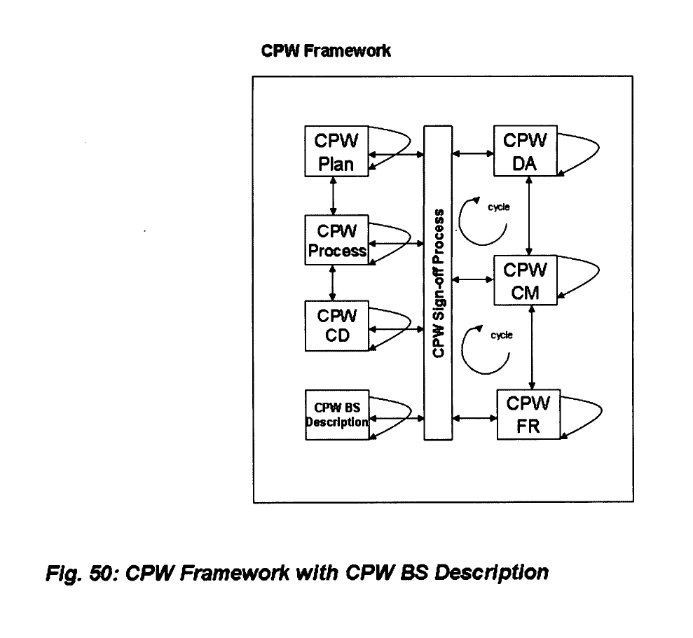

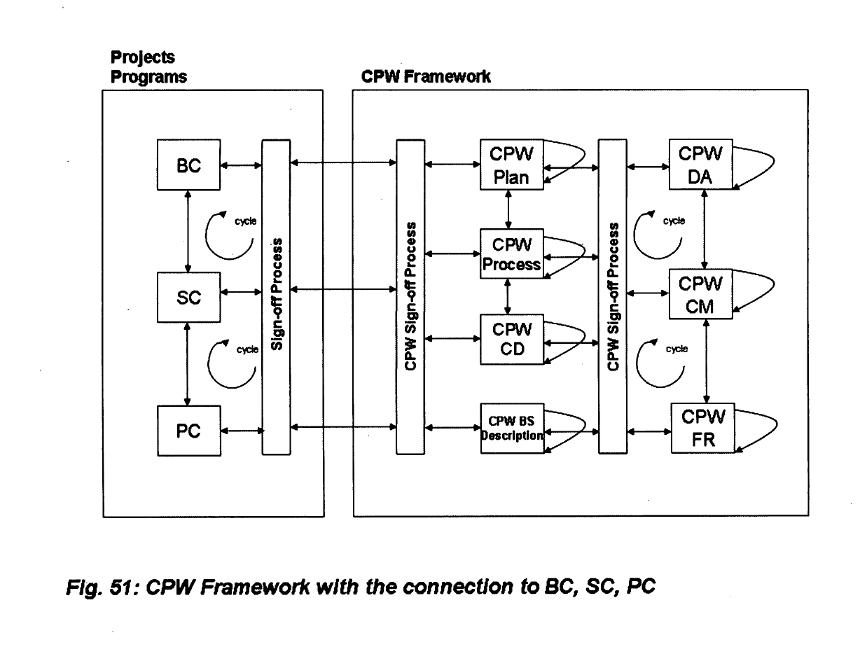

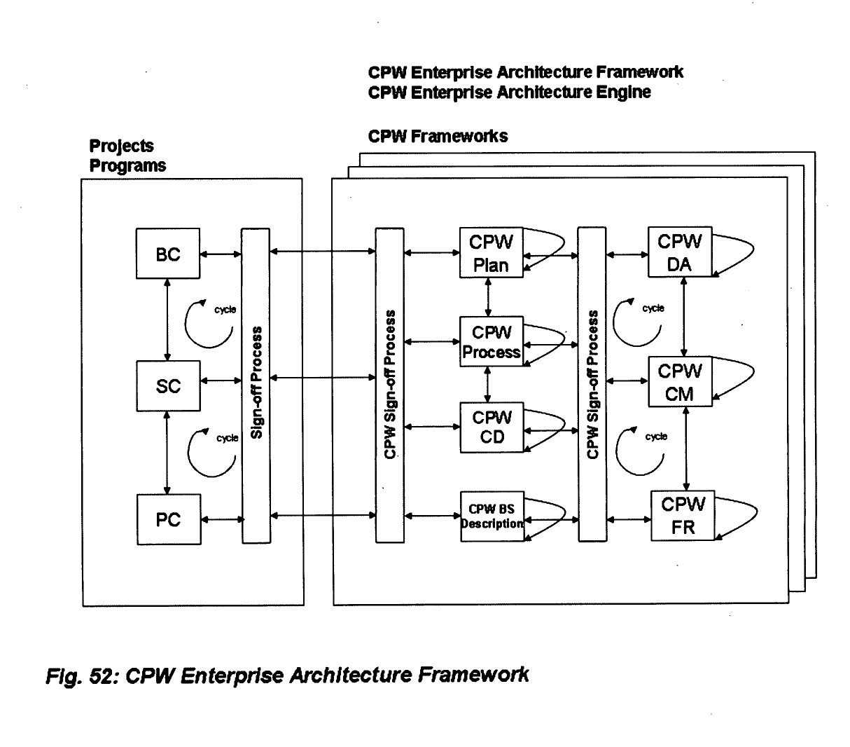

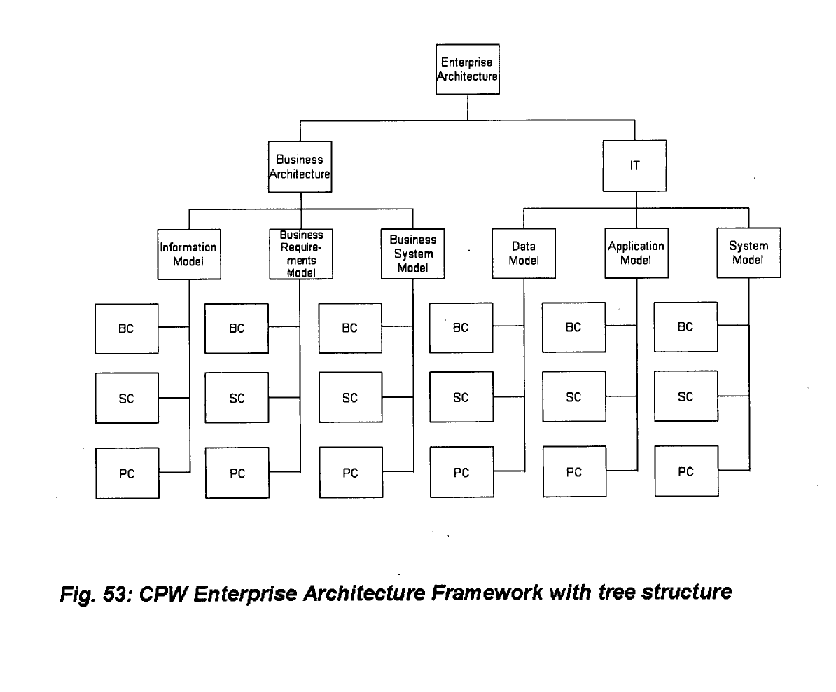

The FIG. 49 shows the CPW Functional Requirements Table, the transformed CPW Functional Diagram and the transformed CPW Object Diagram.

Altogether then the CPW Functional Requirements Context Diagram Transformation has been performed.

In this case the CPW Functional Requirements Context Diagram Transformation is a direct CPW Method Transformation with a 1:1 relationship.

| No. | Key terms and definitions (Schlüsselbegriffe und Definitionen) |
|---|---|
| 1 | CPW Functional Requirements Table |
| 2 | CPW Context Diagram |
| 3 | CPW Functional Requirements Functional Diagram Transformation |
| 4 | CPW Functional Diagram |
| 5 | CPW Functions |
| 6 | CPW Subfunctions |
| 7 | CPW Object Context Diagram |
| 8 | CPW Objects |
| 9 | CPW Functional Diagram Context Diagram Transformation |
| 10 | CPW Functional Diagram Object Context Diagram Transformation |
| 11 | CPW Functional Requirements Context Diagram Transformation |

### 34 CPW FUNCTIONAL DIAGRAM SUBJECT OBJECT CONTEXT DIAGRAM TRANSFORMATION

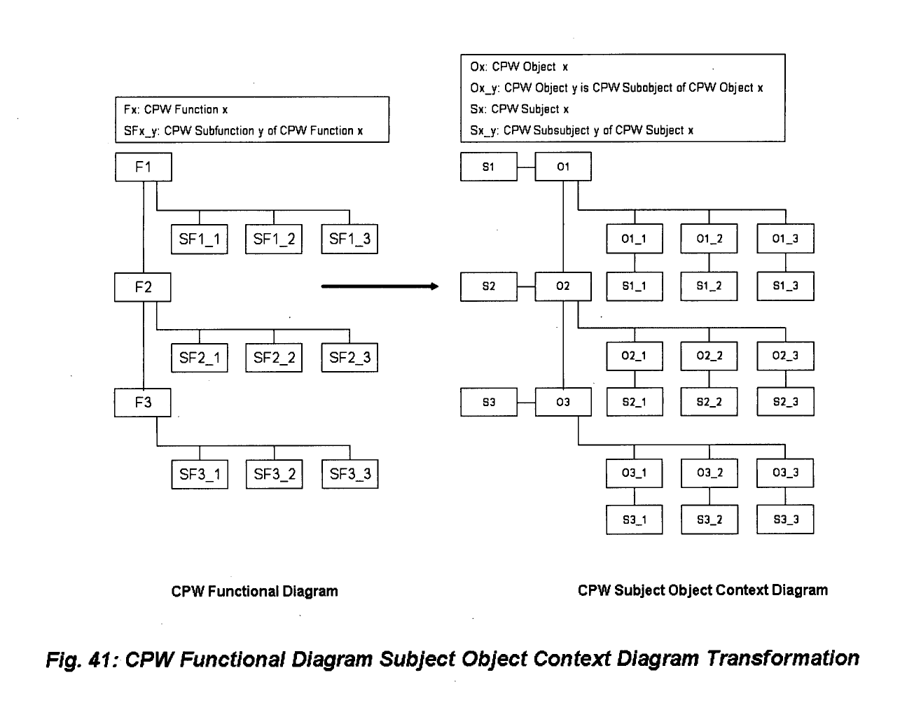

The FIG. 41 shows the CPW Functional Diagram and the transformed CPW Subject

Object Context Diagram. The following table shows the essential work steps, to perform the CPW Functional Diagram Subject Object Context Diagram Transformation:

| | Preconditions, rules and work steps of the transformation of CPW |
|---|---|
| No. | Functional Diagram Subject Object Context Diagram Transformation |
| 1 | Preconditions for the CPW Functional Diagram Subject Object |
| | Context Diagram Transformation |
| | At the CPW Functional Diagram Subject Object Context Diagram |
| | Transformation is transformed from the CPW Functional Diagram a |
| | CPW Subject Object Diagram. |
| 2 | The represented CPW Functional Diagram in FIG. 41 can be regarded at |
| | first as CPW Object Context Diagram, where the CPW Functions and the |
| | CPW Subfunctions of the CPW Functional Diagrams are assigned to the CPW |
| | Objects of the CPW Object Diagrams. |
| 3 | In the next work step is assigned to each CPW Object of the CPW Object |
| | Diagram a CPW Subject, so that between all CPW Subject Object |
| | Relationships is made a 1:1 relationship. |
| 4 | The FIG. 41 shows the CPW Subject Object Context Diagram, which has been |
| | transformed from the CPW Functional Diagram. |
| 5 | In this case the CPW Functional Diagram Subject Object Context Diagram |
| | Transformation is a direct CPW Method Transformation with a 1:1 |
| | Relationship. |

| No. | Key terms and definitions (Schlüsselbegriffe und Definitionen) |
|---|---|
| 1 | CPW Functional Diagram |
| 2 | CPW Subject Object Context Diagram |
| 3 | CPW Functional Diagram Subject Object Context Diagram |
| | Transformation |

### 35 CPW FUNCTIONAL DIAGRAM OBJECT FLOW CONTEXT DIAGRAM TRANSFORMATION

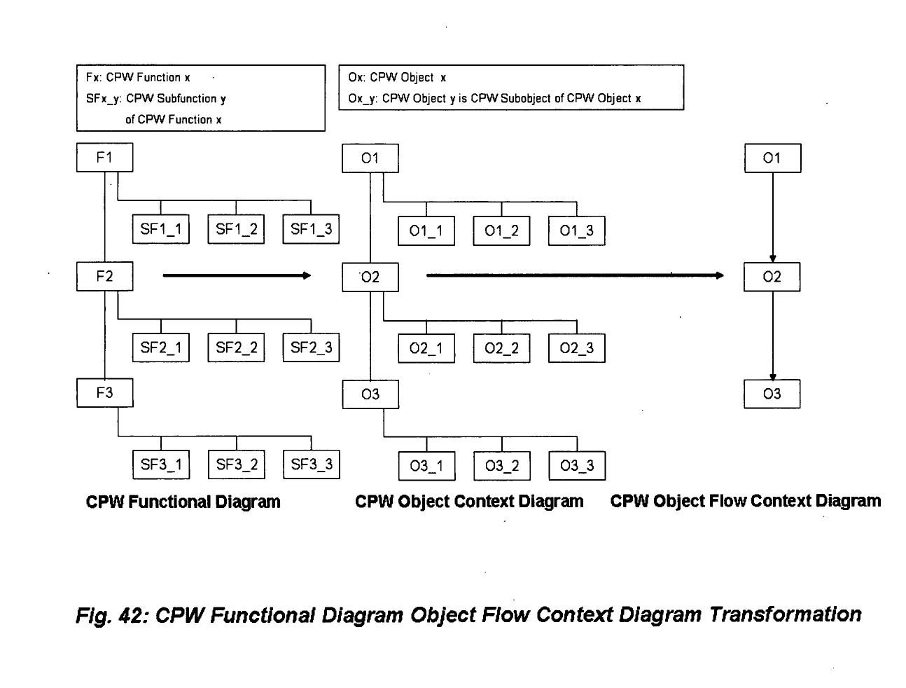

The FIG. 42 shows the CPW Functional Diagram, the CPW Object Context Diagram and the transformed CPW Object Flow Context Diagram.

The following table shows the work steps, to transform from the CPW Functional Diagram a CPW Object Flow Context Diagram:

| | Preconditions, rules and work steps of the Method Transformation of |
|---|---|
| No. | CPW Functional Diagram Object Flow Context Diagram Transformation |
| 1 | Precondition for the CPW Functional Diagram Object Flow Context |
| | Diagram Transformation |
| | At the Functional Diagram Object Flow Context Diagram |
| | Transformation is transformed from the CPW Functional Diagram a |
| | CPW Object Flow Diagram. |
| 2 | The represented CPW Functional Diagram in FIG. 42 can be regarded at |
| | first as CPW Object Context Diagram, where the CPW Functions and the |
| | CPW Subfunctions of the CPW Functional Diagrams are assigned to the CPW |
| | Objects of the CPW Object Context Diagram. |
| 3 | In this work step the whole CPW Subobjects in the CPW Object Context |
| | Diagram are just left out, so that only still remain the essential CPW |
| | Objects in the CPW Object Context Diagram. |
| 4 | As the next work step the relationships between the CPW Objects in the |
| | CPW Object Context Diagram are assigned to a directional arrow, there |
| | are the CPW Object Flow Directional Arrows. |
| 5 | All defined directional arrows are assigned to a Sequence, Selection, logic |
| | operation or Iteration. |
| 6 | In FIG. 42 is represented the transformed CPW Object Flow Context |
| | Diagram, so that overall the CPW Functional Diagram Object Flow |
| | Diagram Transformation is performed. |

| No. | Key terms and definitions (Schlüsselbegriffe und Definitionen) |
|---|---|
| 1 | CPW Functional Diagram |
| 2 | CPW Functions |
| 3 | CPW Subfunctions |
| 4 | CPW Object Context Diagram |
| 5 | CPW Object Flow Context Diagram |
| 6 | CPW Object Flow Directional Arrows |
| 7 | CPW Objects |
| 8 | CPW Subobjects |
| 9 | CPW Functional Diagram Object Flow Context Diagram |
| | Transformation |

### 36 CPW FUNCTIONAL REQUIREMENTS PROCESS TRANSFORMATION

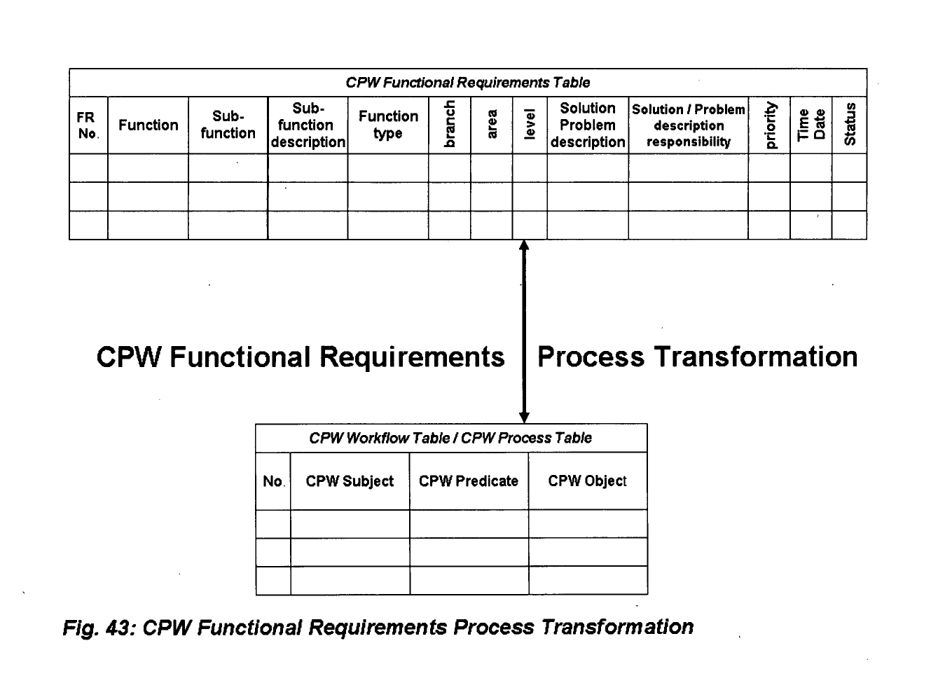

The FIG. 43 shows the CPW Functional Requirements Table and the transformed CPW Process Table.

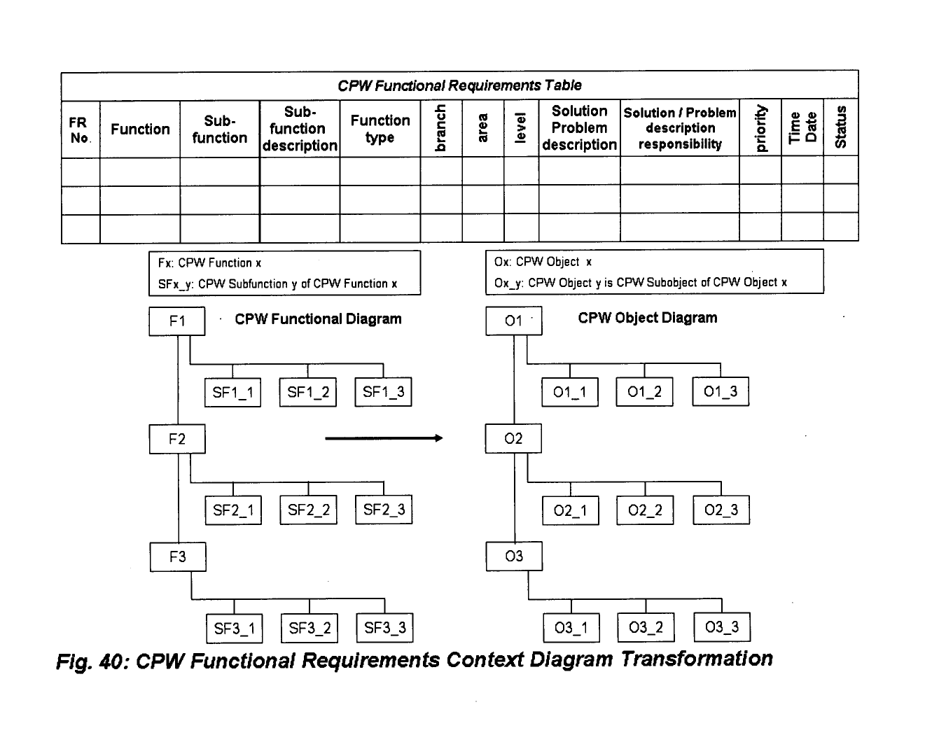

The following table shows the work steps, to transform from the CPW Functional Requirements Table a CPW Process Table:

| | Preconditions, rules and work steps of the Transformation of CPW |
|---|---|
| No. | Functional Requirements Process Transformation |
| 1 | Preconditions for the CPW Functional Requirements Process |
| | Transformation |
| | At the CPW Functional Requirements Process Transformation is |
| | transformed from the CPW Functional Requirements Table a CPW |
| | Process Table. |
| 2 | The FIG. 43 shows the CPW Functional Requirements Table and the |
| | transformed CPW Process Table. The work steps, to perform the CPW |
| | Functional Requirements Process Transformation, can be explained and |
| | performed by means of the previous described chapters with the CPW |
| | Method Transformations. |
| 3 | In the chapter with the CPW Functional Requirements Functional Diagram |
| | Transformation the work step is described with FIG. 39, where from the CPW |
| | Functional Requirements Table a CPW Functional Diagram is transformed. |
| 4 | It is the objective in the next work step to transform from the CPW |
| | Functional Diagram a CPW Object Context Diagram. |
| 5 | In the chapter with the CPW Functional Requirements Context Diagram |
| | Transformation is described among others with the FIG. 40, how from a |
| | CPW Functional Diagram a CPW Object Context Diagram is transformed, |
| | the so-called CPW Functional Diagram Object Context Diagram |
| | Transformation or the CPW Functional Diagram Context Diagram |
| | Transformation. |
| 6 | It is the objective in the next work step to transform from a CPW Object |
| | Context Diagram the CPW Process. |
| 7 | In the chapter with the CPW Object Context Diagram Process |
| | Transformation is described, where from a CPW Object Context Diagram |
| | the CPW Process is transformed. |
| | The FIG. 17 shows as initial situation the CPW Object Context Diagram. |
| | The FIG. 18 shows as further work step the CPW Object Flow Context |
| | Diagram. |
| | The FIG. 20 shows as further work step the CPW Subject Object Flow |
| | Context Diagram. |
| | The FIG. 22 shows as further work step the CPW Subject Object Process |
| | Flow Context Diagram. |
| | The FIG. 23 shows for one thing the CPW Subject Object Process Flow |
| | Context Diagram and for another thing the CPW Subject Object Process |
| | Flow Table. The CPW Subject Object Process Flow Table can also be |
| | regarded as CPW Process Table or CPW Workflow Table. |
| | In FIG. 24 is represented the transformed CPW Process and CPW |
| | Workflow. |
| 8 | The CPW Process Table, which is transformed from the CPW Subject |
| | Object Process Flow Table, is represented in FIG. 43, so that overall with |
| | the described work steps the CPW Functional Requirements Process |
| | Transformation could be performed. |

| No. | Key terms and definitions (Schlüsselbegriffe und Definitionen) |
|---|---|
| 1 | CPW Functional Requirements Table |
| 2 | CPW Process, CPW Process Table |
| 3 | CPW Functional Requirements Process Transformation |
| 4 | CPW Functional Requirements Functional Diagram Transformation |
| 5 | CPW Functional Requirements Context Diagram Transformation |
| 6 | CPW Functional Diagram Context Diagram Transformation |
| 7 | CPW Functional Diagram Object Context Diagram Transformation |
| 8 | CPW Object Context Diagram Process Transformation |
| 9 | CPW Object Context Diagram |
| 10 | CPW Object Flow Context Diagram |
| 11 | CPW Subject Object Flow Context Diagram |
| 12 | CPW Subject Object Process Flow Context Diagram |
| 13 | CPW Subject Object Process Flow Table |
| 14 | CPW Process Table, CPW Workflow Table |
| 15 | CPW Process, CPW Workflow |

### 37 CPW FUNCTIONAL REQUIREMENTS PLAN TRANSFORMATION

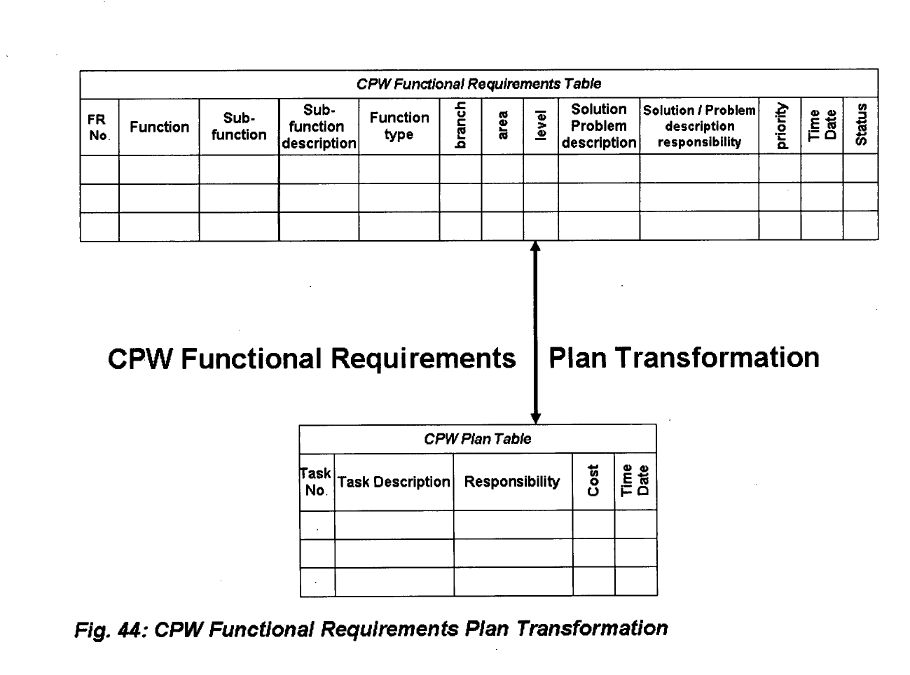

The FIG. 44 shows the CPW Functional Requirements Table and the transformed CPW Plan Table.

At the CPW Functional Requirements Table the attribute FR No. can be assigned to the attribute Task No. of the CPW Plan Table, to have a unique key at the CPW Functional Requirements Plan Transformation.

But it also can be assigned at the Functional Requirements Table the attributes Function and Subfunction as Primary Key or as unique Key to the attribute Task No. of the CPW Plan Table.

There are also different possibilities, to define a unique Key for the CPW Functional Requirements Plan Transformation.

Depending on the case at the CPW Functional Requirements Plan Transformation can be taken the direct or the indirect CPW Method Transformation.

Depending on the case and the scenario make sense a direct or indirect CPW Method Transformation, so that the CPW Method Transformation from the one CPW Method Component to the other CPW Method Component can be in relationship as follows:

| No. | CPW Method Transformation |
|---|---|
| 1 | Direct CPW Method Transformation |
| | In the 1:1 Relationship |
| 2 | Indirect CPW Method Transformation |
| | In the 1:M Relationship |
| | In the N:1 Relationship |
| | In the N:M Relationship |

Also here is the question, if depending on the case and the scenario are to be found or are to be derived rules, to automate the CPW Method Transformation. So it can be taken a complete automatic CPW Method Transformation through the configured system, or depending on the case an automatic CPW Method Transformation in combination with a manual CPW Method Transformation, or only a manual CPW Method Transformation.
Automatic CPW Method Transformation
Manual CPW Method Transformation

| No. | Key terms and definitions (Schlüsselbegriffe und Definitionen) |
|---|---|
| 1 | CPW Functional Requirements Table |
| 2 | CPW Plan Table |
| 3 | CPW Functional Requirements Plan Transformation |
| 4 | Unique Key at the CPW Method Transformation |
| 5 | Primary Key at the CPW Method Transformation |

### 38 CPW FRAMEWORK

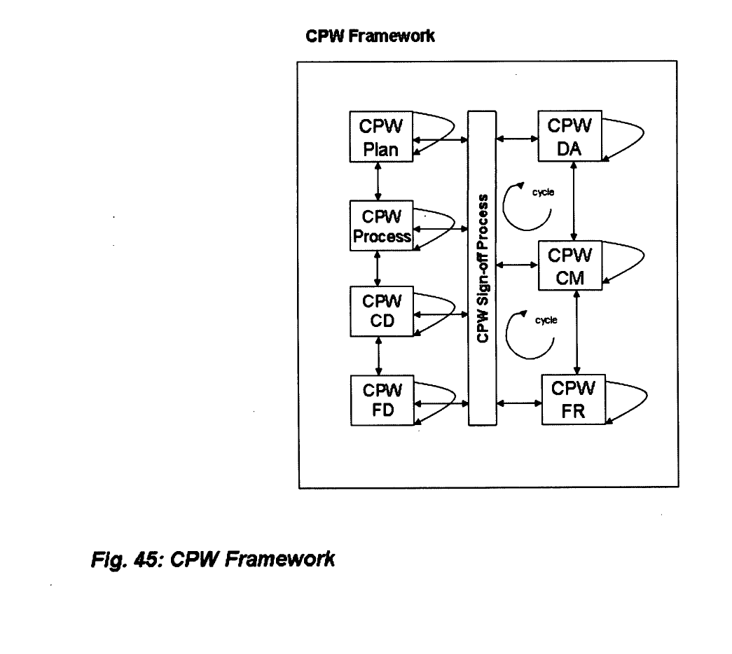

The FIG. 45 shows the CPW Framework with following CPW Method Components, which have been described in the previous chapters with the appropriate CPW Method Transformations.

| No. | CPW Framework with following CPW Method Components: |
|---|---|
| 1 | CPW DC (CPW Diagnostic Assessment) |
| 2 | CPW CM (CPW Change Management) |
| 3 | CPW FR (CPW Functional Requirements) |
| 4 | CPW Sign-off Process |
| 5 | CPW Plan |
| 6 | CPW CD (CPW Context Diagram) |
| 7 | CPW Object Context Diagram |
| 8 | CPW Subject Context Diagram |
| 9 | CPW Subject Object Diagram |
| 10 | CPW FD (CPW Functional Diagram) |

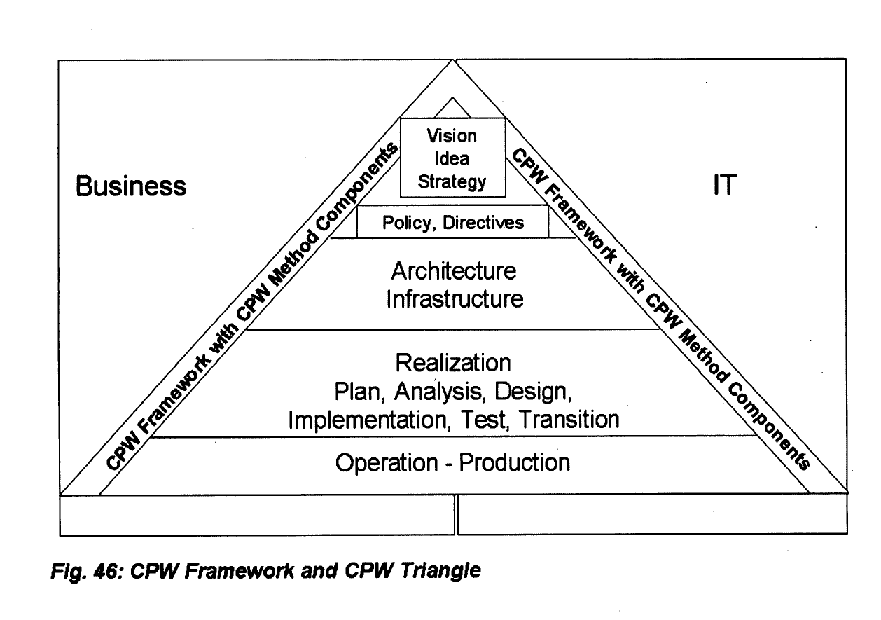

The FIG. 46 shows how the CPW Framework with CPW Method Components can be applied in Business and IT in the CPW Triangle.

| No. | Key terms and definitions (Schlüsselbegriffe und Definitionen) |
|---|---|
| 1 | CPW Framework |
| 2 | CPW Triangle |
| 3 | CPW Method Components |
| 4 | CPW Method Transformations |

### 39 METHOD TRANSFORMATION OF BDM/ERD TO CPW SUBJECT OBJECT CONTEXT DIAGRAM

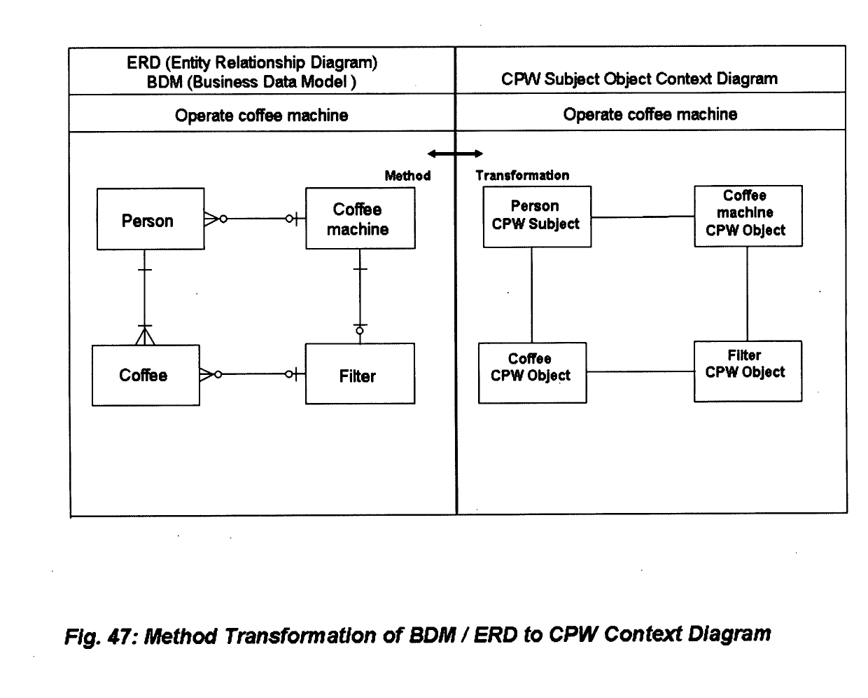

The FIG. 47 shows a Entity Relationship Diagram (ERD), which is regarded as a Business Data Model (BDM), and which is transformed by means of method transformation in a CPW Subject Object Context Diagram, the so-called CPW Context Diagram BDM Transformation.

At the method transformation of Entity Relationship Diagram (ERD) to the CPW Subject Object Context Diagram is transformed each entity of the ERD in a CPW Object or in a

CPW Subject. All relationships between the Entities of the ERD are transformed in the relationships between the particular CPW Subjects and CPW Objects of the CPW Subject Object Context Diagram.

In the CPW Subject Object Context Diagram are the CPW Objects in relationship to the CPW Subjects, which correspond to a responsibility.

| No. | Key terms and definitions (Schlüsselbegriffe und Definitionen) |
|---|---|
| 1 | Method Transformation of BDM/ERD to CPW Subject Object |
| | Context Diagram |
| 2 | Entity Relationship Diagram (ERD) |
| 3 | Entity |
| 4 | Business Data Model (BDM) |
| 5 | CPW Subject Object Context Diagram |
| 6 | CPW Object |
| 7 | CPW Subject |
| 8 | CPW Context Diagram BDM Transformation |

### 40 METHOD TRANSFORMATION FROM BDM/ERD TO CPW SUBJECT OBJECT RELATIONSHIP DIAGRAM

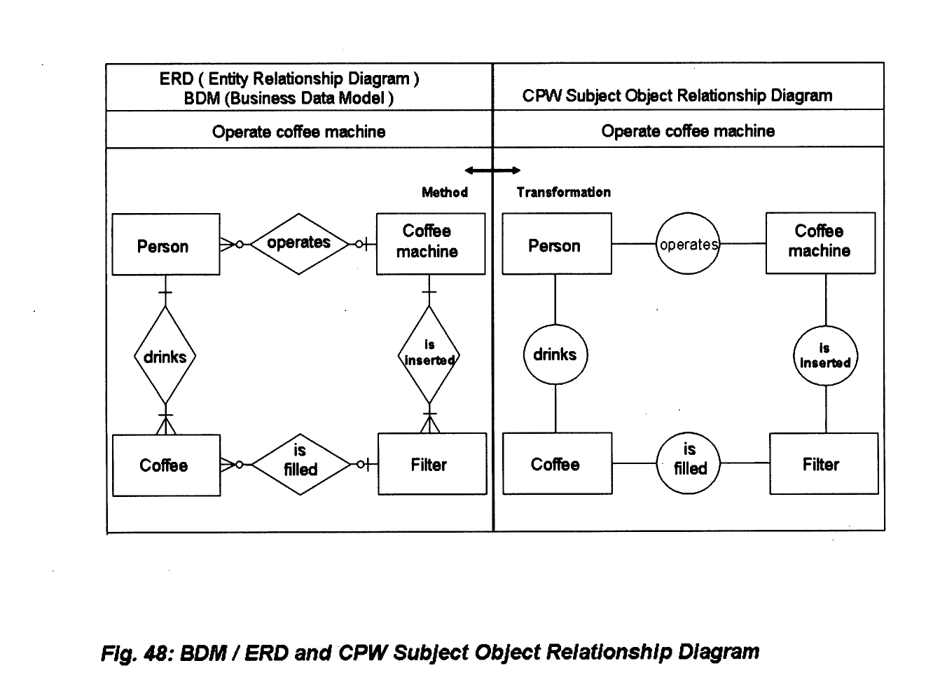

The FIG. 48 shows an Entity Relationship Diagram (ERD), which is regarded as Business Data Model (BDM) and which is transformed by means of Method Transformation in a CPW Subject Object Relationship Diagram.

At the Method Transformation of Entity Relationship Diagram (ERD) to the CPW Subject Object Relationship Diagram is transformed each Entity of the ERD in a CPW Object or in a CPW Subject. All relationships between the entities of the ERD, which are represented through a rhombus, are transformed as CPW Predicate, so that between all CPW Objects and CPW Subjects stand a CPW Predicate.

In the following table are rules for the grammar, semantics and the syntax of the CPW Subject Object Relationship Diagram:

| | Rules for grammar, semantics and syntax of the CPW Subject Object |
|---|---|
| No. | Relationship Diagram |
| 1 | A CPW Subject can also be in a CPW Subject Object Relationship |
| | Diagram a CPW Object and a CPW Object can also be a CPW Subject. |
| 2 | The relationship between a CPW Subject and a CPW Object is extended |
| | though a CPW Predicate, so that between each CPW Subject and CPW |
| | Object is a CPW Predicate. |
| 3 | The relationships between a CPW Subject and a CPW Object, which |
| | have been extended through a CPW Predicate, can be regarded as |
| | active simple sentence with CPW Subject, CPW Predicate and CPW Object. |
| 4 | The active simple sentence with CPW Subject, CPW Predicate and |
| | CPW Object can also be regarded as single CPW Process Step. |
| 5 | Is the active simple sentence formed as passive simple sentence, so from |
| | the CPW Subject becomes a CPW Object and from the CPW Object becomes |
| | a CPW Subject and the CPW Predicate is accordingly conjugated |
| | for the passive simple sentence. |

| No. | Key terms and definitions (Schlüsselbegriffe und Definitionen) |
|---|---|
| 1 | Method Transformation from BDM/ERD to CPW Subject Object |
| | Relationship Diagram |
| 2 | Entity Relationship Diagram (ERD) |
| 3 | Entity |
| 4 | Business Data Model (BDM) |
| 5 | CPW Subject Object Relationship Diagram |
| 6 | CPW Object |
| 7 | CPW Predicate |
| 8 | CPW Subject |
| 9 | Active simple sentence |
| 10 | Passive simple sentence |

### 41 CPW CONTEXT DIAGRAM SUBJECT OBJECT RELATIONSHIP DIAGRAM TRANSFORMATION

The FIG. 49 shows a CPW Subject Object Context Diagram, which has been transformed in a CPW Subject Object Relationship Diagram. This CPW Method Transformation is named as CPW Context Diagram Subject Object Relationship Diagram Transformation.

At the CPW Context Diagram Subject Object Relationship Diagram Transformation the CPW Subjects and the CPW Objects from the CPW Subject Object Context Diagram can be taken direct for the CPW Subject Object Relationship Diagram.

The relationships between the CPW Subjects and the CPW Objects in the CPW Subject

Object Relationship Diagram are extended through the CPW Predicates, so that between each CPW Subject and CPW Object is a CPW Predicate.

| No. | Key terms and definitions (Schlüsselbegriffe und Definitionen) |
|---|---|
| 1 | CPW Context Diagram Subject Object Relationship Diagram |
| | Transformation |
| 2 | CPW Subject Object Context Diagram |
| 3 | CPW Method Transformation |

### 42 METHOD TRANSFORMATION OF AN ENTITY RELATIONSHIP DIAGRAM TO A CPW PROCESS OR CPW WORKFLOW

In the chapter Method Transformation of BDM/ERD to CPW Subject Object Context Diagram is described and in FIG. 47 is represented, how from an Entity Relationship Diagram (ERD) respectively a Business Data Model (BDM) is transformed a CPW Subject Object Context Diagram, the so-called CPW Context Diagram BDM Transformation.

In the chapter Method Transformation of BDM/ERD to CPW Subject Object Relationship Diagram is described and in FIG. 48 is represented, how from an Entity Relationship Diagram (ERD) respectively a Business Data Model (BDM) is transformed a CPW Subject Object Relationship Diagram.

In the chapter CPW Context Diagram Subject Object Relationship Diagram Transformation is described and in FIG. 49 is represented, how from a CPW Subject Object Context Diagram is transformed a CPW Subject Object Relationship Diagram.

In the chapters Variant A Method Transformation of CPW Object Context Diagram Process Transformation, Variant B Method Transformation of CPW Subject Object Context Diagram Process Transformation and Variant C Method Transformation of CPW Object Context Diagram Process Transformation are described the Variants A, B, C Method Transformations of the CPW Context Diagram Process Transformation.

It is possible in this context, to transform from an Entity Relationship Diagram (ERD) respectively a Business Data Model (BDM) a CPW Context Diagram or a CPW Subject Object Relationship Diagram. And then afterwards as a next work step to transform from a CPW Context Diagram a CPW Process or CPW Workflow with the CPW Context Diagram Process Transformation. With the described work steps can be named this variant of the Method Transformation as CPW BDM Process Transformation.

In the context with the CPW Method can be transformed the CPW Process or CPW Workflow also in a CPW Dialog, so that a Method Transformation of a BDM/ERD to a CPW Dialog is also possible.

This variant of the Method Transformation of an Entity Relationship Diagram (ERD) to a CPW Process or CPW Workflow as CPW BDM Process Transformation could then make sense for example, if in a project for various reason only exist the data model in form of an Entity Relationship Diagram (ERD) respectively BDM as documentation and it is the objective to realize a process.

| No. | Key terms and definitions (Schlüsselbegriffe und Definitionen) |
|---|---|
| 1 | Method Transformation of an Entity Relationship Diagram to a |
| | CPW Process or CPW Workflow |
| 2 | Entity Relationship Diagram (ERD) |
| 3 | Business Data Model (BDM) |
| 4 | CPW Subject Object Context Diagram |
| 5 | CPW Context Diagram BDM Transformation |
| 6 | CPW Subject Object Relationship Diagram |
| 7 | Variants A, B, C Method Transformation of the CPW Context |
| | Diagram Process Transformation |
| 8 | CPW BDM Process Transformation |
| 9 | CPW Process |
| 10 | CPW Workflow |
| 11 | CPW Dialog |

### 43 CPW BUSINESS SYSTEM DESCRIPTION

In FIG. 50 is represented the CPW Framework with the CPW Business System Description (CPW BS Description)

The Business System is described in prose text with a preferably stringent and didactical structure, so that the project people can get a good understanding for the to-be-executed Business System. As a basis for the CPW Business System Description may serve a guideline of the enterprise.

Within the CPW Business System Description are references to the different, acquired and executed CPW Method Components and the CPW Method Component Instances of the CPW Frameworks.

It is the objective, to create a didactic, functional, up-to-date good work, which then can be used as a basis for the CPW Sign-off Process of the project, where the CPW Business System Description is evaluated and is assessed by the expert committees and committees with the objective to achieve a Sign-off of the project.

| No. | Key terms and definitions (Schlüsselbegriffe und Definitionen) |
|---|---|
| 1 | CPW Business System Description (CPW BS Description) |
| 2 | CPW Framework |
| 3 | CPW Method Components |
| 4 | Business System |
| 5 | CPW Sign-off Process |

### 44 BUSINESS CASE, SPECIFICATION CASE, PRODUCTION CASE

In FIG. 51 is represented the CPW Framework with the connection to Business Case (BC), Specification Case (SC) and Production Case (PC). With Business Case, Specification Case and Production Case are named the phases, which run through the projects or programs of an enterprise. How in FIG. 51 is represented, the Business Case, Specification Case and Production Case is connected with a Sign-off Process.

Within a Sign-off Process are involved all responsibilities of the project or of the program, to decide over the important points of the project or of the program.

Enterprises have usually a guideline, how this Sign-off Process proceed in detail for various project variants.

During the process of the project or of the program the Sign-off Process of the project and of the program is synchronized with the CPW Sign-off Process of the CPW Framework.

| No. | Key terms and definitions (Schlüsselbegriffe und Definitionen) |
|---|---|
| 1 | Business Case (BC), |
| 2 | Specification Case (SC) |
| 3 | Production Case (PC) |
| 4 | Sign-off Process |
| 5 | CPW Sign-off Process |
| 6 | CPW Framework |

### 45 CPW ENTERPRISE ARCHITECTURE FRAMEWORK

In FIG. 52 is represented the CPW Enterprise Architecture Framework and CPW Enterprise Architecture Engine. With the CPW Enterprise Architecture Framework, which is based upon the concept of the CPW Framework, is implemented the CPW Enterprise Architecture Engine.

In the following table are defined rules, High Level Key Requirements and Functions for the CPW Enterprise Architecture Framework or the CPW Enterprise Architecture Engine with CPW Frameworks.

| | Rules, High Level Key Requirements and Functions for the CPW |
|---|---|
| | Enterprise Architecture Framework or the CPW Enterprise |
| No. | Architecture Framework Engine with CPW Frameworks |
| 1 | In the CPW Enterprise Architecture Framework can be created one to |
| | many CPW Frameworks. Thereby can be assigned again to the CPW |
| | Frameworks one to many CPW Method Components. |
| 2 | Within a CPW Framework from a CPW Method Component can be created |
| | one to many CPW Method Component Instances. |
| | At the CPW Method Component CPW Plan this means that for example, that |
| | can be created one to many CPW Plans. |
| 3 | In the CPW Enterprise Architecture Framework can be created one to many |
| | CPW Frameworks independent from each other. |
| 4 | A created CPW Framework can be assigned again one to many CPW |
| | Frameworks. Thereby it is possible to create with the created CPW |
| | Frameworks a hierarchical tree structure, a so-called hierarchical tree |
| | structure of CPW Frameworks. |
| 5 | Within a CPW Enterprise Architecture Engine in the hierarchical tree |
| | structure of CPW Frameworks, which in the hierarchy highest CPW |
| | Framework is named as CPW Parent Framework and which in the |
| | hierarchy direct underlying CPW Frameworks are named as CPW Child |
| | Frameworks. Because a hierarchical tree structure can have many |
| | hierarchy levels, there is then the highest CPW Parent Framework with the |
| | underlying CPW Child Frameworks. And the CPW Child Framework again |
| | then can be named as CPW Parent Framework, if below follows a further |
| | hierarchy level with CPW Child Frameworks. |
| 6 | Within a CPW Enterprise Architecture Framework can be created one to |
| | many tree structures of CPW Frameworks. It is the CPW Enterprise |
| | Architecture Framework or the CPW Enterprise Architecture Engine |
| | with hierarchical tree structures of CPW Frameworks. |
| 7 | The CPW Frameworks can be created at any time additional CPW Method |
| | Components as well. But it can also be deleted CPW Method Components of CPW |
| | Frameworks. |
| 8 | A tree structure of CPW Frameworks can be assigned at any time |
| | additional CPW Frameworks. |
| 9 | In the CPW Enterprise Architecture Framework or in the CPW Enterprise |
| | Architecture Engine it is possible within a CPW Framework or between two |
| | CPW Frameworks between two CPW Method Components to perform the |
| | functions of the CPW Method Transformation. It is the CPW Enterprise |
| | Architecture Framework or the CPW Enterprise Architecture Engine |
| | with the functions of the CPW Method Transformation. |
| 10 | In the CPW Enterprise Architecture Framework it is possible within a CPW |
| | Framework to configure the automatic direct CPW Method Transformation |
| | or automatic indirect CPW Method Transformation between the CPW |
| | Method Components. |
| | This kind of configuration belongs to the CPW Framework Configuration. |
| 11 | It should also be possible from two various CPW Method Components |
| | from two different CPW Frameworks to configure an automatic direct CPW |
| | Method Transformation or an automatic indirect CPW Method |
| | Transformation. This kind of the configuration belongs to the CPW |
| | Enterprise Architecture Engine Configuration. |
| 12 | In the CPW Enterprise Architecture Framework it is possible within a CPW |
| | Framework to take or to perform the manual CPW Method |
| | Transformation between the CPW Method Components. |
| 13 | It should also be possible from two various CPW Method Components |
| | from two different CPW Frameworks to take or to perform a manual CPW |
| | Method Transformation. |
| 14 | It should also be possible from two various CPW Method Components |
| | from two different CPW Frameworks, which again belong to two different |
| | tree structures of CPW Frameworks, to take or to perform a CPW Method |
| | Transformation. |
| 15 | The CPW Enterprise Architecture Engine provides an external |
| | interface, which makes it possible to transform the internal CPW Method |
| | Components to external Tools and applications with external method |
| | components. |
| 16 | In the CPW Enterprise Architecture Framework it is possible to transform |
| | the CPW Method Components to the external method components |
| | Business Case (BC), Specification Case (SC), and Production Case |
| | (PC), which are assigned to a project or program. |
| 17 | Within a CPW Framework the CPW Method Components can be |
| | configured within the scope of the CPW Framework Configuration like this, |
| | so that the data, which are transformed or synchronized from one CPW |
| | Method Component to another, should run through or not a CPW Sign-off |
| | Process. |
| 18 | The described functions within of the CPW Enterprise Architecture |
| | Framework and the CPW Enterprise Architecture Engine, which make |
| | possible a configuration, are assigned to the CPW Enterprise |
| | Architecture Engine Configuration and the CPW Framework |
| | Configuration. |

| | Rules, High Level Key Requirements and Functions for the CPW |
|---|---|
| | Enterprise Architecture Framework or the CPW Enterprise |
| No. | Architecture Framework Engine for the function of synchronization. |
| 1 | Within of the CPW Enterprise Architecture Framework with the function |
| | synchronization it should be possible to synchronize two equal CPW |
| | Method Components from two different CPW Frameworks. The |
| | synchronization can be manual or automatic configurable. The |
| | synchronization should be possible in both directions. It is the so-called |
| | manual synchronization or automatic synchronization of two equal |
| | CPW Method Components from two different CPW Frameworks. |
| 2 | Within of the CPW Enterprise Architecture Framework it should be |
| | possible to synchronize two CPW Frameworks. The synchronization can |
| | be manual or automatic configurable. The synchronization should be |
| | possible in both directions. It is the so-called manual or automatic |
| | synchronization of two CPW Frameworks. |
| 3 | Within of the CPW Enterprise Architecture Framework it should be |
| | possible, to synchronize a CPW Method Component in a CPW Parent |
| | Framework in a tree structure with all equal CPW Method Components, |
| | which are located in the CPW Child Frameworks of the tree structure. |
| 4 | Within of the CPW Enterprise Architecture Framework it should be |
| | possible to synchronize all CPW Method Components in a CPW Parent |
| | Framework in a tree structure with all equal CPW Method Components, |
| | which are located in the CPW Child Frameworks of the tree structure. It is |
| | the so-called synchronization of CPW Method Components between |
| | CPW Parent Framework and CPW Child Frameworks in a tree |
| | structure. |
| 5 | Within of the CPW Enterprise Architecture Framework it should be |
| | possible to synchronize a CPW Method Component of a CPW |
| | Framework of a tree structure with all equal CPW Method Components, |
| | which are located in the tree structure. |
| 6 | Within of the CPW Enterprise Architecture Framework it should be |
| | possible to synchronize two CPW Method Components from two |
| | different CPW Frameworks of two different tree structures. |
| 7 | The synchronization between two CPW Method Components can be |
| | configured according to a logic operation. It is the so-called synchronization of two |
| | CPW Method Components with a logic operation. |
| 8 | The synchronization between two CPW Frameworks can be configured |
| | according to a logic operation. It is the so-called synchronization of two CPW |
| | Frameworks with a logic operation. |
| 9 | The synchronization between the CPW Frameworks within a tree structure can be |
| | configured according to a logic operation. It is the so-called synchronization of two |
| | CPW Frameworks with a logic operation within a tree structure. |
| 10 | The synchronization between the CPW Frameworks between two tree |
| | structures can be configured according to a logic operation. It is the so- |
| | called synchronization of CPW Frameworks with a logic operation from two |
| | various tree structures. |
| 11 | The synchronization encloses among others with their configuration |
| | possibility as logic operation the Map and Gap Analysis. This means, that |
| | with the function synchronization and with their configuration possibility as |
| | logic operation the Map and Gap Analysis can be realized. |
| 12 | The synchronization also encloses with their configuration possibility as |
| | logic operation the distribution of CPW Method Components |
| | Instances. This means, that the function synchronization and with their |
| | configuration possibility as logic operation the CPW Method Components |
| | Instances within a tree structure can be distributed, or can be distributed |
| | from one tree structure to another tree structure. |
| 13 | The CPW Enterprise Architecture Engine provides an external interface, |
| | which makes it possible to external tools and applications to synchronize |
| | external method components to the internal CPW Method Components |
| | and the other way around. It is the so-called synchronization of external |
| | method components with internal CPW Method Components by means of |
| | external interface of the CPW Enterprise Architecture Engine. |
| 14 | In the CPW Enterprise Architecture Framework it is possible to perform the |
| | function of the synchronization to the external method components |
| | Business Case (BC), Specification Case(SC), and Production Case (PC), |
| | which are assigned to a project or program. |
| 15 | The synchronization can be taken manual or automatic according to |
| | periodic time intervals (e.g.: hourly, daily, weekly, monthly) or in real-time. |
| | It is the so-called manual synchronization of CPW Frameworks or the |
| | automatic synchronization of CPW Frameworks. |
| 16 | Within a CPW Enterprise Architecture Framework it is possible, that the |
| | CPW Method Component Instances of the same CPW Method Component |
| | within a CPW Framework can be synchronized. |

| | Rules, High Level Key Requirements and Functions for the CPW |
|---|---|
| | Enterprise Architecture Framework or the CPW Enterprise |
| No. | Architecture Framework Engine for the function security |
| 1 | The CPW Enterprise Architecture Engine can be connected through an |
| | external interface to an external user permission system. |
| 2 | All CPW Method Component Instances, which are assigned to a CPW |
| | Enterprise Architecture Framework, can be assigned through authorization |
| | to the corresponding persons or organizational units. |
| 3 | There are permissions for CPW Method Components, which are assigned |
| | to a CPW Framework and for complete CPW Frameworks, which are |
| | assigned to a tree structure, which can be assigned to the corresponding |
| | persons or organizational units through authorization. |
| 4 | There are permissions for CPW Frameworks, or for whole tree structures |
| | of CPW Frameworks, which can be assigned to the corresponding persons |
| | or organizational units through authorization. |
| 5 | The permissions refer to Create, Read, Update and Delete. |
| | The permissions refer to all functionalities of the synchronization. |
| | The permissions refer to all functionalities of the CPW Method Transformations. |
| | All permissions can be assigned to the corresponding persons through authorization. |

In FIG. 53 is represented a CPW Enterprise Architecture Framework with a tree structure of CPW Frameworks. At the tree structure of CPW Frameworks the area Enterprise Architecture is subdivided into the area Business Architecture and IT.

The area Business Architecture is subdivided into the area Information Model, Business Requirements Model and Business System Model. The area IT is subdivided into the area Data Model, Application Model and System Model.

The areas Information Model, Business Requirements Model and Business System Model are each assigned the Business Case(BC), Specification Case(SC) and Production Case (PC). The areas Data Model, Application Model and System Model are each assigned the Business Case (BC), Specification Case(SC) and Production Case (PC).

All areas within this tree structure is assigned a CPW Framework. According to the configuration possibility of the CPW Enterprise Architecture Frameworks or CPW Enterprise Architecture Engine through the CPW Enterprise Architecture Configuration are assigned each CPW Framework within the tree structure the CPW Method Components or the external method components.

In FIG. 54 is represented a CPW Triangle. It shows, that the CPW Enterprise Architecture Framework can be applied on the represented levels in Business and IT. In the previous described CPW Enterprise Architecture Framework there is a splitting of the CPW Frameworks for the project phases of Business Case, Specification Case and Production Case. These three CPW Frameworks with project phases can be assigned for example to the levels in the CPW Triangle as follows:

| | Assignment of the CPW Frameworks for the |
|---|---|
| | area Business Case, Specification Case and |
| | Production Case to the levels in the CPW Triangle |
| No. | at the CPW Enterprise Architecture Framework |
| 1 | Business Case |
| | Vision, Idea |
| | Strategy |
| 2 | Specification Case |
| | Policy, Guidelines |
| | Architecture |
| | Infrastructure |
| | Realization(Plan, Analysis, Design, Implementation, |
| | Test, Transition) |
| 3 | Production Case |
| | Operation - Production |

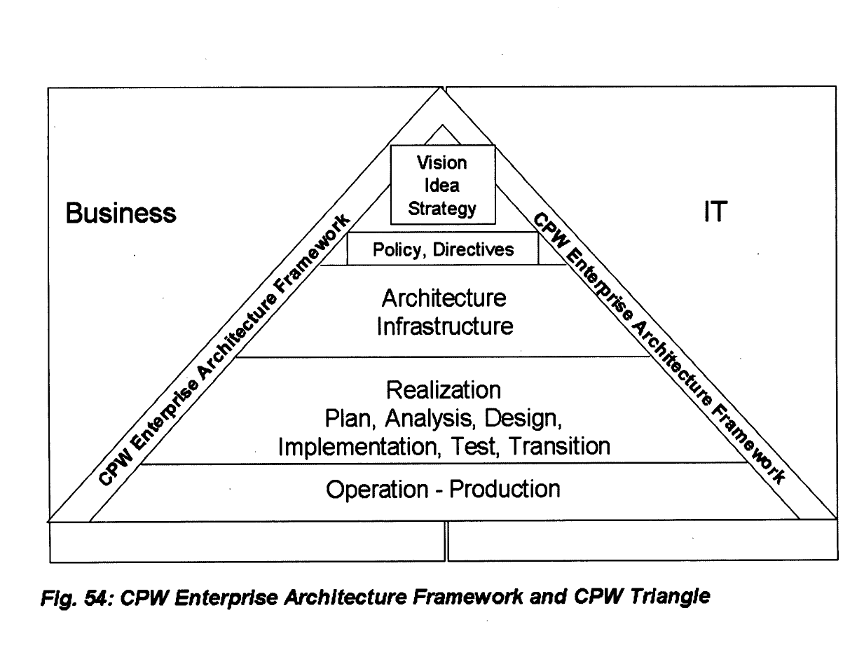

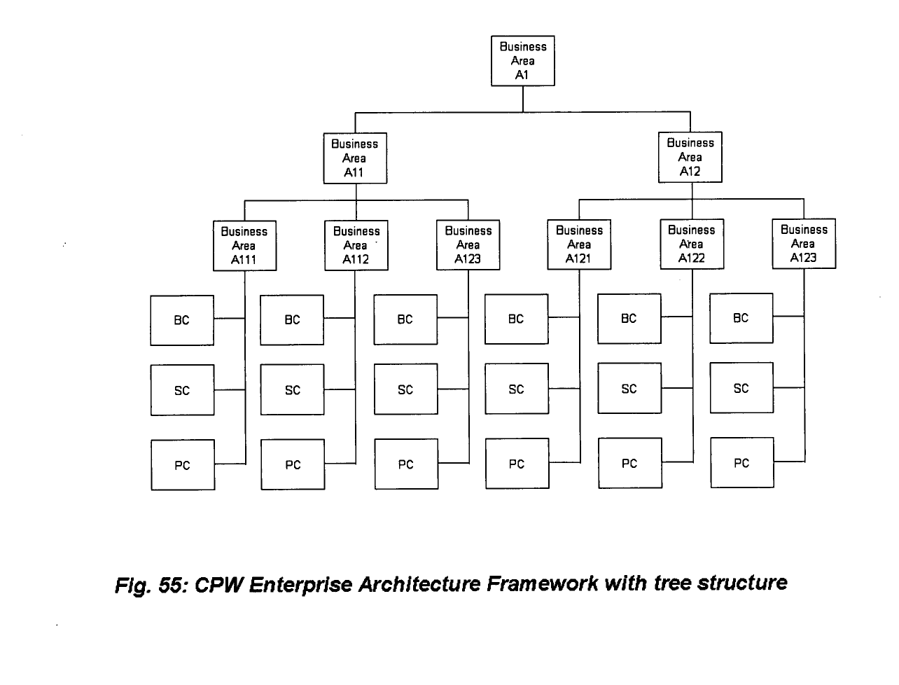

The FIG. 55 shows the tree structure of a CPW Enterprise Architecture Framework or a CPW Enterprise Architecture Engine. At the tree structure a Business Area is subdivided into various Business Areas. Each Business Area is assigned a CPW Framework. Each subdivided Business Area is each assigned a Business Case, a Specification Case and a Production Case, which again is also assigned a CPW Framework.

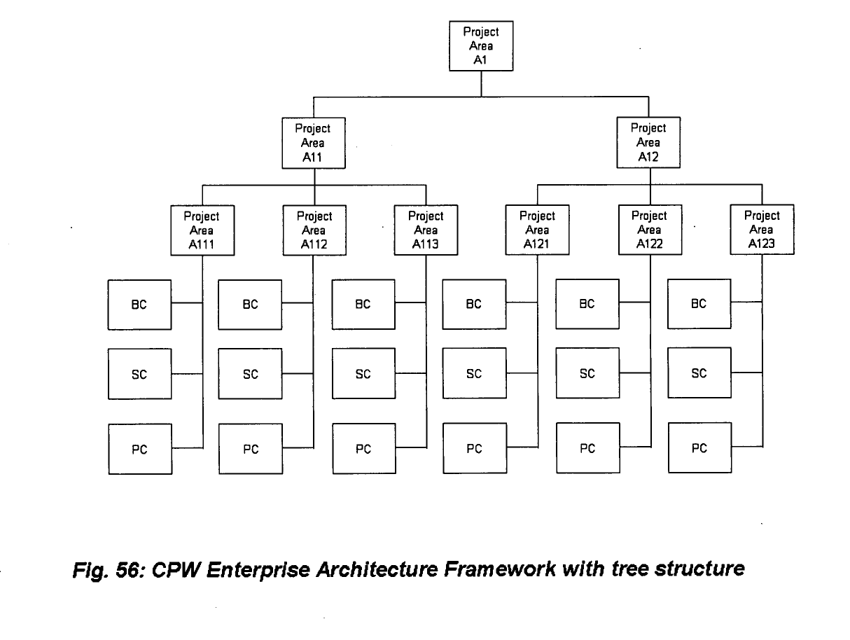

The FIG. 56 shows the tree structure of a CPW Enterprise Architecture Framework or a CPW Enterprise Architecture Engine. At the tree structure a Project Area is subdivided into various Project Areas. Each Project Area is assigned a CPW Framework. Each subdivided Project Area is each assigned a Business Case, a Specification Case and a Production Case, which again is also assigned a CPW Framework.

| No. | Key terms and definitions (Schlüsselbegriffe und Definitionen) |
|---|---|
| 1 | Functions of the CPW Enterprise Architecture Framework |
| | and the CPW Enterprise Architecture Engine |
| 2 | CPW Enterprise Architecture Framework |
| 3 | CPW Enterprise Architecture Engine |
| 4 | CPW Frameworks |
| 5 | CPW Method Components |
| 6 | CPW Method Component Instances |
| 7 | hierarchical tree structure |
| 8 | A hierarchical tree structure of CPW Frameworks |
| 9 | A tree structure of CPW Frameworks |
| 10 | CPW Parent Framework |
| 11 | CPW Child Framework |
| 12 | CPW Framework Configuration |
| 13 | CPW Enterprise Architecture Engine Configuration |
| 14 | automatic direct or automatic indirect CPW Method |
| | Transformation |
| 15 | manual CPW Method Transformation |
| 16 | CPW Enterprise Architecture Engine with external Interface |
| 17 | external method components |
| 18 | external method components Business Case (BC), |
| | Specification Case(SC), and Production |
| | Case (PC) |
| 19 | CPW Sign-off Process |
| 20 | CPW Enterprise Architecture Framework Engine with the function |
| | synchronization |
| 21 | CPW Enterprise Architecture Framework Engine for the function |
| | synchronization |
| 22 | Synchronization of external method components with |
| | internal CPW Method Components by means |
| | of external Interface |
| 23 | manual or automatic synchronization of two equal CPW Method |
| | Components from two different CPW Frameworks |
| 24 | manual or automatic synchronization of two CPW Frameworks |
| 25 | CPW Parent Framework in a tree structure |
| 26 | CPW Child Frameworks in a tree structure |
| 27 | Synchronization of CPW Method Components between |
| | CPW Parent Framework and CPW |
| | Child Frameworks in a tree structure. |
| 28 | Synchronization of two CPW Method Components with a |
| | logic operation. |
| 29 | Synchronization of two CPW Frameworks with a logic operation. |
| 30 | Synchronization of two CPW Frameworks with a logic operation |
| | within a tree structure |
| 31 | Synchronization of CPW Frameworks with a logic operation from |
| | two various tree structures |
| 32 | Map and Gap Analysis |
| 33 | Distribution of CPW Method Components Instances |
| 34 | manual synchronization of CPW Frameworks |
| 35 | automatic synchronization of CPW Frameworks |
| 35 | CPW Enterprise Architecture Framework and CPW |
| | Enterprise Architecture Framework Engine |
| | with the function security |
| 36 | Permissions of corresponding persons or organizational units. |
| 37 | Authorization of corresponding persons or organizational units. |
| 38 | CPW Enterprise Architecture Framework with tree structure |
| 39 | The tree structure of the area Enterprise Architecture is |
| | subdivided into the area Business Architecture and IT |
| 40 | CPW Triangle |

### 46 VARIANTS AND EXAMPLES OF CPW ENTERPRISE ARCHITECTURE FRAMEWORKS

Examples for Various Variants of CPW Enterprise Architecture Frameworks and External Frameworks

The FIG. 53 shows the tree structure of the Enterprise Architecture with Business Architecture and IT. The tree structure of the IT is subdivided into Data Model, Application Model and System Model. Data Model, Application Model and System Model are each assigned the project phases Business Case (BC), Specification Case (SC) and Production Case (PC).

Each point within the tree structure is or can be assigned a CPW Framework. Each CPW Framework can be assigned one to many CPW Method Components or external method components.

The following examples show represented in tables, what sort of CPW Frameworks with CPW Method Components and external method components are assigned to the project phases Business Case (BC), Specification Case (SC) and Production Case (PC), and to the Data Model, Application Model and System Model.

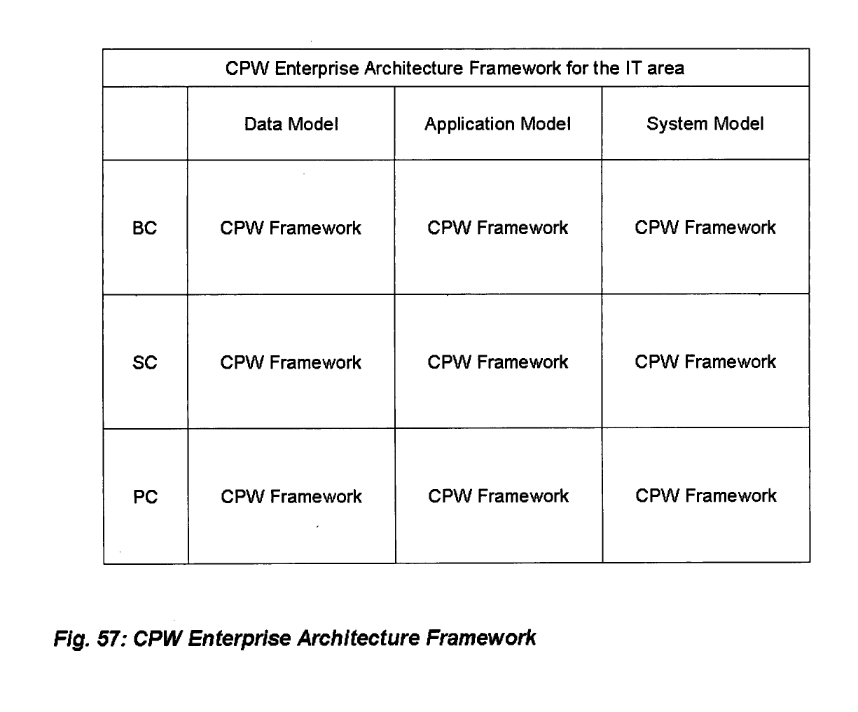

The FIG. 57 shows, that at the CPW Enterprise Architecture Framework at the area of the IT with Data Model, Application Model and System Model at the project phases Business Case (BC), Specification Case (SC) and Production Case (PC) is each assigned a CPW Framework.

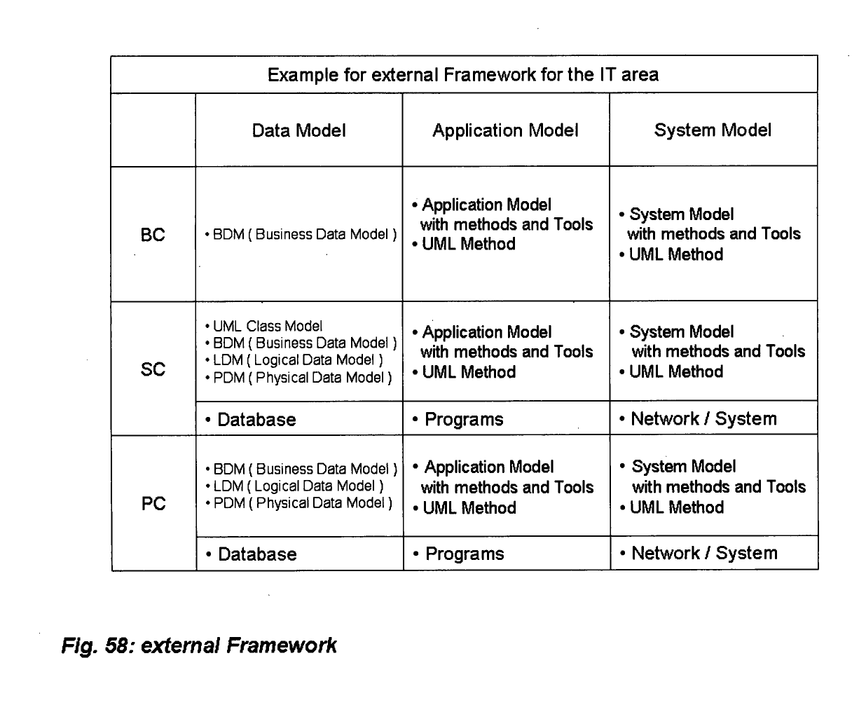

The FIG. 58 shows an example for an external Framework for the area of the IT with Data Model, Application Model and System Model and what sort of method components are each assigned to the project phases Business Case (BC), Specification Case (SC) and Production Case (PC).

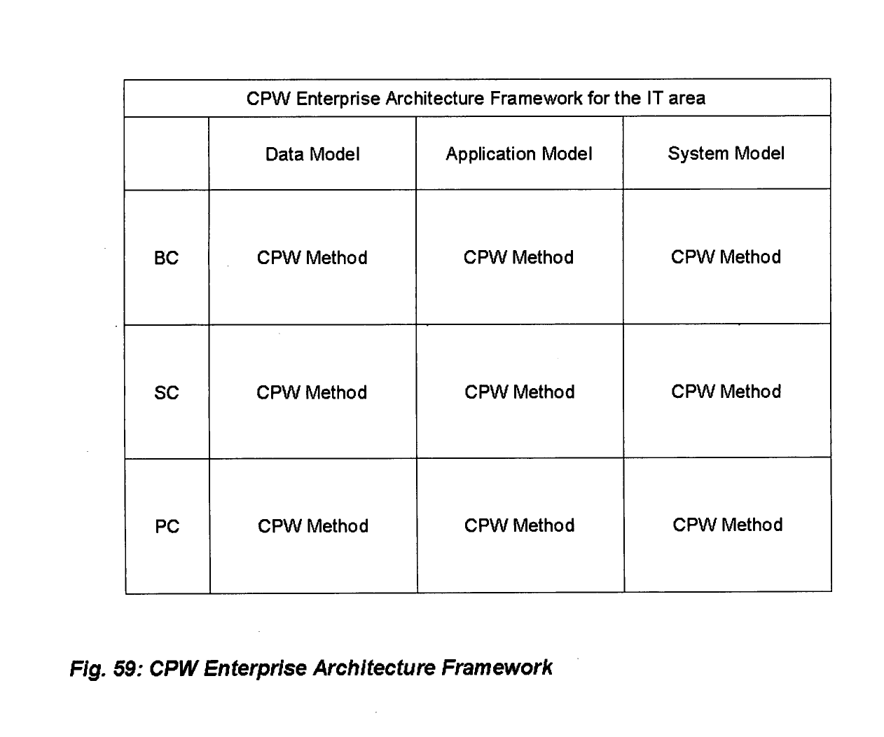

The FIG. 59 shows, that at the CPW Enterprise Architecture Framework at the area of the IT with Data Model, Application Model and System Model, at the project phases Business Case (BC), Specification Case (SC) and Production Case (PC) is each assigned the CPW Method.

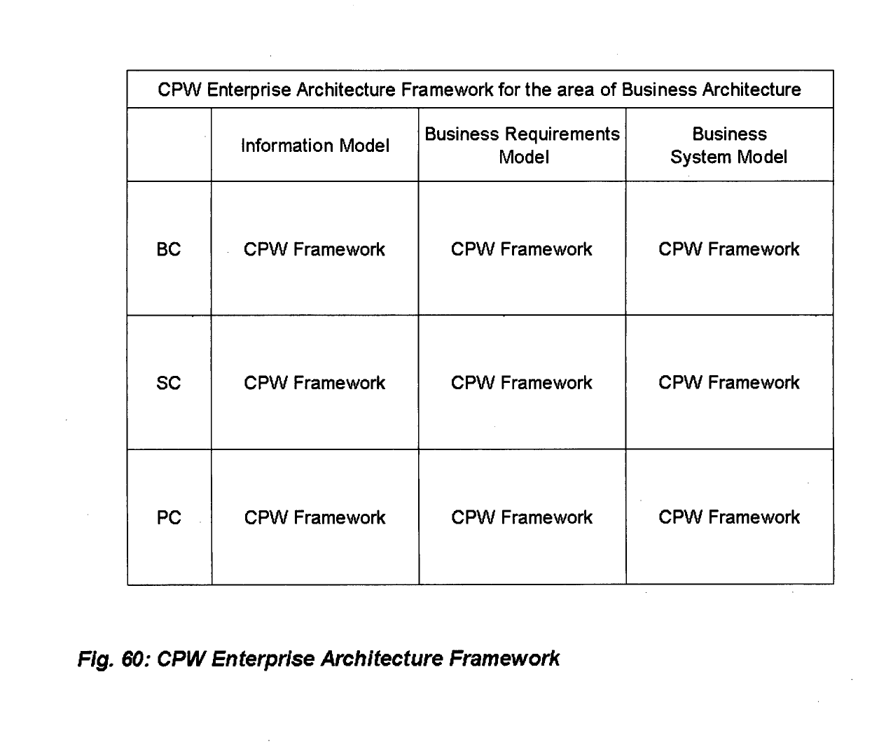

The FIG. 60 shows, that at the CPW Enterprise Architecture Framework at the area of the Business Architecture with Information Model, Business Requirements Model and Business System Model at the project phases Business Case (BC), Specification Case (SC) and Production Case (PC) is each assigned a CPW Framework.

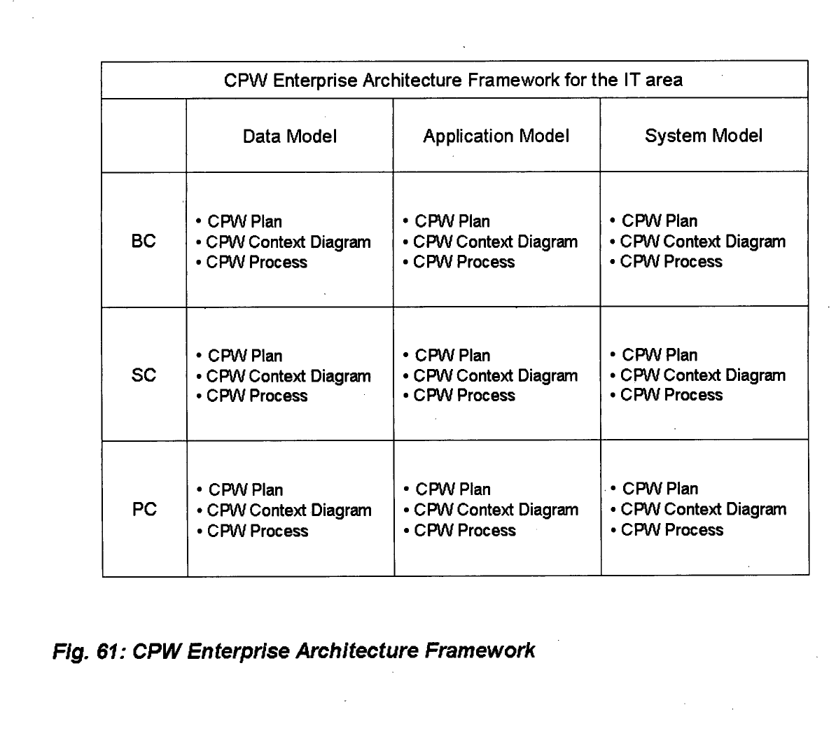

The FIG. 61 shows, that at the CPW Enterprise Architecture Framework at the area of the IT with Data Model, Application Model and System Model at the project phases Business Case (BC), Specification Case (SC) and Production Case (PC) is each assigned a CPW Framework with the CPW Method Components CPW Plan, CPW Context Diagram and CPW Process.

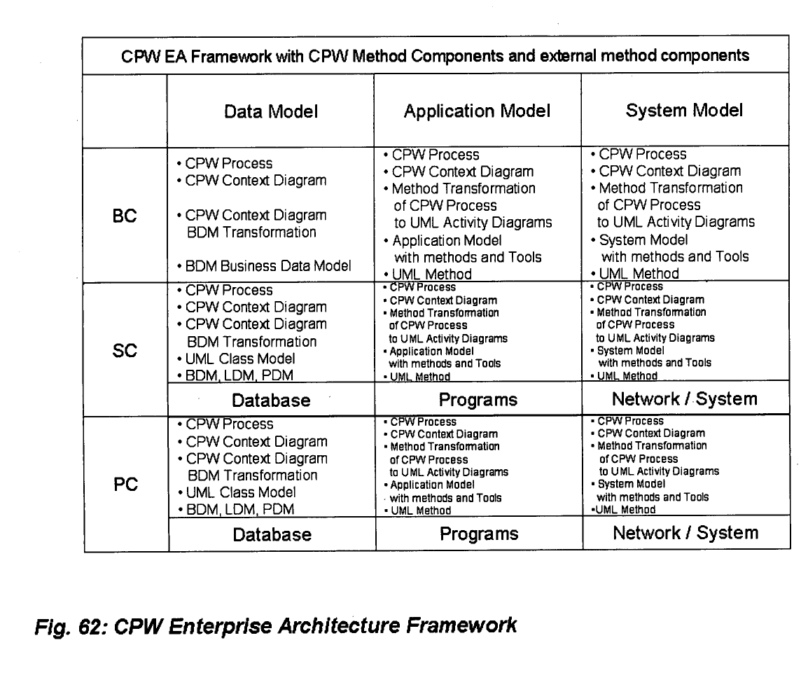

The FIG. 62 shows a CPW Enterprise Architecture Framework (CPW EA Framework) for the area of the IT with Data Model, Application Model and System Model, and what sort of CPW Method Components and external method components in a CPW Framework are each assigned to the project phases Business Case (BC), Specification Case (SC) and Production Case (PC).

The following table shows, which CPW Method Components, external method components, CPW Method Transformations and Transformations are each assigned to the CPW Frameworks in the tree structure in the CPW Enterprise Architecture Framework (CPW EA Framework).

| | CPW EA Framework with tree structure of CPW |
|---|---|
| | Frameworks with CPW Method Components, |
| | external method components, CPW Method |
| No. | Transformations and Transformations |
| 1 | CPW Framework for the area: Data Model - BC |
| | CPW Process |
| | CPW Context Diagram |
| | CPW Context Diagram BDM Transformation |
| | BDM Business Data Model |
| 2 | CPW Framework for the area: Data Model - SC |
| | CPW Process |
| | CPW Context Diagram |
| | CPW Context Diagram BDM Transformation |
| | UML Class Model |
| | BDM, LDM, PDM |
| | Database |
| 3 | CPW Framework for the area: Data Model - PC |
| | CPW Process |
| | CPW Context Diagram |
| | CPW Context Diagram BDM Transformation |
| | UML Class Model |
| | BDM, LDM, PDM |
| | Database |
| 4 | CPW Framework for the area: Application Model - BC |
| | CPW Process |
| | CPW Context Diagram |
| | Method transformation of CPW Process to UML Activity |
| | Diagrams Application Model with methods and Tools |
| | UML Method |
| 5 | CPW Framework for the area: Application Model - SC |
| | CPW Process |
| | CPW Context Diagram |
| | Method transformation of CPW Process to UML Activity |
| | Diagrams Application Model with methods and Tools |
| | UML Method |
| | Programs |
| 6 | CPW Framework for the area: Application Model - PC |
| | CPW Process |
| | CPW Context Diagram |
| | Method transformation of CPW Process to UML Activity |
| | Diagrams Application Model with methods and Tools |
| | UML Method |
| | Programs |
| 7 | CPW Framework for the area: System Model - BC |
| | CPW Process |
| | CPW Context Diagram |
| | Method transformation of CPW Process to UML Activity |
| | Diagrams System Model with methods and Tools |
| | UML Method |
| 8 | CPW Framework for the area: System Model - SC |
| | CPW Process |
| | CPW Context Diagram |
| | Method transformation of CPW Process to UML Activity |
| | Diagrams System Model with methods and Tools |
| | UML Method |
| | Network/System |
| 9 | CPW Framework for the area: System Model - PC |
| | CPW Process |
| | CPW Context Diagram |
| | Method transformation of CPW Process to UML Activity |
| | Diagrams System Model with methods and Tools |
| | UML Method |
| | Network/System |

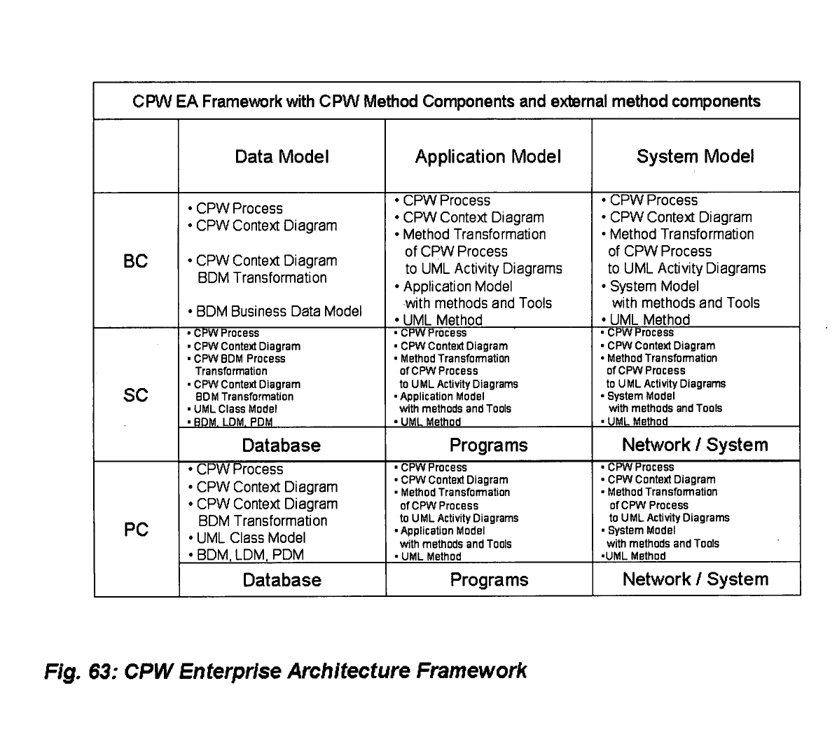

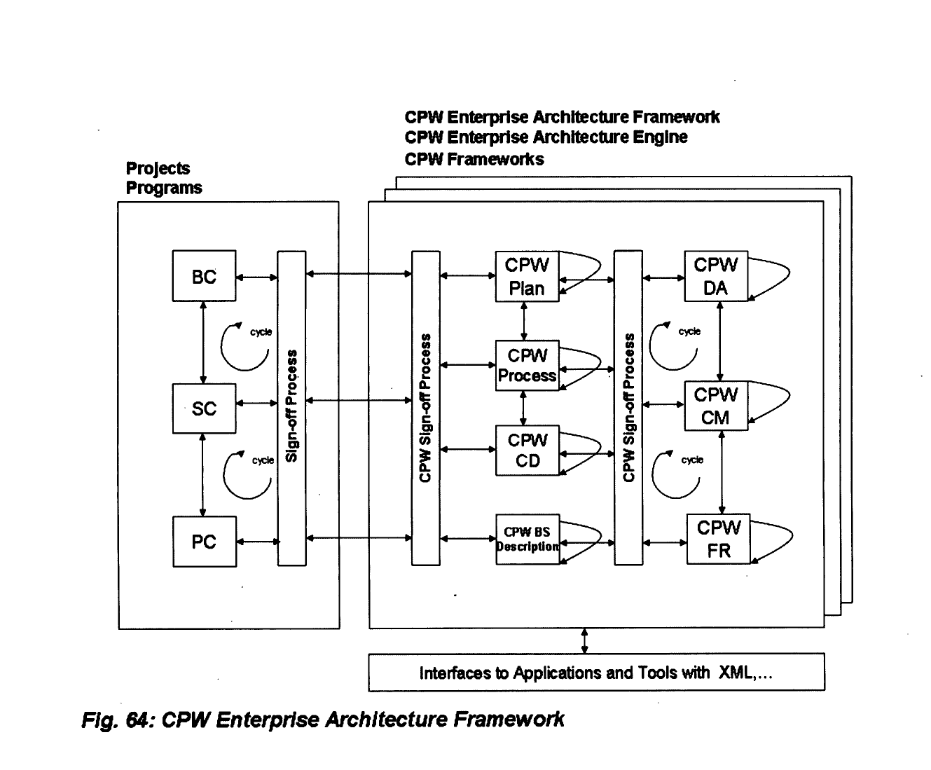

The FIG. 63 shows a CPW Enterprise Architecture Framework (CPW EA Framework) for the area of the IT with Data Model, Application Model and System Model and what sort of CPW Method Components and external method components are assigned to the project phases Business Case (BC), Specification Case (SC) and Production Case (PC) in each case of a CPW Framework.

The CPW EA Framework with the CPW Method Components, external method components, CPW Method Transformations and Transformations in FIG. 63 corresponds basically to the CPW EA Framework in FIG. 62 with the difference, that at the CPW Framework for the area Data Model—SC has also been added in addition the CPW Method Transformation CPW BDM Process Transformation:

| No. | Key terms and definitions (Schlüsselbegriffe und Definitionen) |
|---|---|
| 1 | Examples for various variants of CPW Enterprise Architecture |
| | Frameworks and external Frameworks |
| 2 | Tree structure of the Enterprise Architecture with Business |
| | Architecture and IT |
| 3 | Area of the IT with Data Model, Application Model and |
| | System Model |
| 4 | Area of the Business Architecture with Information Model, |
| | Business Requirements Model and Business |
| | System Model |
| 5 | Business Case (BC), Specification Case (SC) and |
| | Production Case (PC) |
| 6 | CPW EA Framework with CPW Method Component and |
| | external method components |
| 7 | CPW EA Framework with CPW Method Component, external |
| | method components, CPW Method Transformation |
| | and Transformation |

### 47 CPW ENTERPRISE ARCHITECTURE FRAMEWORKS AND CPW ENTERPRISE ARCHITECTURE ENGINE AS APPLICATION

CPW Enterprise Architecture Framework and CPW Enterprise Architecture Engine as Application

| | Rules, High Level Key Requirements and Functions for the CPW |
|---|---|
| | Enterprise Architecture Framework or the CPW Enterprise |
| No. | Architecture Framework Engine as application |
| 1 | The CPW Enterprise Architecture Engine is the technical |
| | realization of a CPW Enterprise Architecture Framework as |
| | technical system. |
| 2 | Functions of the CPW Enterprise Architecture Framework and of |
| | the CPW Enterprise Architecture Engine |
| | Functions of the CPW Framework |
| 3 | Functions of the CPW Enterprise Architecture Framework and of |
| | the CPW Enterprise Architecture Engine with one to many CPW |
| | Frameworks |
| | Functions of the CPW Enterprise Architecture Framework and of |
| | the CPW Enterprise Architecture Engine with one to many tree |
| | structures of CPW Frameworks |
| | Functions of the CPW Framework with one to many CPW Method |
| | Components |
| 4 | Functionality for all CPW Method Transformations |
| | Functionality for the Function synchronization |
| | The functionality of the synchronization can correspond to a |
| | logical operation like: AND, OR, NOT and their logical |
| | combinations. |
| | Functionality for the setup and the administration of CPW |
| | Frameworks with tree structures |
| 5 | CPW Enterprise Architecture Configuration and CPW Framework |
| | Configuration |
| | Configuration for all CPW Method Transformations |
| | Configuration for the function synchronization |
| | Configuration for the setup and the administration of CPW |
| | Frameworks with tree structures |
| 6 | Configuration for all CPW Method Transformations with the CPW |
| | Enterprise Architecture Configuration and the CPW Framework |
| | Configuration |
| | Which and how the CPW Method Components can be transformed |
| | together manual, automatic, direct or indirect together, can be |
| | configured within a CPW Framework, within of tree structure of |
| | CPW Frameworks, or between two tree structures of CPW |
| | Frameworks, or to external method components over an external |
| | interface. |
| 7 | CPW Sign-off Process for CPW Method Components, CPW |
| | Frameworks and tree structures with CPW Frameworks |
| | Automation of the CPW Sign-off Process within the application |
| | CPW Enterprise Architecture Engine |
| 8 | Application and administration of the functions of the CPW |
| | Enterprise Architecture Engine through the administrator or for the |
| | user with the authorized functions. |
| 9 | Administration of the authorizations for users within of the CPW |
| | Enterprise Architecture Engine through the administrator |
| | Administration of the authorizations for users regarding the |
| | functions within of the CPW Enterprise Architecture Engine |
| | External interface to an user authorization system |
| 10 | External interface to the external method components, which are |
| | assigned to the Business Case, Specification Case and |
| | Production Case, and which again are assigned to a project or |
| | program of an enterprise. |
| | Functionalities of the method transformation between of the CPW |
| | Method Components and the external method components are |
| | possible, which are assigned to the project phases Business |
| | Case, Specification Case and Production Case. |
| | All functionalities of the synchronization are possible to the |
| | external method components, which are assigned to the |
| | Business Case, Specification Case and Production Case. |
| 11 | External interface to the external method components and |
| | external Frameworks of a development process within an |
| | enterprise, in which the projects and programs are assigned to the |
| | project phases Business Case (BC), Specification Case (SC) |
| | and Production Case (PC). |
| 12 | Synchronization of the CPW Sign-off Process of the CPW |
| | Frameworks with the external Sign-off Processes of the external |
| | Frameworks with the project phases Business Case, Specification |
| | Case and Production Case. |
| 13 | External interface to external method components |
| | Functionalities of the method transformation are possible between |
| | of the CPW Method Components and of the external method |
| | components |
| 14 | Functionalities of the synchronization are possible between CPW |
| | Method Components and to the external method components. |
| 15 | An external interface to an external method component can be |
| | assigned to a CPW Method Component or a CPW Framework, or a |
| | tree structure of CPW Frameworks |
| 16 | Interfaces of the application CPW Enterprise Architecture Engine |
| | to external applications with external method components. |
| | Method transformation of CPW Method Components to external |
| | method components over an external interface |
| 17 | Call of an external application with external method components |
| | from the application CPW Enterprise Architecture Framework. |
| | The call of the external method component is assigned to a |
| | CPW Framework. |
| 18 | External interface to: |
| | Enterprise Architecture Tool |
| | UML Tool |
| | Process Tool |
| | Planning Tool |
| | Software Development Tool |
| | Programming Tool |
| | Business Intelligence Tool |
| | Data Warehouse Tool |
| | Data Modeling Tool |
| 19 | External interface to: |
| | Workflow Engine. |
| | The data of the CPW Enterprise Architecture Engine can be |
| | transmitted automatic in Real-time or in periodic time intervals to |
| | the Workflow Engine. |
| 20 | External interface with: |
| | XML |
| | XML Process Definition Language (XPDL) |
| | Web Services (WS) |
| | And other technical methods and protocols |
| 21 | Within of the CPW Enterprise Architecture Engine can be applied |
| | the CPW Method by means of XML, XML Process Definition |
| | Language (XPDL) and Web Services (WS). |
| | The CPW Enterprise Architecture Engine can communicates over |
| | an external interface by means of XML, XML Process Definition |
| | Language (XPDL) and Web Services (WS) the CPW Method to |
| | other Tools and applications. |
| 22 | Within of the CPW Enterprise Architecture Engine can be applied |
| | the CPW Method by means of Business Process Modeling |
| | Notation (BPMN), Business Process Execution Language |
| | (BPEL), Web Services Definition Language (WSDL), Flow |
| | Definition Language (FDL). |
| | The CPW Enterprise Architecture Engine can communicates over |
| | an external interface by means of BPMN, BPEL, WSDL, FDL the |
| | CPW Method to other Tools and applications. |

In FIG. 64 is represented the CPW Enterprise Architecture Framework and CPW Enterprise Architecture Engine with the interface to applications and Tools with the corresponding protocols like for example.: XML, Web Services

| No. | Key terms and definitions (Schlüsselbegriffe und Definitionen) |
|---|---|
| 1 | CPW Enterprise Architecture Framework and CPW Enterprise |
| | Architecture Engine as application |
| 2 | CPW Enterprise Architecture Framework |
| 3 | CPW Enterprise Architecture Engine |
| 4 | CPW Framework |
| 5 | Functions of the CPW Enterprise Architecture Framework and |
| | of the CPW Enterprise Architecture Engine |
| 6 | Functions of the CPW Framework |
| 7 | CPW Enterprise Architecture Configuration and CPW Framework |
| | Configuration |
| 8 | Functionality for all CPW Method Transformations |
| 9 | Configuration for all CPW Method Transformations |
| 10 | All Functionality for the function synchronization |
| 11 | Configuration for the function synchronization |
| 12 | Functionality for the setup of CPW Frameworks with tree |
| | structures. |
| 13 | Configuration for the setup of CPW Frameworks with tree |
| | structures. |
| 14 | CPW Sign-off Process |
| 15 | Administration of the authorizations |
| 16 | External interface to the external method components |

### 48 TECHNICAL SYSTEM DESCRIPTION

CPW Enterprise Architecture Framework and CPW Enterprise Architecture Engine as Application

| | Rules, High Level Key Requirements and Functions for the CPW |
|---|---|
| | Enterprise Architecture Framework or the CPW Enterprise |
| No. | Architecture Framework Engine as application |
| 1 | The CPW Enterprise Architecture Engine is the technical realization of a CPW |
| | Enterprise Architecture Framework as technical system. |
| 2 | The application and realization of the CPW Method in a CPW Enterprise |
| | Architecture Framework |
| 3 | The application and realization of the CPW Method in a CPW Enterprise |
| | Architecture Engine |
| 4 | The application and realization of the CPW Method in a CPW Enterprise |
| | Architecture Tool |
| 5 | The application and realization of the CPW Method in a CPW Workflow |
| | Engine. |
| 6 | The application and realization of the CPW Method in a CPW Process Engine |
| 7 | The application and realization of the CPW Method in a CPW Process Tool |
| 8 | The application and realization of the CPW Method in a Enterprise |
| | Architecture Framework |
| 9 | The application and realization of the CPW Method in a Enterprise |
| | Architecture Engine |
| 10 | The application and realization of the CPW Method in a Enterprise |
| | Architecture Tool |
| 11 | The application and realization of the CPW Method in a Workflow Engine |
| 12 | The application and realization of the CPW Method in a Process Engine |
| 13 | The application and realization of the CPW Method in a Process Tool |
| 14 | The application and realization of the CPW Method in a Workflow Tool |
| 15 | The application and realization of the CPW Method in a Workflow |
| | Management System |
| 16 | The application and realization of the CPW Method in a Business Process |
| | Management System |
| 17 | The application and realization as technical system of the CPW |
| | Method in a CPW Enterprise Architecture Engine as: |
| | Enterprise Architecture Framework |
| | Enterprise Architecture Engine |
| | Enterprise Architecture Tool |
| | Workflow Engine. |
| | Process Engine |
| 18 | The CPW Enterprise Architecture Engine as realized application with |
| | interface to: |
| | Enterprise Architecture Framework |
| | Enterprise Architecture Engine |
| | Enterprise Architecture Tool |
| | Workflow Engine. |
| | Process Engine |
| 19 | The application and realization of the CPW Method by means of |
| | Information Technologies |
| 20 | The CPW Enterprise Architecture Engine with external interface |
| | with XML, XML Process Definition Language (XPDL), Web |
| | Services (WS) and other technical methods, protocols and |
| | technologies |
| 21 | The CPW Enterprise Architecture Engine with external interface |
| | with BPMN, BPEL, WSDL, FDL and other technical methods, |
| | protocols and technologies |
| 22 | The application and realization of the CPW Method by means of |
| | Internet Technologies |
| 23 | The application and realization of the CPW Method by means of |
| | application systems |
| 24 | The application and realization of the CPW Method in an |
| | application system with integrated database. |
| 25 | The application and realization of the CPW Method by means of |
| | Information Technologies |
| 26 | Application of the graphical representation of the method in |
| | technical systems |
| 27 | The CPW Enterprise Architecture Engine with external interface to: |
| | Enterprise Architecture Tool |
| | UML Tool |
| | Process Tool |
| | Planning Tool |
| | Software Development Tool |
| | Programming Tool |
| | Business Intelligence Tool |
| | Data Warehouse Tool |
| | Data Modeling Tool |
| 28 | The CPW Enterprise Architecture Engine with interface to: |
| | Enterprise Architecture Framework |
| | Enterprise Architecture Engine |
| | Enterprise Architecture Tool |
| | Workflow Engine. |
| | Process Engine |
| 29 | The CPW Enterprise Architecture Engine with interface to: |
| | Workflow Engine. |
| | The data of the CPW Enterprise Architecture Engine can be |
| | transmitted automatic in Real-time or in periodic time intervals |
| | to the Workflow Engine. |
| 30 | The CPW Enterprise Architecture Engine with external interface with: |
| | XML |
| | XML Process Definition Language (XPDL) |
| | Web Services (WS) |
| | Business Process Modeling Notation (BPMN) |
| | Business Process Execution Language (BPEL) |
| | Web Services Definition Language (WSDL) |
| | Flow Definition Language (FDL) |
| | And other technical methods and protocols |

| No. | Key terms and definitions (Schlüsselbegriffe und Definitionen) |
|---|---|
| 1 | CPW Enterprise Architecture Framework and CPW Enterprise |
| | Architecture Engine as application |
| 2 | CPW Enterprise Architecture Framework |
| 3 | CPW Enterprise Architecture Engine |
| 4 | CPW Method |

### 49 CPW ENTERPRISE ARCHITECTURE FRAMEWORK FROM SERVICE ORIENTED VIEW

The following table shows the CPW Enterprise Architecture Framework or the CPW Enterprise Architecture Engine from service oriented view:

| | Rules, High Level Key Requirements and Functions for the CPW |
|---|---|
| | Enterprise Architecture Framework or the CPW Enterprise |
| No. | Architecture Framework Engine from service oriented view |
| 1 | The principle of the service awareness and of the service thought is |
| | founded among other things or becomes important, if the things which are |
| | done, are not only for the self purpose, but it is the objective and it follows, |
| | to bring a piece of service or a service for other humans or people or for a |
| | product. To render a good service, it needs service oriented principles. |
| 2 | This means related to the CPW Framework or the CPW Enterprise |
| | Architecture Framework, in what way first of all in the CPW Diagnostic |
| | Assessment under the aspect of the Evaluation Criteria the Business |
| | Objectives or the business goals are aligned? That means, in what way |
| | are aligned the Business Objectives or the business goals as service |
| | oriented business objectives? |
| 3 | Then the service oriented thinking and acting affects to the application of |
| | all CPW Method Components, and to the application of the CPW |
| | Framework, or overall to the application of the CPW Enterprise Architecture |
| | Framework or the CPW Enterprise Architecture Engine with all given functions. |
| 4 | Is the service described through the CPW Process or CPW Workflow, so is |
| | described every Service Step through a CPW Process Step with CPW |
| | Subject, CPW Predicate and CPW Object and consequently is every |
| | Service Step through the CPW Process Step in relationship to a |
| | responsibility through the CPW Subject. |
| 5 | Especially the Service can be described through the application of the |
| | CPW Process, CPW Workflow and CPW Dialog in this manner, where the |
| | Business Process or the to-be-described Service is integrated into a |
| | sociocultural context. |
| 6 | The needs or the requirements for a Service can stay for a time, but they |
| | can also change dynamically or be valid only for a moment. |
| 7 | In what way a service oriented architecture or a service oriented |
| | Framework is successful, depends also on, among others, in what way |
| | the people, which want to bring the service with the service oriented |
| | architecture and the service oriented Framework, can react on the |
| | dynamic situation of the to-be-changed service, then also to bring the right |
| | service at the right time according to the service requirements. For |
| | example may change the needs of the clients from one moment to the |
| | other moment. |
| 8 | With the application of the CPW Framework, the CPW Enterprise |
| | Architecture Framework and the CPW Enterprise Architecture Engine can |
| | be built a service oriented architecture. |
| 9 | The CPW Framework, the CPW Enterprise Architecture Framework and |
| | the CPW Enterprise Architecture Engine can be regarded with their |
| | application as service oriented Framework, with which can be reacted on |
| | dynamic changes of the services. It is the service oriented CPW |
| | Enterprise Architecture Framework as service oriented Framework. |

| No. | Key terms and definitions (Schlüsselbegriffe und Definitionen) |
|---|---|
| 1 | CPW Enterprise Architecture Framework |
| 2 | CPW Enterprise Architecture Engine |
| 3 | service oriented business objectives |
| 4 | Service Step |
| 5 | CPW Process Step |
| 6 | service oriented view |
| 7 | service oriented principles |
| 8 | service oriented architecture |
| 9 | service oriented Framework |
| 10 | service oriented CPW Enterprise Architecture Framework |

### 50 FURTHER VARIANTS AND EXAMPLES

The following table shows variants and examples of the High Level Key Requirements and functions for the CPW Enterprise Architecture Framework or the CPW Enterprise Architecture Engine.

| | Further variants and examples of the High Level Key Requirements |
|---|---|
| | and functions for the CPW Enterprise Architecture Framework or the |
| No. | CPW Enterprise Architecture Engine. |
| 1 | Functions of the CPW Enterprise Architecture Frameworks or the CPW |
| | Enterprise Architecture Engine regarding the function of the |
| | synchronization and CPW Method Transformation to the external |
| | interface of projects and programs with Business Case (BC), |
| | Specification Case (SC), Production Case (PC) |
| 2 | Functions of the CPW Enterprise Architecture Frameworks or the CPW |
| | Enterprise Architecture Engine regarding the function of the |
| | synchronization and CPW Method Transformation to the external |
| | interface with external tools and applications. |
| 3 | Functions of the CPW Enterprise Architecture Frameworks or the CPW |
| | Enterprise Architecture Engine regarding the function of the |
| | synchronization and CPW Method Transformation to the external |
| | interface with external tools and applications with various technical |
| | methods and protocols like for example XML, XML Process Definition Language |
| | (XPDL), Web Services (WS). |
| 4 | Functions of the CPW Enterprise Architecture Frameworks or the CPW |
| | Enterprise Architecture Engine regarding the function of the |
| | synchronization and CPW Method Transformation to the external |
| | interface with external tools and applications with various technical |
| | methods and protocols like for example Business Process Modeling |
| | Notation (BPMN), Business Process Execution Language (BPEL), |
| | Web Services Definition Language (WSDL), Flow Definition |
| | Language (FDL). |
| 5 | Functions of the CPW Enterprise Architecture Framework or the CPW |
| | Enterprise Architecture Engine with the tree structure of CPW |
| | Frameworks, at which the tree structure at the area Enterprise |
| | Architecture is subdivided into the area Business Architecture and IT. |
| | The area Business Architecture is divided into the areas Information |
| | Model, Business Requirements and Business System. The area IT is |
| | divided into the areas Data Model, Application Model and |
| | System Model. Within the CPW Enterprise Architecture Frameworks or the CPW |
| | Enterprise Architecture Engine are possible the functions |
| | synchronization and CPW Method Transformations between the CPW |
| | Frameworks Business Architecture and IT within the tree structure. |
| 6 | The CPW Enterprise Architecture Engine Configuration with the |
| | configuration possibilities of the CPW Method Components within the |
| | CPW Frameworks, of the CPW Enterprise Architecture Framework and |
| | of the CPW Enterprise Architecture Engine |
| 7 | the function synchronization between Business Case (BC), |
| | Specification Case (SC) and Production Case (PC) and the CPW |
| | Frameworks of the CPW Enterprise Architecture Framework |
| | the CPW Enterprise Architecture Framework with the CPW |
| | Frameworks applied as Enterprise Architecture Framework |
| | the CPW Enterprise Architecture Framework with a tree structure of |
| | CPW Frameworks with the areas Data Model, Application Model |
| | and System Model applied as Enterprise Architecture Framework |
| | or as Enterprise Architecture Engine with the areas Data Model, |
| | Application Model and System Model. |
| | the CPW Enterprise Architecture Engine with a tree structure of |
| | CPW Frameworks with the areas Data Model, Application Model and |
| | System Model |
| | the CPW Enterprise Architecture Engine with a tree structure of CPW |
| | Frameworks with the areas Information Model, Business |
| | Requirements Model and Business System Model. |
| | the CPW Enterprise Architecture Engine with a tree structure of CPW |
| | Frameworks with the areas Data Model, Application Model and |
| | System Model. The CPW Frameworks are each assigned the |
| | corresponding CPW Method Components. The possible CPW |
| | Method Transformations between the various CPW Method |
| | Components are configurable. The function of the synchronization |
| | between the CPW Frameworks and CPW Method Components is |
| | furthermore configurable. |
| | the CPW Method applied as Enterprise Architecture Framework or |
| | as Enterprise Architecture Engine with the areas Data Model, |
| | Application Model and System Model. |
| 8 | The application of the CPW Enterprise Architecture Framework and of |
| | the CPW Enterprise Architecture Engine can also be named as |
| | Enterprise Architecture Modeling or Business Architecture |
| | Modeling. |
| 9 | The application of the CPW Enterprise Architecture Framework and |
| | the CPW Enterprise Architecture Engine with the tree structure of CPW |
| | Frameworks with the areas Data Model, Application Model and |
| | System Model. The areas Data Model, Application Model and System |
| | Model are again assigned the CPW Frameworks in the project phases |
| | Business Case (BC), Specification Case (SC), and Production Case |
| | (PC). |
| | In the application of the CPW Enterprise Architecture Framework |
| | and the CPW Enterprise Architecture Engine the created CPW |
| | Frameworks within the tree structure with the areas Data Model, |
| | Application Model and System Model are assigned the CPW |
| | Method Components. |
| | In the application of the CPW Enterprise Architecture Framework |
| | and the CPW Enterprise Architecture Engine the created CPW |
| | Frameworks within the tree structure with the areas Data Model, |
| | Application Model and System Model are assigned the CPW Method |
| | Components CPW Plan, CPW Context Diagram and CPW Process. |
| | In the application of the CPW Enterprise Architecture Framework |
| | and the CPW Enterprise Architecture Engine the created CPW |
| | Frameworks within the tree structure with the areas Data Model, |
| | Application Model and System Model are assigned the CPW |
| | Method Components and external method components. |
| | In the application of the CPW Enterprise Architecture Framework and |
| | the CPW Enterprise Architecture Engine the created CPW Frameworks |
| | within the tree structure with the areas Data Model, Application |
| | Model and System Model are assigned the CPW Method |
| | Components CPW Process and CPW Context Diagram, and the |
| | external method components UML Method, Business Data Model |
| | (BDM), Logical Data Model (LDM), Physical Data Model (PDM) |
| | are assigned to the CPW Frameworks, and the external method |
| | components to the areas database, programs, network and |
| | system are assigned to the CPW Frameworks. To the created CPW |
| | Frameworks are also assigned the functions of the synchronization |
| | and the CPW Method Transformations. Especially at the example of |
| | the method transformation CPW Context Diagram BDM |
| | Transformation and the method transformation of CPW Process to |
| | UML Activity Diagrams. |
| | In the application of the CPW Enterprise Architecture Framework and |
| | the CPW Enterprise Architecture Engine the created CPW Frameworks |
| | within the tree structure with the areas Data Model, Application |
| | Model and System Model are assigned the CPW Method |
| | Components CPW Process and CPW Context Diagram, and the |
| | external method components UML Method, Business Data Model |
| | (BDM), Logical Data Model (LDM), Physical Data Model (PDM) are |
| | assigned to the CPW Frameworks, and the external method |
| | components to the areas database, programs, network and system are |
| | assigned to the CPW Frameworks. To the created CPW Frameworks |
| | are also assigned the functions of the synchronization and the CPW |
| | Method Transformations. Especially at the example of the method |
| | transformation CPW Context Diagram BDM Transformation and the |
| | method transformation of CPW Process to UML Activity Diagrams, and |
| | the CPW BDM Process Transformation. |
| 10 | the CPW Enterprise Architecture Engine with a tree structure of CPW |
| | Frameworks with the areas Data Model, Application Model and |
| | System Model. |
| | the CPW Enterprise Architecture Engine with a tree structure of CPW |
| | Frameworks with the areas Information Model, Business |
| | Requirements Model and Business System Model. |
| 11 | The CPW Enterprise Architecture Engine with a tree structure of CPW |
| | Frameworks with the areas Information Model, Business |
| | Requirements Model and Business System Model. The particular |
| | CPW Frameworks are each assigned one to many CPW Method |
| | Components and overall in the tree structure of the CPW Frameworks |
| | is possible a configuration and application of the CPW Method |
| | Transformations and the function of the synchronization. |
| | The CPW Enterprise Architecture Engine with a tree structure of CPW |
| | Frameworks with the areas Data Model, Application Model and |
| | System Model. The particular CPW Frameworks are each assigned |
| | one to many CPW Method Components and overall in the tree |
| | structure of the CPW Frameworks is possible a configuration and |
| | application of the CPW Method Transformations and the function |
| | of the synchronization. |
| 12 | The CPW Enterprise Architecture Engine with a tree structure of CPW |
| | Frameworks with the areas Information Model, Business |
| | Requirements Model and Business System Model. The particular |
| | CPW Frameworks are assigned following CPW Method Components: |
| | CPW Diagnostic Assessment |
| | CPW Change Management |
| | CPW Functional Requirements |
| | CPW Plan |
| | CPW Process |
| | CPW Context Diagram |
| | CPW Functional Diagram |
| | CPW Business System Description |
| | Overall in the tree structure of the CPW Frameworks is possible a |
| | configuration and application of the CPW Method Transformations and |
| | the function of the synchronization. |
| 13 | The CPW Enterprise Architecture Engine with a tree structure of CPW |
| | Frameworks with the areas Data Model, Application Model and |
| | System Model. The particular CPW Frameworks are assigned |
| | following CPW Method Components: |
| | CPW Diagnostic Assessment |
| | CPW Change Management |
| | CPW Functional Requirements |
| | CPW Plan |
| | CPW Process |
| | CPW Context Diagram |
| | CPW Functional Diagram |
| | CPW Business System Description |
| | Overall in the tree structure of the CPW Frameworks is possible a |
| | configuration and application of the CPW Method Transformations and |
| | the function of the synchronization. |
| 14 | The CPW Enterprise Architecture Engine with a tree structure of CPW |
| | Frameworks with the areas Information Model, Business |
| | Requirements Model and Business System Model. The particular |
| | CPW Frameworks are each assigned a combination of one to many |
| | CPW Method Components and overall in the tree structure of the CPW |
| | Frameworks is possible a configuration and application of the CPW |
| | Method Transformations and the function of the synchronization. |
| | The CPW Enterprise Architecture Engine with a tree structure of CPW |
| | Frameworks with the areas Data Model, Application Model and |
| | System Model. The particular CPW Frameworks are each assigned a |
| | combination of one to many CPW Method Components and overall in |
| | the tree structure of the CPW Frameworks is possible a configuration |
| | and application of the CPW Method Transformations and the |

### 51 DICTIONARY

### 51.1 TERMS FOR THE CPW METHOD, EXTENSIONS OF THE CPW METHOD AND CPW METHOD COMPONENT

| No. | English | German |
|---|---|---|
| 1 | Cognitive Process Workflow (CPW) | Kognitiver Prozess Workflow (CPW) |
| | Method | Methode |
| 2 | CPW Method | CPW Methode |
| 3 | CPW Overall Method | CPW Gesamtmethode |
| 4 | CPW Process | CPW Prozess |
| 5 | CPW Process Step | CPW Prozessschritt, CPW Prozess |
| | | Schritt |
| 6 | CPW Process Step Number | CPW Prozessschritt Nummer |
| 7 | CPW Subject | CPW Subjekt |
| 8 | CPW Subject Relationships | CPW Subjekt Beziehungen |
| 9 | CPW Subject Subject Relationships | CPW Subjekt Subjekt Beziehungen |
| 10 | CPW Subsubject | CPW Subsubjekt |
| 11 | CPW Predicate | CPW Prädikat |
| 12 | CPW Object | CPW Objekt |
| 13 | CPW Object Relationships | CPW Objekt Beziehungen |
| 14 | CPW Subobject | CPW Subobjekt |
| 15 | CPW Subject Predicate Object | CPW Subjekt Prädikat Objekt |
| | Relationships | Beziehungen |
| 16 | CPW Dialog | CPW Dialog |
| 17 | CPW Workflow | CPW Workflow |
| 18 | CPW Context Diagram | CPW Kontext Diagramm |
| 19 | CPW Subject Context Diagram | CPW Subjekt Kontext Diagramm |
| 20 | CPW Object Context Diagram | CPW Objekt Kontext Diagramm |
| 21 | CPW Subject Object Context | CPW Subjekt Objekt Kontext Diagramm |
| | Diagram | |
| 22 | CPW Subject Object Relationships | CPW Subjekt Objekt Beziehungen |
| 23 | CPW Subject Object Relationship | CPW Subjekt Objekt Beziehungs |
| | Diagram | Diagramm |
| 24 | CPW Process 2d | CPW Prozess 2d |
| 25 | CPW Workflow 2d | CPW Workflow 2d |
| 26 | CPW Dialog 2d | CPW Dialog 2d |
| 27 | CPW Context Diagram 2d | CPW Kontext Diagramm 2d |
| 28 | CPW Object Context Diagram 2d | CPW Objekt Kontext Diagramm 2d |
| 29 | CPW Subject Context Diagram 2d | CPW Subjekt Kontext Diagramm 2d |
| 30 | CPW Subject Object Context | CPW Subjekt Objekt Kontext Diagramm |
| | Diagram 2d | 2d |
| 31 | CPW Enterprise Architecture | CPW Enterprise Architektur |
| | Framework | Framework |
| 32 | CPW Enterprise Architecture | CPW Enterprise Architektur |
| | Frameworks | Frameworks |
| 33 | CPW Enterprise Architecture | CPW Enterprise Architektur Engine |
| | Engine | |
| 34 | CPW Framework | CPW Framework |
| 35 | CPW Parent Framework | CPW Eltern Framework |
| 36 | CPW Child Framework | CPW Kind Framework |
| 37 | CPW Framework Configuration | CPW Framework Konfiguration |
| 38 | CPW Enterprise Architecture Engine | CPW Enterprise Architecture Engine |
| | Configuration. | Konfiguration |
| 39 | CPW Method Component | CPW Methodenkomponente |
| 40 | CPW Method Component Instance | CPW Methodenkomponenten Instanz |
| 41 | CPW DA | CPW DA |
| | (CPW Diagnostic Assessment) | (CPW Diagnostik Assessment) |
| 42 | CPW Diagnostic Assessment | CPW Diagnostic Assessment |
| | | CPW Diagnostik Beurteilung |
| | | CPW Diagnostik Bewertung |
| 43 | CPW Diagnostic Assessment Result | CPW Diagnostik Assessment Ergebnis |
| | (CPW DA Result) | (CPW DA Ergebnis) |
| 44 | CPW Expert Concept | CPW Experten Konzept |
| 45 | CPW CM | CPW CM |
| | (CPW Change Management) | (CPW Change Management) |
| 46 | CPW Change Request | CPW Change Request |
| 47 | CPW Functional Model | CPW Funktions Model |
| 48 | CPW Functional Diagram | CPW Funktions Diagramm |
| 49 | CPW Function | CPW Funktion |
| 50 | CPW Subfunction | CPW Subfunktion |
| 51 | CPW Functional Requirements | CPW Funktions Anforderungen |
| 52 | CPW Plan | CPW Plan |
| 53 | CPW Sign-off Process | CPW Sign-off Prozess |
| 54 | CPW Object Flow Context Diagram | CPW Objekt Fluss Kontext Diagramm |
| 55 | CPW Object Flow | CPW Objekt Fluss |
| 56 | CPW Object Flow Step | CPW Objekt Fluss Schritt |
| 57 | CPW Object Flow Directional Arrows | CPW Objekt Fluss Richtungspfeile |
| 58 | CPW Subject Object Flow Context | CPW Subjekt Objekt Fluss Kontext |
| | Diagram | Diagramm |
| 59 | CPW Subject Object Flow | CPW Subjekt Objekt Fluss |
| 60 | CPW Subject Object Process Flow | CPW Subjekt Objekt Prozess Fluss |
| | Context Diagram | Kontext Diagramm |
| 61 | CPW Business System Description | CPW Business System Beschreibung |
| | (CPW BS Description) | (CPW BS Beschreibung) |
| 62 | CPW Method Component Table | CPW Methodenkomponenten Table |
| 63 | CPW Change Management Table | CPW Change Management Tabelle |
| 64 | CPW Functional Requirements | CPW Funktions Anforderungs Tabelle |
| | Table | |
| 65 | CPW Plan Table | CPW Plan Tabelle |
| 66 | CPW Process Table | CPW Prozess Tabelle |
| 67 | CPW Workflow Table | CPW Workflow Tabelle |
| 68 | CPW Object Flow Table | CPW Objekt Fluss Tabelle |
| 69 | CPW Subject Object Process Flow | CPW Subjekt Objekt Prozess Fluss |
| | Table | Tabelle |
| 70 | CPW Triangle | CPW Dreieck |

### 51.2 FURTHER TERMS FOR THE CPW METHOD, EXTENSIONS OF THE CPW METHOD AND CPW METHOD COMPONENT

| No. | English | German |
|---|---|---|
| 1 | Method Extensions of the CPW | Methodenerweiterungen des CPW |
| | Process | Prozesses |
| 2 | Method Extensions of the CPW | Methodenerweiterungen des CPW |
| | Dialog | Dialogs |
| 3 | CPW Process with Swimlanes | CPW Prozess mit Swimlanes |
| | | (Schwimmbahnen) |
| 4 | CPW Workflow with Swimlanes | CPW Workflow mit Swimlanes |
| | | (Schwimmbahnen) |
| 5 | CPW Dialog with Swimlanes | CPW Dialog mit Swimlanes |
| | | (Schwimmbahnen) |
| 6 | CPW Dialog with Direct Speech | CPW Dialog mit Direkte Rede |
| 7 | CPW Dialog with Reported Speech | CPW Dialog mit Indirekte Rede |
| 8 | CPW Process synchronized with the | CPW Process synchronisiert mit dem |
| | CPW Functional Diagram | CPW Functional Diagram |
| 9 | Extraction of the CPW Process or of | Extrahieren des CPW Process oder des |
| | the CPW Workflow from the CPW | CPW Workflow aus dem CPW Dialog |
| | Dialog | |
| 10 | directional arrows of the CPW Object | Richtungspfeile des CPW Object Flow |
| | Flow Context Diagram | Context Diagram |
| 11 | directional arrows between the CPW | Richtungspfeile zwischen den CPW |
| | Object Relationships | Objekt Beziehungen |
| 12 | Start point of the CPW Object Flow | Startpunkt des CPW Object Flow |
| 13 | End point of the CPW Object Flow | Endpunkt des CPW Object Flow |
| 14 | Start point and end points of the | Startpunkt und Endpunkte des CPW |
| | CPW Subject Object Process Flow | Subject Object Process Flow Context |
| | Context Diagram | Diagram |
| 15 | Current CPW Object Flow Step | Aktueller CPW Object Flow Step |
| 16 | Next CPW Object Flow Step | Nächster CPW Object Flow Step |
| 17 | CPW Workflow synchronized with | CPW Workflow synchronisiert mit dem |
| | the CPW Functional Diagram | CPW Functional Diagram |
| 18 | CPW Parent Framework in a tree | CPW Parent Framework in einer |
| | structure | Baumstruktur |
| 19 | CPW Child Frameworks in a tree | CPW Child Frameworks in einer |
| | structure | Baumstruktur |
| 20 | Conjunction of CPW Method | Verknüpfung von CPW Method |
| | Components | Components |
| 21 | Conjunction of CPW Method | Verknüpfung von CPW Method |
| | Components within a CPW | Components innerhalb eines CPW |
| | Framework | Frameworks |
| 22 | CPW Enterprise Architecture | CPW Enterprise Architecture |
| | Framework with the Function | Framework mit der Funktion |
| | synchronization | Synchronisation |
| 23 | Manual Synchronization of CPW | manuelle Synchronisation von CPW |
| | Frameworks | Frameworks |
| 24 | Automatic Synchronization of CPW | automatische Synchronisation von CPW |
| | Frameworks | Frameworks |
| 25 | Manual Synchronization of two CPW | manuelle Synchronisation zweier CPW |
| | Frameworks | Frameworks |
| 26 | Automatic Synchronization of two | automatische Synchronisation zweier |
| | CPW Frameworks | CPW Frameworks |
| 27 | Attributes of the CPW Method | Attribute der CPW Methoden |
| | Component Table | Komponente Tabelle |
| 28 | Records of the CPW Method | Records der CPW Methoden |
| | Component Table | Komponente Tabelle |
| 29 | directional arrow between two CPW | Richtungspfeil zwischen zwei CPW |
| | Method Components | Method Components |

### 51.3 TERMS FOR CPW ENTERPRISE ARCHITECTURE FRAMEWORK AND CPW ENTERPRISE ARCHITECTURE ENGINE

| No. | English | German |
|---|---|---|
| 1 | Functions of the CPW Enterprise | Funktionen des CPW Enterprise |
| | Architecture Framework | Architecture Framework Funktionen der |
| | Functions of the CPW Enterprise | CPW Enterprise Architecture Engine |
| | Architecture Engine | |
| 2 | CPW EA Framework with CPW | CPW EA Framework mit CPW Method |
| | Method Component | Component und externen |
| | and external method components | Methodenkomponenten |
| 3 | CPW EA Framework with CPW | CPW EA Framework mit CPW Method |
| | Method Component, | Component, externen |
| | external method components, CPW | Methodenkomponenten, CPW Method |
| | Method Transformation and Method | Transformation und |
| | Transformation | Methodentransformation |
| 4 | Functions of the CPW Framework | Funktionen des CPW Framework |
| 5 | A hierarchical tree structure of CPW | Eine hierarchische Baumstruktur von |
| | Frameworks | den CPW Frameworks |
| 6 | A tree structure of CPW Frameworks | Eine Baumstruktur von CPW |
| | | Frameworks |
| 7 | CPW Enterprise Architecture Engine | CPW Enterprise Architecture Engine |
| | with external interface | mit externer Schnittstelle |
| 8 | CPW Enterprise Architecture | CPW Enterprise Architecture |
| | Framework Engine with the function | Framework Engine für die Funktion |
| | synchronization | Synchronisation |
| 9 | Function Synchronization for the | Funktion Synchronisation für die CPW |
| | CPW Framework | Framework |
| 10 | Synchronization of external Method | Synchronisation von externen |
| | Components with internal CPW | Methodenkomponenten mit internen |
| | Method Components by means of | CPW Methodenkomponenten mittels |
| | external interface | externer Schnittstelle |
| 11 | Manual or automatic synchronization | manuelle oder automatische |
| | of two equal CPW Method | Synchronisation zweier gleichen CPW |
| | Components from two different CPW | Methodenkomponenten aus zwei |
| | Frameworks | unterschiedlichen CPW Frameworks |
| 12 | Manual or automatic | manuelle oder automatische |
| | Synchronization of two CPW | Synchronisation zweier CPW |
| | Frameworks | Frameworks |
| 13 | Synchronization of CPW Method | Synchronisation von CPW |
| | Components between CPW Parent | Methodenkomponenten zwischen CPW |
| | Framework and CPW Child | Parent Framework und CPW Child |
| | Frameworks in a tree structure | Frameworks in einer Baumstruktur. |
| 14 | Synchronization of two CPW Method | Synchronisation zweier CPW |
| | Components with a logic operation. | Methodenkomponenten mit einer |
| | | logischen Verknüpfung. |
| 15 | Synchronization of two CPW | Synchronisation zweier CPW |
| | Frameworks with a logic operation. | Frameworks mit einer logischen |
| | | Verknüpfung. |
| 16 | Synchronization of two CPW | Synchronisation zweier CPW |
| | Frameworks with a logic operation | Frameworks mit einer logischen |
| | within a tree structure. | Verknüpfung innerhalb einer |
| | | Baumstruktur. |
| 17 | Synchronization of CPW | Synchronisation von CPW Frameworks |
| | Frameworks with a logic operation | mit einer logischen Verknüpfung aus |
| | from two various tree structures. | zwei verschiedenen Baumstrukturen |
| 18 | Distribution of CPW Method | Verteilen von CPW |
| | Components Instances | Methodenkomponenten Instanzen |
| 19 | CPW Enterprise Architecture | CPW Enterprise Architecture |
| | Framework with tree structure | Framework mit Baumstruktur |
| 20 | The tree structure of the area | Die Baumstruktur des Bereichs |
| | Enterprise Architecture is subdivided | Enterprise Architecture teilt sich auf in |
| | into the area Business Architecture | den Bereich Business Architecture und |
| | and IT | IT |
| 21 | Examples for various variants of | Beispiele für verschiedene Varianten |
| | CPW Enterprise Architecture | von CPW Enterprise Architecture |
| | Frameworks and external | Frameworks und externen Frameworks |
| | Frameworks | |
| 22 | Tree structure of the Enterprise | Baumstruktur der Enterprise |
| | Architecture with Business | Architecture mit Business Architecture |
| | Architecture and IT | und IT |
| 23 | Area of the IT with Data Model, | Bereich der IT mit Data Model, |
| | Application Model and System | Application Model und System Model |
| | Model | |
| 24 | Area of the Business Architecture | Bereich der Business Architecture mit |
| | with Information Model, Business | Information Model, Business |
| | Requirements Model and Business | Requirements Model und Business |
| | System Model | System Model |
| 25 | CPW Enterprise Architecture | CPW Enterprise Architecture |
| | Framework and CPW Enterprise | Framework und CPW Enterprise |
| | Architecture Engine as application | Architecture Engine als Applikation |
| 26 | Functionality for all CPW Method | Funktionalitat für alle CPW Method |
| | Transformations | Transformations |
| 27 | Configuration for all CPW Method | Konfiguration für alle CPW Method |
| | Transformations | Transformations |
| 28 | All Functionality for the function | Alle Funktionalität für die Funktion |
| | synchronization | Synchronisation |
| 29 | Configuration for the function | Konfiguration für die Funktion |
| | synchronization | Synchronisation |
| 30 | Functionality for the setup of CPW | Funktionalität für den Aufbau von CPW |
| | Frameworks with tree structures | Frameworks mit Baumstrukturen. |
| 31 | Configuration for the setup of CPW | Konfiguration für den Aufbau von CPW |
| | Frameworks with tree structures | Frameworks mit Baumstrukturen. |
| 32 | External interface to the external | Externe Schnittstelle zu den externen |
| | Method components | Methodenkomponenten |
| 33 | CPW Enterprise Architecture | CPW Enterprise Architecture |
| | Framework and CPW Enterprise | Framework und CPW Enterprise |
| | Architecture Framework Engine with | Architecture Framework Engine mit der |
| | the function security | Funktion Sicherheit |
| 34 | Permissions of corresponding | Berechtigungen von entsprechenden |
| | persons or organizational units | Personen oder organisatorischen |
| | | Einheiten |
| 35 | Authorization of corresponding | Autorisierung von entsprechenden |
| | persons or organizational units | Personen oder organisatorischen |
| | | Einheiten |
| 36 | Administration of the authorizations | Verwaltung der Berechtigungen |
| 37 | Service oriented CPW Enterprise | service orientierter CPW Enterprise |
| | Architecture Framework | Architecture Framework |

### 51.4 TERMS FOR CPW METHOD TRANSFORMATION

| No. | English | German |
|---|---|---|
| 1 | CPW Method Transformation | CPW Methodentransformation |
| 2 | CPW Method Transformation | CPW Methodentransformation |
| | Relationship | Beziehung |
| 3 | Method Transformation | Methodentransformation |
| 4 | Variant A Method Transformation of | Variante A Methodentransformation von |
| | CPW Object Context Diagram | CPW Objekt Kontext Diagramm |
| | Process Transformation | Prozess Transformation |
| 5 | Variant B Method Transformation of | Variante B Methodentransformation von |
| | CPW Subject Object Context | CPW Subjekt Objekt Kontext Diagramm |
| | Diagram Process Transformation | Prozess Transformation |
| 6 | Variant C Method Transformation of | Variante C Methodentransformation von |
| | CPW Object Context Diagram | CPW Objekt Kontext Diagramm |
| | Process Transformation | Prozess Transformation |
| 7 | Variants A, B, C Method | Varianten A, B, C |
| | Transformation of the CPW Context | Methodentransformation von der CPW |
| | Diagram Process Transformation | Kontext Diagramm Prozess |
| | | Transformation |
| 8 | CPW DA Change Management | CPW DA Change Management |
| | Transformation | Transformation |
| | (CPW Diagnostic Assessment | (CPW Diagnostic Assessment Change |
| | Change Management | Management Transformation) |
| | Transformation) | |
| 9 | CPW Change Management Plan | CPW Change Management Plan |
| | Transformation | Transformation |
| 10 | CPW Change Management Process | CPW Change Management Prozess |
| | Transformation | Transformation |
| 11 | CPW Change Management | CPW Change Management Funktions |
| | Functional Requirements | Anforderungen Transformation |
| | Transformation | (CPW Change Management FR |
| | (CPW Change Management FR | Transformation) |
| | Transformation) | |
| 12 | CPW Process Plan Transformation | CPW Prozess Plan Transformation |
| 13 | CPW Plan Process Transformation | CPW Plan Prozess Transformation |
| 14 | CPW Functional Requirements | CPW Funktions Anforderungen |
| | Functional Diagram Transformation | Funktions Diagramm Transformation |
| | (CPW Functional Requirements FD | (CPW Functional Requirements FD |
| | Transformation) | Transformation) |
| | (CPW FR FD Transformation) | (CPW FR FD Transformation) |
| 15 | CPW Functional Requirements | CPW Funktions Anforderungen Kontext |
| | Context Diagram Transformation | Diagramm Transformation |
| 16 | CPW Functional Requirements | CPW Funktions Anforderungen Prozess |
| | Process Transformation | Transformation |
| 17 | CPW Functional Requirements Plan | CPW Funktions Anforderungen Plan |
| | Transformation | Transformation |
| 18 | CPW Functional Diagram Context | CPW Funktions Diagramm Kontext |
| | Diagram Transformation | Diagramm Transformation |
| 19 | CPW Functional Diagram Subject | CPW Funktions Diagramm Subjekt |
| | Object Context Diagram | Objekt Kontext Diagramm |
| | Transformation | Transformation |
| 20 | CPW Functional Diagram Object | CPW Funktions Diagramm Objekt |
| | Context Diagram Transformation | Kontext Diagramm Transformation |
| 21 | CPW Functional Diagram Object | CPW Funktions Diagramm Objekt Fluss |
| | Flow Context Diagram | Kontext Diagramm Transformation |
| | Transformation | |
| 22 | CPW Context Diagram Subject | CPW Context Diagram Subject Object |
| | Object Relationship Diagram | Relationship Diagram Transformation |
| | Transformation | |
| 23 | CPW Object Context Diagram | CPW Objekt Kontext Diagramm |
| | Process Transformation | Prozess Transformation |

### 51.5 CPW METHOD TRANSFORMATION

| No. | English | German |
|---|---|---|
| 1 | unique key at the CPW Method | eindeutiger Key bei der CPW |
| | Transformation | Methoden Transformation |
| 2 | direct CPW Method | direkte CPW |
| | Transformation | Methodentransformation |
| 3 | Indirect CPW Method | indirekte CPW |
| | Transformation | Methodentransformation |
| 4 | Manual CPW Method | manuelle CPW |
| | Transformation | Methodentransformation |
| 5 | Automatic CPW Method | automatische CPW |
| | Transformation | Methodentransformation |
| 6 | Automatic direct CPW Method | automatische direkte CPW |
| | Transformation | Methodentransformation |
| 7 | Automatic indirect CPW Method | automatische indirekte CPW |
| | Transformation | Methodentransformation |

### 51.6 METHOD TRANSFORMATION BETWEEN CPW METHOD COMPONENT AND EXTERNAL METHOD COMPONENT

| No. | English | German |
|---|---|---|
| 1 | Transformation | Transformation |
| 2 | Method Transformation | Methodentransformation |
| 3 | Method Transformation of the CPW | Methodentransformation von CPW |
| | Process in a UML Activity Diagram | Process in ein UML Activity Diagram |
| 4 | Method Transformation of the CPW | Methodentransformation von CPW |
| | Process in a BPMN Business | Process in ein BPMN Business Process |
| | Process Diagram (BPD) | Diagram (BPD) |
| 5 | CPW Context Diagram BDM | CPW Kontext Diagramm BDM |
| | Transformation | Transformation |
| 6 | Method transformation of BDM/ | Methodentransformation von BDM/ |
| | ERD to CPW Subject Object Context | ERD zu CPW Subjekt Objekt Kontext |
| | Diagram | Diagramme |
| 7 | Method transformation of BDM/ | Methodentransformation von BDM/ |
| | ERD to CPW Subject Object | ERD zu CPW Subjekt Objekt |
| | Relationship Diagram | Beziehungs Diagramme |
| 8 | CPW BDM Process Transformation | CPW BDM Prozess Transformation |
| 9 | Method transformation of an Entity | Methodentransformation von einem |
| | Relationship Diagram to a CPW | Entity Relationship Diagram zu einem |
| | Process or CPW Workflow | CPW Prozess oder CPW Workflow |

### 51.7 BUSINESS AREAS

| Nr. | English | Deutsch |
|---|---|---|
| 1 | Financial Services | Finanzdienstleistungen |
| 2 | Banking | Bankwesen |
| 3 | Insurance Industry | Versicherung |
| 4 | Financial Accounting and Auditing | Wirtschaftsprüfung |
| 5 | Chemistry | Chemie |
| 6 | Pharmacy | Pharmazie |
| 7 | Medicine | Medizin |
| 8 | Transportation and shipping | Transport- und Verkehrswesen |
| 9 | Travel | Reisewesen |
| 10 | Film Industry | Filmindustrie |
| 11 | Politics | Politik |
| 12 | Psychology | Psychologie |
| 13 | Legal Practice, Jurisprudence, | Jura, Rechtswissenschaft und |
| | Judiciary | Rechtswesen |
| 14 | CRM Customer Relationship | CRM Customer Relationship |
| | Management | Management |
| 15 | ERP Enterprise Resource Planning | ERP Enterprise Resource |
| | | Planning |
| 16 | SCM Supply Chain Management | SCM Supply Chain Management |
| 17 | E-Business Integration | E-Business Integration |

### 51.8 FURTHER TERMS

| No. | English | German |
|---|---|---|
| 1 | Dictionary | Wörterbuch |
| 2 | sociocultural dialog | soziokulturelle Dialog |
| 3 | active simple sentence | aktiver einfacher Satz |
| 4 | passive simple sentence | passiver einfacher Satz |
| 5 | Direct Speech | Direkte Rede |
| 6 | Reported Speech | Indirekte Rede |
| 7 | Subject | Subjekt |
| 8 | Predicate | Prädikat |
| 9 | Object | Objekt |

### 51.9 FURTHER TERMS

| No. | English | German |
|---|---|---|
| 1 | Figure | Abbildung |
| 2 | Fig. (figure) | Abb. (Abbildung) |
| 3 | No., no. (number) | Nr. (Nummer) |

### 51.10 FURTHER TERMS

| No. | English | German |
|---|---|---|
| 1 | External Method Component | externe Methodenkomponente |
| 2 | external method component | Externe Methodenkomponente |
| 3 | UML Activity Diagram | UML Activity Diagram |
| 4 | UML Activity Diagram with | UML Activity Diagram mit Swimlanes |
| | swimlanes | |
| 5 | BPMN Business Process Diagram | BPMN Business Process Diagram |
| | (BPD) | (BPD) |
| 6 | BPMN (Business Process Modeling | BPMN (Business Process Modeling |
| | Notation) | Notation) |
| 7 | Business Case (BC) | Business Case (BC) |
| 8 | Specification Case (SC) | Spezifikations Case (SC) |
| 9 | Production Case (PC) | Produktions Case (PC) |
| 10 | Business Process | Business Prozess |
| 11 | technical Processes | Technische Prozesse |
| 12 | Business Process Dialog | Business Prozess Dialog |
| 13 | Business System Dialog | Business System Dialog |
| 14 | Enterprise System | Enterprise System |
| 15 | Business System | Business System |
| 16 | Business Data Model (BDM) | Business Daten Model (BDM) |
| 17 | Logical Data Model (LDM) | Logisches Daten Model (LDM) |
| 18 | Physical Data Model (PDM) | Physisches Data Model (PDM) |
| 19 | Entity Relationship Diagram (ERD) | Entity Relationship Diagram (ERD) |
| 20 | Entity | Entity |
| 21 | IT System | IT System |
| 22 | Vision | Vision |
| 23 | Strategy | Strategie |
| 24 | Idea | Idee |
| 25 | Policy | Policy |
| 26 | Guideline | Richtlinien |
| 27 | Architecture | Achitektur |
| 28 | Infrastructure | Infrastruktur |
| 29 | Realization EAI | Realisierung EAI |
| 30 | EAI (Enterprise Application | EAI (Enterprise Application Integration) |
| | Integration) | |
| 31 | Plan | Plan |
| 32 | Analysis | Analyse |
| 33 | Design | Design |
| 34 | Implementation | Implementierung |
| 35 | Test | Test |
| 36 | Transition | Einführung |
| 37 | Operation | Produktion |
| 38 | Experts and Subexperts | Experten und Unterexperten |
| 39 | Synchronization | Synchronisation |
| 40 | Synergy | Synergie |
| 41 | Networking | Netzwerk |
| 42 | Branch | Geschäftszweig |
| 43 | Area | Gebiet |
| 44 | Level | Level |
| 45 | Subject area | Fachgebiet |
| 46 | Business objectives | Businessziele |
| 47 | Business area | Geschäftsbereich |
| 48 | Responsibility | Verantwortlichkeit |
| 49 | Line Manager | Linienvorgesetzter |
| 50 | Objectives | Ziele |
| 51 | Team members | Teammitglieder |
| 52 | Line organization | Linienorganisation |
| 53 | Technical System Description | Technische System Beschreibung |
| 54 | High Level Key Requirements | High Level Schlüssel Anforderungen |

### 51.11 TERMS TO THE SUBJECT AND AREA DIAGNOSTIC ASSESSMENT

| No. | English | German |
|---|---|---|
| 1 | Experts | Experten |
| 2 | Evaluation Criteria | Evaluationskriterien |
| 3 | Cognitive Points | Erkenntnis Punkte |
| 4 | Questionnaires | Fragekatalog |
| 5 | People interviewing | Befragung von Leuten |
| 6 | Criteria | Kriterien |
| 7 | Strategy | Strategie |
| 8 | Gaps | Lücke |
| 9 | Problems | Probleme |
| 10 | Strategy point | Strategie Punkt |
| 11 | Gap point | Lücke Punkt |
| 12 | Problem point | Problem Punkt |

### 51.12 EXTERNAL METHOD AND METHOD COMPONENTS

| No. | English | German |
|---|---|---|
| 1 | Overall method | Gesamtmethode |
| 2 | Method component | Methodenkomponente |
| 3 | Conjunction | Verknüpfung |
| 4 | Transformation | Transformation |
| 5 | Submethod | Untermethode |
| 6 | Submethod | Teilmethode |
| 7 | Functional Context Diagram | Funktionales Kontext Diagramm |
| 8 | Function | Funktion |
| 9 | Subfunction | Subfunktion |
| 10 | Change Management Point | Change Management Punkt |
| 11 | Solution point | Lösungs Punkt |
| 12 | Preconditions | Vorbedingungen |
| 13 | Extract | extrahieren |
| 14 | Extraction | Extrahieren |
| 15 | Single Steps | Einzelschritte |
| 16 | Work Step | Arbeitsschritt, Bearbeitungsschritt |
| 17 | Step | Schritt |
| 18 | Sequence number | Schrittnummer, Folgenummer |
| 19 | directional arrow | Richtungspfeil |
| 20 | Start point | Startpunkt |
| 21 | End point | Endpunkt |
| 22 | Sequence, selection, logic | Sequenz, Selection, logische |
| | operation or iteration | Verknüpfung oder Iteration |
| 23 | Selection | Selection |
| 24 | logic operation | logische Verknüpfung |
| 25 | Iteration | Iteration |
| 26 | Sequence | Sequenz |
| 27 | 1:1 Relationship | 1:1 Beziehung |
| 28 | 1:M Relationship | 1:M Beziehung |
| 29 | M:1 Relationship | M:1 Beziehung |
| 30 | M:N Relationship | M:N Beziehung |
| 31 | Flow | Fluss |
| 32 | Transformation interstage | Transformationszwischenstufe |
| 33 | Sign-off Process | Sign-off Prozess |
| 34 | Map and Gap Analysis | Map and Gap Analysis |
| 35 | Swimlanes | Schwimmbahnen |
| 36 | Function Synchronization | Funktion Synchronisation |
| 37 | Manual Synchronization | manuelle Synchronisation |
| 38 | Automatic Synchronization | automatische Synchronisation |
| 39 | Hierarchical tree structure | hierarchische Baumstruktur |
| 40 | Geographical points, places | geographischen Punkte, Orte und |
| | and figures in a two | Gebilde in einer zweidimensionale |
| | dimensional plane | Ebene |
| 41 | Service-oriented business | service orientierte Businessziele |
| | objectives | |
| 42 | Service step | Dienstleistungsschritt |
| 43 | Service oriented view | service orientierte Sicht |
| 44 | Service-oriented principles | service orientierte Prinzipien |
| 45 | Service-oriented architecture | service orientierte Architektur |
| 46 | Service oriented framework | service orientierter Framework |

### 51.13 ATTRIBUTES OF THE TABLES OF THE CPW METHOD COMPONENT

The following table shows the attributes of the tables of the CPW Method Components in English and in German language. At first comes in the first row the name of the table in English in the third column, and in the fourth column in German. Then follows all attributes of the respective table in English in the third column, and in the fourth column in German. In the second column is the number of the attributes of the CPW Method Component Table.

| No. | | English | Deutsch |
|---|---|---|---|
| 1 | | CPW Change Management | CPW Change Management |
| | No. | Table | Tabelle |
| 2 | 1 | CM No. | CM Nr. |
| | | (Change Management No.) | (Change Management No.) |
| 3 | 2 | CM Point description | CM Punkt Beschreibung |
| | | (Change Management Point | (Change Management Punkt |
| | | description) | Beschreibung) |
| 4 | 3 | CM Point Type | CM Punkt Type |
| | | (Change Management Point Type) | (Change Management Punkt Type) |
| 5 | 4 | Branch | Geschäftszweig |
| 6 | 5 | Area | Gebiet |
| 7 | 6 | Level | Level |
| 8 | 7 | Solution/Problem Description | Lösung/Problem Beschreibung |
| 9 | 8 | Solution/Problem Description | Lösung/Problem Beschreibung |
| | | Responsibility | Verantwortlichkeit |
| 10 | 9 | Priority | Priorität |
| 11 | 10 | Status | Status |
| 12 | 11 | Time/Date | Zeit/Datum oder Termin |
| 13 | | CPW Plan Table | CPW Plan Tabelle |
| 14 | 1 | No. | No. |
| 15 | 2 | Task Description | Aufgabenbeschreibung |
| 16 | 3 | Responsibility | Verantwortlichkeit |
| 17 | 4 | Cost | Kosten |
| 18 | 5 | Time, Date | Zeit, Termin |
| 19 | | CPW Process Table | CPW Prozess Tabelle |
| 20 | 1 | No. | Nr. |
| 21 | 2 | CPW Subject | CPW Subjekt |
| 22 | 3 | CPW Predicate | CPW Prädikat |
| 23 | 4 | CPW Object | CPW Objekt |
| 24 | | CPW Functional Requirements | CPW Funktions Anforderungen |
| | | Table | Tabelle |
| 25 | 1 | FR No. | FR Nr |
| | | (Functional Requirements No.) | (Funktions Anforderungen Nr.) |
| 26 | 2 | Function | Funktion |
| 27 | 3 | Subfunction description | Subfunktion Beschreibung |
| 28 | 4 | Function Type | Funktions Type |
| 29 | 5 | Branch | Geschäftszweig |
| 30 | 6 | Area | Gebiet |
| 31 | 7 | Level | Level |
| 32 | 8 | Solution/Problem Description | Lösung/Problem Beschreibung |
| 33 | 9 | Solution/Problem Description | Lösung/Problem Beschreibung |
| | | Responsibility | Verantwortlichkeit |
| 34 | 10 | Priority | Priorität |
| 35 | 11 | Status | Status |
| 36 | 12 | Time/Date | Zeit/Datum oder Termin |
| 37 | | CPW Object Flow Table | CPW Objekt Fluss Tabelle |
| 38 | 1 | Object Flow No. | Objekt Fluss Nr. |
| | | (Object Flow Number) | (Objekt Fluss Nummer) |
| 39 | 2 | CPW Object | CPW Objekt |
| 40 | 3 | Object Flow Description | Objekt Fluss Beschreibung |
| 41 | | CPW Subject Object Flow Table | CPW Subjekt Objekt Fluss |
| | | | Tabelle |
| 42 | 1 | Flow No. | Fluss Nr. |
| | | (Flow Number) | (Fluss Nummer) |
| 43 | 2 | CPW Subject | CPW Subjekt |
| 44 | 3 | CPW Object | CPW Objekt |
| 45 | 4 | Subject Description | Subjekt Beschreibung |
| 46 | 5 | Object Flow Description | Objekt Fluss Beschreibung |
| 47 | | CPW Subject Object Process | CPW Subjekt Objekt Prozess |
| | | Flow Table | Fluss Tabelle |
| 48 | 1 | Flow No. | Fluss Nr. |
| | | (Flow Number) | (Fluss Nummer) |
| 49 | 2 | CPW Subject | CPW Subjekt |
| 50 | 3 | CPW Predicate | CPW Prädikat |
| 51 | 4 | CPW Object | CPW Objekt |
| 52 | 5 | Subject Description | Subjekt Beschreibung |
| 53 | 6 | Object Flow Description | Objekt Fluss Beschreibung |

What is claimed is:

1. All kinds of applications of the Cognitive Process Workflow (CPW) Method with the previous application of the international application number: PCT/IB01/01337 and the U.S. application Ser. No. 10/486,290 in technical systems and all kinds of applications with the extensions of the CPW Method in this patent application in technical systems. Among others belong to the CPW Method:
(a) the CPW Process, the CPW Dialog and the CPW Workflow
(b) and the CPW Context Diagrams: CPW Subject Context Diagram, CPW Object Context Diagram and CPW Subject Object Context Diagram
Among others belong to the technical systems:
(c) The application of the CPW Method by means of Information Technologies
(d) The application of the CPW Method by means of technical protocols
(e) The application of the CPW Method by means of technologies
(f) The application of the CPW Method by means of Internet Technologies
(g) The application of the CPW Method by means of application systems

2. All kinds of applications of the Cognitive Process Workflow (CPW) Method with their extensions of the CPW Method through this patent application in technical systems. Among others belong to the extensions of the CPW Method:
(a) CPW Overall Method
(b) CPW Method Component
(c) CPW Method Transformation
Among others belong to the technical systems:
(d) The application of the CPW Method by means of Information Technologies
(e) The application of the CPW Method by means of technical protocols
(f) The application of the CPW Method by means of technologies
(g) The application of the CPW Method by means of Internet Technologies
(h) The application of the CPW Method by means of application systems

3. All kinds of applications of the Cognitive Process Workflow (CPW) Method with their extensions of the CPW Method through this patent application in technical systems. Among others belong to the extensions of the CPW Method:
(a) Method extensions of the CPW Process
(b) Method extensions of the CPW Dialog
Among others belong to the technical systems:
(c) The application of the CPW Method by means of Information Technologies
(d) The application of the CPW Method by means of technical protocols
(e) The application of the CPW Method by means of technologies
(f) The application of the CPW Method by means of Internet Technologies
(g) The application of the CPW Method by means of application systems

4. All kinds of applications of the Cognitive Process Workflow (CPW) Method with their extensions of the CPW Method through this patent application in technical systems. Among others belong to the extensions of the CPW Method:
(a) The CPW Process, the CPW Dialog and the CPW Workflow with Swimlanes
(b) The CPW Process, CPW Workflow synchronized with the CPW Functional Model (CPW Functional Diagram, CPW Functional Requirements)
Among others belong to the technical systems:
(c) The application of the CPW Method by means of Information Technologies
(d) The application of the CPW Method by means of technical protocols
(e) The application of the CPW Method by means of technologies
(f) The application of the CPW Method by means of Internet Technologies
(g) The application of the CPW Method by means of application systems

5. All kinds of applications of the Cognitive Process Workflow (CPW) Method with their extensions of the CPW Method through this patent application in technical systems. Among others belong to the extensions of the CPW Method:
(a) the CPW Process transformed in a UML Activity Diagram
Among others belong to the technical systems:
(b) The application of the CPW Method by means of Information Technologies
(c) The application of the CPW Method by means of technical protocols
(d) The application of the CPW Method by means of technologies
(e) The application of the CPW Method by means of Internet Technologies
(f) The application of the CPW Method by means of application systems

6. All kinds of applications of the Cognitive Process Workflow (CPW) Method with their extensions of the CPW Method through this patent application in technical systems. Among others belong to the extensions of the CPW Method:
(a) the CPW Process transformed in a BPMN Business Process Diagram (BPD) from the Business Process Modeling Notation (BPMN)
Among others belong to the technical systems:
(b) The application of the CPW Method by means of Information Technologies
(c) The application of the CPW Method by means of technical protocols
(d) The application of the CPW Method by means of technologies
(e) The application of the CPW Method by means of Internet Technologies
(f) The application of the CPW Method by means of application systems

7. All kinds of applications of the Cognitive Process Workflow (CPW) Method with their extensions of the CPW Method through this patent application in technical systems. Among others belong to the extensions of the CPW Method:
(a) the CPW Process, the CPW Workflow and the CPW Dialog integrated in a sociocultural dialog
Among others belong to the technical systems:
(b) The application of the CPW Method by means of Information Technologies
(c) The application of the CPW Method by means of technical protocols
(d) The application of the CPW Method by means of technologies
(e) The application of the CPW Method by means of Internet Technologies
(f) The application of the CPW Method by means of application systems

8. All kinds of applications of the Cognitive Process Workflow (CPW) Method with their extensions of the CPW Method through this patent application in technical systems. Among others belong to the extensions of the CPW Method:
(a) the CPW Process 2d
(b) the CPW Workflow 2d
(c) the CPW Dialog 2d
(d) the CPW Context Diagram 2d (CPW Object Context Diagram 2d, CPW Subject Context Diagram 2d, CPW Subject Object Context Diagram 2d)
Among others belong to the technical systems:
(e) The application of the CPW Method by means of Information Technologies
(f) The application of the CPW Method by means of technical protocols
(g) The application of the CPW Method by means of technologies
(h) The application of the CPW Method by means of Internet Technologies
(i) The application of the CPW Method by means of application systems

9. All kinds of applications of the Cognitive Process Workflow (CPW) Method and with their extensions of the CPW Method through this patent application in technical systems. Among others belong to the extensions of the CPW Method:
(a) the CPW Framework
(b) the CPW Method Component Instance
(c) the CPW Method Component CPW Sign-off Process
(d) the CPW Triangle
Among others belong to the technical systems:
(e) The application of the CPW Method by means of Information Technologies
(f) The application of the CPW Method by means of technical protocols
(g) The application of the CPW Method by means of technologies
(h) The application of the CPW Method by means of Internet Technologies
(i) The application of the CPW Method by means of application systems

10. All kinds of applications of the Cognitive Process Workflow CPW) Method and with their extensions of the CPW Method through this patent application in technical systems. Among others belong to the extensions of the CPW Method the following CPW Method Components, which can be applied in a CPW Framework:
(a) CPW Diagnostic Assessment
(b) CPW Change Management
(c) CPW Functional Requirements
(d) CPW Plan
(e) CPW Process
(f) CPW Context Diagram
(g) CPW Functional Diagram
(h) CPW Business System Description
Among others belong to the technical systems:
(i) The application of the CPW Method by means of Information Technologies
(j) The application of the CPW Method by means of technical protocols
(k) The application of the CPW Method by means of technologies
(l) The application of the CPW Method by means of Internet Technologies
(m) The application of the CPW Method by means of application systems

11. All kinds of applications of the Cognitive Process Workflow (CPW) Method and with their extensions of the CPW Method through this patent application in technical systems. Among others belong to the extensions of the CPW Method:
(a) The configuration of the CPW Frameworks with CPW Method Components
(b) The configuration of the CPW Frameworks with CPW Method Transformations
(c) The configuration of the CPW Frameworks with the function of the Synchronization
Among others belong to the technical systems:
(d) The application of the CPW Method by means of Information Technologies
(e) The application of the CPW Method by means of technical protocols
(f) The application of the CPW Method by means of technologies
(g) The application of the CPW Method by means of Internet Technologies
(h) The application of the CPW Method by means of application systems

12. All kinds of applications of the Cognitive Process Workflow (CPW) Method with their extensions of the CPW Method through this patent application in technical systems. Among others belong to the extensions of the CPW Method:
(a) Variant A Method Transformation of CPW Object Context Diagram Process Transformation
(b) CPW Object Flow Context Diagram
(c) CPW Subject Object Flow Context Diagram
(d) CPW Subject Object Process Flow Context Diagram
(e) Variant B Method Transformation of CPW Subject Object Context Diagram Process Transformation
(f) Variant C Method Transformation of CPW Object Context Diagram Process Transformation
Among others belong to the technical systems:
(g) The application of the CPW Method by means of Information Technologies
(h) The application of the CPW Method by means of technical protocols
(i) The application of the CPW Method by means of technologies
(j) The application of the CPW Method by means of Internet Technologies
(k) The application of the CPW Method by means of application systems

13. All kinds of applications of the Cognitive Process Workflow (CPW) Method with their extensions of the CPW Method through this patent application in technical systems. Among others belong to the extensions of the CPW Method:
(a) CPW Process Plan Transformation
(b) CPW Plan Process Transformation
Among others belong to the technical systems:
(c) The application of the CPW Method by means of Information Technologies
(d) The application of the CPW Method by means of technical protocols
(e) The application of the CPW Method by means of technologies
(f) The application of the CPW Method by means of Internet Technologies
(g) The application of the CPW Method by means of application systems

14. All kinds of applications of the Cognitive Process Workflow (CPW) Method with their extensions of the CPW Method through this patent application in technical systems. Among others belong to the extensions of the CPW Method:
(a) CPW Expert Concept
(b) CPW Diagnostic Assessment
(c) CPW Diagnostic Assessment Change Management Transformation
Among others belong to the technical systems:
(d) The application of the CPW Method by means of Information Technologies
(e) The application of the CPW Method by means of technical protocols
(f) The application of the CPW Method by means of technologies
(g) The application of the CPW Method by means of Internet Technologies
(h) The application of the CPW Method by means of application systems

15. All kinds of applications of the Cognitive Process Workflow (CPW) Method with their extensions of the CPW Method through this patent application in technical systems. Among others belong to the extensions of the CPW Method:
(a) CPW Change Management Plan Transformation
(b) CPW Change Management Process Transformation
(c) CPW Change Management Functional Requirements Transformation
Among others belong to the technical systems:
(d) The application of the CPW Method by means of Information Technologies
(e) The application of the CPW Method by means of technical protocols
(f) The application of the CPW Method by means of technologies
(g) The application of the CPW Method by means of Internet Technologies
(h) The application of the CPW Method by means of application systems

16. All kinds of applications of the Cognitive Process Workflow (CPW) Method with their extensions of the CPW Method through this patent application in technical systems. Among others belong to the extensions of the CPW Method:
(a) CPW Functional Requirements Functional Diagram Transformation
(b) CPW Functional Requirements Context Diagram Transformation
(c) CPW Functional Diagram Subject Object Context Diagram Transformation
(d) CPW Functional Diagram Object Flow Context Diagram Transformation
Among others belong to the technical systems:
(e) The application of the CPW Method by means of Information Technologies
(f) The application of the CPW Method by means of technical protocols
(g) The application of the CPW Method by means of technologies
(h) The application of the CPW Method by means of Internet Technologies
(i) The application of the CPW Method by means of application systems

17. All kinds of applications of the Cognitive Process Workflow (CPW) Method with their extensions of the CPW Method through this patent application in technical systems. Among others belong to the extensions of the CPW Method:
(a) CPW Functional Requirements Process Transformation
(b) CPW Functional Requirements Plan Transformation
Among others belong to the technical systems:
(c) The application of the CPW Method by means of Information Technologies
(d) The application of the CPW Method by means of technical protocols
(e) The application of the CPW Method by means of technologies
(f) The application of the CPW Method by means of Internet Technologies
(g) The application of the CPW Method by means of application systems

18. All kinds of applications of the Cognitive Process Workflow (CPW) Method with their extensions of the CPW Method through this patent application in technical systems. Among others belong to the extensions of the CPW Method:
(a) Method Transformation of BDM/ERD to CPW Subject Object Context Diagram
(b) CPW Context Diagram BDM Transformation
(c) CPW Subject Object Relationship Diagram
(d) Method Transformation of BDM/ERD to CPW Subject Object Relationship Diagram
(e) CPW Context Diagram Subject Object Relationship Diagram Transformation
Among others belong to the technical systems:
(h) The application of the CPW Method by means of Information Technologies
(i) The application of the CPW Method by means of technical protocols
(j) The application of the CPW Method by means of technologies
(k) The application of the CPW Method by means of Internet Technologies
(f) The application of the CPW Method by means of application systems

19. All kinds of applications of the Cognitive Process Workflow (CPW) Method with their extensions of the CPW Method through this patent application in technical systems. Among others belong to the extensions of the CPW Method:
(a) Method Transformation of an Entity Relationship Diagram to a CPW Process or CPW Workflow
(b) CPW BDM Process Transformation
Among others belong to the technical systems:
(c) The application of the CPW Method by means of Information Technologies
(d) The application of the CPW Method by means of technical protocols
(e) The application of the CPW Method by means of technologies
(f) The application of the CPW Method by means of Internet Technologies
(g) The application of the CPW Method by means of application systems

20. All kinds of applications of the Cognitive Process Workflow (CPW) Method with their extensions of the CPW Method through this patent application in technical systems. Among others belong to the extensions of the CPW Method:
(a) CPW Business System Description
Among others belong to the technical systems:
(b) The application of the CPW Method by means of Information Technologies
(c) The application of the CPW Method by means of technical protocols
(d) The application of the CPW Method by means of technologies
(e) The application of the CPW Method by means of Internet Technologies
(f) The application of the CPW Method by means of application systems

21. All kinds of applications of the Cognitive Process Workflow (CPW) Method and with their extensions of the CPW Method through this patent application in technical systems. Among others belong to the extensions of the CPW Method:
(a) Service oriented CPW Enterprise Architecture Framework
Among others belong to the technical systems:
(b) The application of the CPW Method by means of Information Technologies
(c) The application of the CPW Method by means of technical protocols
(d) The application of the CPW Method by means of technologies
(e) The application of the CPW Method by means of Internet Technologies
(f) The application of the CPW Method by means of application systems

22. All kinds of applications of the Cognitive Process Workflow (CPW) Method and with their extensions of the CPW Method through this patent application in technical systems. Among others belong to the extensions of the CPW Method:
(a) CPW Enterprise Architecture Framework
(b) CPW Enterprise Architecture Engine
Among others belong to the technical systems:
(c) The application of the CPW Method by means of Information Technologies
(d) The application of the CPW Method by means of technical protocols
(e) The application of the CPW Method by means of technologies
(f) The application of the CPW Method by means of Internet Technologies
(g) The application of the CPW Method by means of application systems

23. All kinds of applications of the Cognitive Process Workflow (CPW) Method and with their extensions of the CPW Method through this patent application in technical systems. Among others belong to the extensions of the CPW Method:
(a) CPW Enterprise Architecture Framework
(b) CPW Enterprise Architecture Engine
Among others belong to the technical systems:
(c) The application of the CPW Method by means of Information Technologies
(d) The application of the CPW Method by means of XML, XML Process Definition Language (XPDL), Web Services (WS) and other technical methods, protocols and technologies
(e) The application of the CPW Method by means of technologies
(f) The application of the CPW Method by means of Internet Technologies
(g) The application of the CPW Method by means of application systems

24. All kinds of applications of the Cognitive Process Workflow (CPW) Method and with their extensions of the CPW Method through this patent application in technical systems. Among others belong to the extensions of the CPW Method:
(a) CPW Enterprise Architecture Framework
(b) CPW Enterprise Architecture Engine
Among others belong to the technical systems:
(c) The application of the CPW Method by means of Information Technologies
(d) The application of the CPW Method by means of Business Process Modeling Notation (BPMN), Business Process Execution Language (BPEL), Web Services Definition Language (WSDL), Flow Definition Language (FDL) and other technical methods, protocols and technologies
(e) The application of the CPW Method by means of technologies
(f) The application of the CPW Method by means of Internet Technologies
(g) The application of the CPW Method by means of application systems

25. All kinds of applications of the Cognitive Process Workflow (CPW) Method and with their extensions of the CPW Method through this patent application in technical systems. Among others belong to the extensions of the CPW Method:
(a) Functions of the CPW Framework with CPW Method Components
(b) Functions for the CPW Enterprise Architecture Framework or the CPW Enterprise Architecture Engine with CPW Frameworks
(c) The CPW Enterprise Architecture Framework or the CPW Enterprise Architecture Engine with hierarchical tree structures of CPW Frameworks.
(d) The CPW Enterprise Architecture Framework or the CPW Enterprise Architecture Engine with the functions of the CPW Method Transformation
(e) Functions for the CPW Enterprise Architecture Framework or the CPW Enterprise Architecture Framework Engine for the function of synchronization.
Among others belong to the technical systems:
(f) The application of the CPW Method by means of Information Technologies
(g) The application of the CPW Method by means of technical protocols
(h) The application of the CPW Method by means of technologies
(i) The application of the CPW Method by means of Internet Technologies
(j) The application of the CPW Method by means of application systems

26. All kinds of applications of the Cognitive Process Workflow (CPW) Method and with their extensions of the CPW Method through this patent application in technical systems. Among others belong to the extensions of the CPW Method:
(a) Functions of the CPW Enterprise Architecture Frameworks or the CPW Enterprise Architecture Engine regarding the function of the synchronization and CPW Method Transformation to the external interface of projects and programs with Business Case (BC), Specification Case (SC), Production Case (PC)
(b) Functions of the CPW Enterprise Architecture Frameworks or the CPW Enterprise Architecture Engine regarding the function of the synchronization and CPW Method Transformation to the external interface with external tools and applications. (c) Functions of the CPW Enterprise Architecture Frameworks or the CPW Enterprise Architecture Engine regarding the function of the synchronization and CPW Method Transformation to the external interface with external tools and applications with various technical methods and protocols like for example XML, XML Process Definition Language (XPDL), Web Services (WS).
(d) Functions of the CPW Enterprise Architecture Frameworks or the CPW Enterprise Architecture Engine regarding the function of the synchronization and CPW Method Transformation to the external interface with external tools and applications with various technical methods and protocols like for example Business Process Modeling Notation (BPMN), Business Process Execution Language (BPEL), Web Services Definition Language (WSDL), Flow Definition Language (FDL).
Among others belong to the technical systems:
(e) The application of the CPW Method by means of Information Technologies
(f) The application of the CPW Method by means of XML, XML Process Definition Language (XPDL), Web Services (WS) and other technical methods, protocols and technologies
(g) The application of the CPW Method by means of Business Process Modeling Notation (BPMN), Business Process Execution Language (BPEL), Web Services Definition Language (WSDL), Flow Definition Language (FDL) and other technical methods, protocols and technologies
(h) The application of the CPW Method by means of technologies
(i) The application of the CPW Method by means of Internet Technologies
(j) The application of the CPW Method by means of application systems

27. All kinds of applications of the Cognitive Process Workflow (CPW) Method and with their extensions of the CPW Method through this patent application in technical systems. Among others belong to the extensions of the CPW Method:
(a) Functions of the CPW Enterprise Architecture Framework or the CPW Enterprise Architecture Engine with the tree structure of CPW Frameworks, at which the tree structure at the area Enterprise Architecture is subdivided into the area Business Architecture and IT. The area Business Architecture is divided into the areas Information Model, Business Requirements and Business System. The area IT is divided into the areas Data Model, Application Model and System Model. Within the CPW Enterprise Architecture Frameworks or the CPW Enterprise Architecture Engine are possible the functions synchronization and CPW Method Transformations between the CPW Frameworks Business Architecture and IT within the tree structure.
Among others belong to the technical systems:
(b) The application of the CPW Method by means of Information Technologies
(c) The application of the CPW Method by means of technical protocols
(d) The application of the CPW Method by means of technologies
(e) The application of the CPW Method by means of Internet Technologies
(f) The application of the CPW Method by means of application systems

28. All kinds of applications of the Cognitive Process Workflow (CPW) Method and with their extensions of the CPW Method through this patent application in technical systems. Among others belong to the extensions of the CPW Method:
(a) Functions of the CPW Framework Configuration
(b) Functions of the CPW Enterprise Architecture Engine Configuration
(c) The CPW Enterprise Architecture Engine Configuration with the configuration possibilities of the CPW Method Components within the CPW Frameworks, of the CPW Enterprise Architecture Framework and of the CPW Enterprise Architecture Engine
Among others belong to the technical systems:
(d) The application of the CPW Method by means of Information Technologies
(e) The application of the CPW Method by means of technical protocols
(f) The application of the CPW Method by means of technologies
(g) The application of the CPW Method by means of Internet Technologies
(h) The application of the CPW Method by means of application systems

29. All kinds of applications of the Cognitive Process Workflow (CPW) Method and with their extensions of the CPW Method through this patent application in technical systems. Among others belong to the extensions of the CPW Method:
(a) The application of the CPW Method as Enterprise Architecture Engine.
(b) The application of the CPW Method as Workflow Engine.
(c) The application of the graphical representation of the CPW Method in a technical system
(d) The application of the CPW Method in an application system with integrated database.
(e) The application of the CPW Method in Internet Technologies

30. All kinds of applications of the Cognitive Process Workflow (CPW) Method and with their extensions of the CPW Method through this patent application in technical systems. Among others belong to the extensions of the CPW Method:
(a) the function synchronization between Business Case (BC), Specification Case (SC) and Production Case (PC) and the CPW Frameworks of the CPW Enterprise Architecture Framework
(b) the CPW Enterprise Architecture Framework with the CPW Frameworks applied as Enterprise Architecture Framework
(c) the CPW Enterprise Architecture Framework with a tree structure of CPW Frameworks with the areas Data Model, Application Model and System Model applied as Enterprise Architecture Framework or as Enterprise Architecture Engine with the areas Data Model, Application Model and System Model.
(d) the CPW Enterprise Architecture Engine with a tree structure of CPW Frameworks with the areas Data Model, Application Model and System Model
(e) the CPW Enterprise Architecture Engine with a tree structure of CPW Frameworks with the areas Information Model, Business Requirements Model and Business System Model.
(f) the CPW Enterprise Architecture Engine with a tree structure of CPW Frameworks with the areas Data Model, Application Model and System Model. The CPW Frameworks are each assigned the corresponding CPW Method Components. The possible CPW Method Transformations between the various CPW Method Components are configurable. The function of the synchronization between the CPW Frameworks and CPW Method Components is furthermore configurable.
(g) the CPW Method applied as Enterprise Architecture Framework or as Enterprise Architecture Engine with the areas Data Model, Application Model and System Model.
Among others belong to the technical systems:
(h) The application of the CPW Method by means of Information Technologies
(i) The application of the CPW Method by means of technical protocols
(j) The application of the CPW Method by means of technologies
(k) The application of the CPW Method by means of Internet Technologies
(l) The application of the CPW Method by means of application systems

31. All kinds of applications of the Cognitive Process Workflow (CPW) Method and with their extensions of the CPW Method through this patent application in technical systems. Among others belong to the extensions of the CPW Method:
(a) The application of the CPW Enterprise Architecture Framework and of the CPW Enterprise Architecture Engine can also be named as Enterprise Architecture Modeling or Business Architecture Modeling.
Among others belong to the technical systems:
(b) The application of the CPW Method by means of Information Technologies
(c) The application of the CPW Method by means of technical protocols
(d) The application of the CPW Method by means of technologies
(e) The application of the CPW Method by means of Internet Technologies
(f) The application of the CPW Method by means of application systems

32. All kinds of applications of the Cognitive Process Workflow (CPW) Method and with their extensions of the CPW Method through this patent application in technical systems. Among others belong to the extensions of the CPW Method:
(a) The application of the CPW Enterprise Architecture Framework and the CPW Enterprise Architecture Engine with the tree structure of CPW Frameworks with the areas Data Model, Application Model and System Model. The areas Data Model, Application Model and System Model are again assigned the CPW Frameworks in the project phases Business Case (BC), Specification Case (SC), and Production Case (PC).
(b) In the application of the CPW Enterprise Architecture Framework and the CPW Enterprise Architecture Engine the created CPW Frameworks within the tree structure with the areas Data Model, Application Model and System Model are assigned the CPW Method Components.
(c) In the application of the CPW Enterprise Architecture Framework and the CPW Enterprise Architecture Engine the created CPW Frameworks within the tree structure with the areas Data Model, Application Model and System Model are assigned the CPW Method Components CPW Plan, CPW Context Diagram and CPW Process.
(d) In the application of the CPW Enterprise Architecture Framework and the CPW Enterprise Architecture Engine the created CPW Frameworks within the tree structure with the areas Data Model, Application Model and System Model are assigned the CPW Method Components and external method components.
(e) In the application of the CPW Enterprise Architecture Framework and the CPW Enterprise Architecture Engine the created CPW Frameworks within the tree structure with the areas Data Model, Application Model and System Model are assigned the CPW Method Components CPW Process and CPW Context Diagram, and the external method components UML Method, Business Data Model (BDM), Logical Data Model (LDM), Physical Data Model (PDM) are assigned to the CPW Frameworks, and the external method components to the areas database, programs, network and system are assigned to the CPW Frameworks. To the created CPW Frameworks are also assigned the functions of the synchronization and the CPW Method Transformations. Especially at the example of the method transformation CPW Context Diagram BDM Transformation and the method transformation of CPW Process to UML Activity Diagrams.
(f) In the application of the CPW Enterprise Architecture Framework and the CPW Enterprise Architecture Engine the created CPW Frameworks within the tree structure with the areas Data Model, Application Model and System Model are assigned the CPW Method Components CPW Process and CPW Context Diagram, and the external method components UML Method, Business Data Model (BDM), Logical Data Model (LDM), Physical Data Model (PDM) are assigned to the CPW Frameworks, and the external method components to the areas database, programs, network and system are assigned to the CPW Frameworks. To the created CPW Frameworks are also assigned the functions of the synchronization and the CPW Method Transformations. Especially at the example of the method transformation CPW Context Diagram BDM Transformation and the method transformation of CPW Process to UML Activity Diagrams, and the CPW BDM Process Transformation.
Among others belong to the technical systems:
(g) The application of the CPW Method by means of Information Technologies
(h) The application of the CPW Method by means of technical protocols
(i) The application of the CPW Method by means of technologies
(j) The application of the CPW Method by means of Internet Technologies
(k) The application of the CPW Method by means of application systems

33. All kinds of applications of the Cognitive Process Workflow (CPW) Method and with their extensions of the CPW Method through this patent application in technical systems and the application of the CPW Method and with their extensions in various areas. Among others belong to the extensions of the CPW Method:
(a) The CPW Enterprise Architecture Framework
(b) The CPW Enterprise Architecture Engine
Among others belong to the application of the CPW Method in various areas:
(c) Financial Services (Banking, insurance industry and Financial Accounting and Auditing)
(d) Chemistry
(e) Pharmacy
(f) Medicine
(g) Transportation and shipping
(h) Travel
(i) Film industry
(j) Politics
(k) Psychology
(l) Legal Practice, Jurisprudence, Judiciary
Among others belong to the technical systems:
(m) The application of the CPW Method by means of Information Technologies
(n) The application of the CPW Method by means of technical protocols
(o) The application of the CPW Method by means of technologies
(p) The application of the CPW Method by means of Internet Technologies
(q) The application of the CPW Method by means of application systems

34. All kinds of applications of the Cognitive Process Workflow (CPW) Method and with their extensions of the CPW Method through this patent application in technical systems. Among others belong to the extensions of the CPW Method:
(a) The CPW Enterprise Architecture Framework
(b) The CPW Enterprise Architecture Engine
Among others belong to the technical systems:
(c) The application of the graphical representation of the method in technical systems
(d) The application of the CPW Method by means of Internet Technologies
(e) The application of the CPW Method by means of application systems
(f) The application of the CPW Method in an Enterprise Architecture Framework
(g) The application of the CPW Method in an Enterprise Architecture Engine
(h) The application of the CPW Method in an application system with integrated database.
(i) The application of the CPW Method in a Workflow Engine.

35. The Cognitive Process Workflow (CPW) Method and with their extensions of the CPW Method through this patent application. Among others belong to the extensions of the CPW Method:
(a) The CPW Enterprise Architecture Framework
(b) The CPW Enterprise Architecture Engine

36. All kinds of applications of the Cognitive Process Workflow (CPW) Method and with their extensions of the CPW Method through this patent application. Among others belong to the extensions of the CPW Method:
(a) The CPW Enterprise Architecture Framework
(b) The CPW Enterprise Architecture Engine

37. All kinds of applications of the Cognitive Process Workflow (CPW) Method and with their extensions of the CPW Method through this patent application. Among others belong to the extensions of the CPW Method:
(a) The CPW Enterprise Architecture Framework
(b) The CPW Enterprise Architecture Engine
Among others belong to the application:
(c) Application of the graphical representation of the method.

38. All kinds of applications of the Cognitive Process Workflow (CPW) Method and with their extensions of the CPW Method through this patent application in technical systems. Among others belong to the extensions of the CPW Method:
(a) The CPW Enterprise Architecture Framework
(b) The CPW Enterprise Architecture Engine
Among others belong to the technical systems:
(c) Application of the graphical representation of the method in technical systems

39. All kinds of applications of the Cognitive Process Workflow (CPW) Method and with their extensions of the CPW Method through this patent application on data and information in various business areas. Among others belong to the extensions of the CPW Method:
(a) The CPW Enterprise Architecture Framework
(b) The CPW Enterprise Architecture Engine
Among others belong to the application of the CPW Method in various business areas:
(c) Financial Services (Banking, insurance industry and Financial Accounting and Auditing)
(d) Chemistry
(e) Pharmacy
(f) Medicine
(g) Transportation and shipping
(h) Travel
(i) Film industry
(j) Politics
(k) Psychology
(l) Legal Practice, Jurisprudence, Judiciary

40. All kinds of applications of the Cognitive Process Workflow (CPW) Method and with their extensions of the CPW Method through this patent application in technical systems. Among others belong to the extensions of the CPW Method:
(a) The CPW Enterprise Architecture Framework
(b) The CPW Enterprise Architecture Engine
Among others belong to the technical systems:
(c) The application of the CPW Method in an Enterprise Architecture Framework
(d) The application of the CPW Method in an Enterprise Architecture Engine
(e) The application of the CPW Method in an Enterprise Architecture Tool
(f) The application of the CPW Method in a Workflow Engine
(g) The application of the CPW Method in a Process Engine
(h) The application of the CPW Method in a Process Tool

41. All kinds of applications of the Cognitive Process Workflow (CPW) Method and with their extensions of the CPW Method through this patent application in technical systems. Among others belong to the extensions of the CPW Method:
(a) The CPW Enterprise Architecture Framework
(b) The CPW Enterprise Architecture Engine
Among others belong to the technical systems:
(c) The application of the CPW Method in a Workflow Tool
(d) The application of the CPW Method in a Workflow Management System
(e) The application of the CPW Method in a Business Process Management System

42. All kinds of applications of the Cognitive Process Workflow (CPW) Method and with their extensions of the CPW Method through this patent application in technical systems. Among others belong to the extensions of the CPW Method:
(a) The CPW Enterprise Architecture Framework
(b) The CPW Enterprise Architecture Engine
Among others belong to the technical systems:
(c) The application of the CPW Method in a CPW Enterprise Architecture Framework
(d) The application of the CPW Method in a CPW Enterprise Architecture Engine
(e) The application of the CPW Method in a CPW Enterprise Architecture Tool
(f) The application of the CPW Method in a CPW Workflow Engine
(g) The application of the CPW Method in a CPW Process Engine
(h) The application of the CPW Method in a CPW Process Tool

43. All kinds of applications of the Cognitive Process Workflow (CPW) Method and with their extensions of the CPW Method through this patent application in technical systems. Among others belong to the extensions of the CPW Method:
(a) The CPW Enterprise Architecture Framework
(b) The CPW Enterprise Architecture Engine
Among others belong to the technical systems the application of the CPW Method in a CPW Enterprise Architecture Engine with corresponding configuration as:
(c) Enterprise Architecture Framework
(d) Enterprise Architecture Engine
(e) Enterprise Architecture Tool
(f) Workflow Engine
(g) Process Tool
(h) Process Engine

44. All kinds of applications of the Cognitive Process Workflow (CPW) Method and with their extensions of the CPW Method through this patent application in technical systems. Among others belong to the extensions of the CPW Method:
(a) the CPW Enterprise Architecture Engine with a tree structure of CPW Frameworks with the areas Data Model, Application Model and System Model
(b) the CPW Enterprise Architecture Engine with a tree structure of CPW Frameworks with the areas Information Model, Business Requirements Model and Business System Model.
Among others belong to the technical systems:
(c) The application of the CPW Method by means of Information Technologies
(d) The application of the CPW Method by means of technical protocols
(e) The application of the CPW Method by means of technologies
(f) The application of the CPW Method by means of Internet Technologies
(g) The application of the CPW Method by means of application systems

45. All kinds of applications of the Cognitive Process Workflow (CPW) Method and with their extensions of the CPW Method through this patent application in technical systems. Among others belong to the extensions of the CPW Method:
(a) The CPW Enterprise Architecture Engine with a tree structure of CPW Frameworks with the areas Information Model, Business Requirements Model and Business System Model. The particular CPW Frameworks are each assigned one to many CPW Method Components and overall in the tree structure of the CPW Frameworks is possible a configuration and application of the CPW Method Transformations and the function of the synchronization.
(b) The CPW Enterprise Architecture Engine with a tree structure of CPW Frameworks with the areas bath Model, Application Model and System Model. The particular CPW Frameworks are each assigned one to many CPW Method Components and overall in the tree structure of the CPW Frameworks is possible a configuration and application of the CPW Method Transformations and the function of the synchronization.
Among others belong to the technical systems:
(c) The application of the CPW Method by means of Information Technologies
(d) The application of the CPW Method by means of technical protocols
(e) The application of the CPW Method by means of technologies
(f) The application of the CPW Method by means of Internet Technologies
(g) The application of the CPW Method by means of application systems

46. All kinds of applications of the Cognitive Process Workflow (CPW) Method and with their extensions of the CPW Method through this patent application in technical systems. Among others belong to the extensions of the CPW Method:
(a) The CPW Enterprise Architecture Engine with a tree structure of CPW Frameworks with the areas Information Model, Business Requirements Model and Business System Model. The particular CPW Frameworks are assigned following CPW Method Components:
(b) CPW Diagnostic Assessment
(c) CPW Change Management
(d) CPW Functional Requirements
(e) CPW Plan
(f) CPW Process
(g) CPW Context Diagram
(h) CPW Functional Diagram
(i) CPW Business System Description
(j) Overall in the tree structure of the CPW Frameworks is possible a configuration and application of the CPW Method Transformations and the function of the synchronization.
Among others belong to the technical systems:
(k) The application of the CPW Method by means of Information Technologies
(l) The application of the CPW Method by means of technical protocols
(m) The application of the CPW Method by means of technologies
(n) The application of the CPW Method by means of Internet Technologies
(o) The application of the CPW Method by means of application systems

47. All kinds of applications of the Cognitive Process Workflow (CPW) Method and with their extensions of the CPW Method through this patent application in technical systems. Among others belong to the extensions of the CPW Method:
(a) The CPW Enterprise Architecture Engine with a tree structure of CPW Frameworks with the areas Data Model, Application Model and System Model. The particular CPW Frameworks are assigned following CPW Method Components:
(b) CPW Diagnostic Assessment
(c) CPW Change Management
(d) CPW Functional Requirements
(e) CPW Plan
(f) CPW Process
(g) CPW Context Diagram
(h) CPW Functional Diagram
(i) CPW Business System Description
(j) Overall in the tree structure of the CPW Frameworks is possible a configuration and application of the CPW Method Transformations and the function of the synchronization.
Among others belong to the technical systems:
(k) The application of the CPW Method by means of Information Technologies
(l) The application of the CPW Method by means of technical protocols
(m) The application of the CPW Method by means of technologies
(n) The application of the CPW Method by means of Internet Technologies
(o) The application of the CPW Method by means of application systems

48. All kinds of applications of the Cognitive Process Workflow (CPW) Method and with their extensions of the CPW Method through this patent application in technical systems. Among others belong to the extensions of the CPW Method:
(a) The CPW Enterprise Architecture Engine with a tree structure of CPW Frameworks with the areas Information Model, Business Requirements Model and Business System Model. The particular CPW Frameworks are each assigned a combination of one to many CPW Method Components and overall in the tree structure of the CPW Frameworks is possible a configuration and application of the CPW Method Transformations and the function of the synchronization.
(b) The CPW Enterprise Architecture Engine with a tree structure of CPW Frameworks with the areas Data Model, Application Model and System Model. The particular CPW Frameworks are each assigned a combination of one to many CPW Method Components and overall in the tree structure of the CPW Frameworks is possible a configuration and application of the CPW Method Transformations and the function of the synchronization.
Among others belong to the technical systems:
(c) The application of the CPW Method by means of Information Technologies
(d) The application of the CPW Method by means of technical protocols
(e) The application of the CPW Method by means of technologies
(f) The application of the CPW Method by means of Internet Technologies
(g) The application of the CPW Method by means of application systems
